(19) United States
(12) Patent Application Publication
(10) Pub. No.: US 2012/0221589 A1
(43) Pub. Date: Aug. 30, 2012

(54) METHOD AND SYSTEM FOR SELECTING, RETRIEVING, VISUALIZING AND EXPLORING TIME-ORIENTED DATA IN MULTIPLE SUBJECT RECORDS

(76) Inventors: Yuval Shahar, Omer (IL); Denis Klimov, Beer Sheva (IL)

(21) Appl. No.: 13/391,644

(22) PCT Filed: Aug. 24, 2010
(86) PCT No.: PCT/IL10/00689

§ 371 Date: May 13, 2012

Related U.S. Application Data
(60) Provisional application No. 61/236,844, filed on Aug. 25, 2009.
(60) Provisional application No. 61/262,293, filed on Nov. 18, 2009.

(51) Int. Cl. G06F 17/30

(52) U.S. Cl. 707/758; 707/E17.014

(57) ABSTRACT

Provided herein system and method for analyzing time oriented data in a plurality of records, by defining a knowledge base in a domain and linking it to a database of a plurality of records, each storing at least one instance of time oriented data based on at least one concept defined in the knowledge base; and specifying at least one constraint on the subject records; and retrieving subject records which satisfy at least one constraint and graphically displaying at least one instance of time oriented data stored in the retrieved subject records; and exploring at least one association between the instance of time oriented data stored in the retrieved records.

### FIELD OF THE DISCLOSED TECHNIQUE

The disclosed technique relates to data retrieval and data analysis in general, and to methods and systems for selecting, retrieving, visualizing and exploring temporal relations in time-oriented data in multiple subject records, in particular.

### BACKGROUND OF THE DISCLOSED TECHNIQUE

A central task in decision making involves the gathering and analysis of relevant data in order to best deliberate over possible options. The task of finding and analyzing relevant data efficiently is becoming increasingly difficult as the quantities of data and information being stored and made available is constantly growing at ever increasing rates. In particular is the amount of time-stamped data regarding subject records, also known as longitudinal subject records or time-oriented data (the terms are used interchangeably herein), especially when such subject records involve a plurality of subjects.

A subject record refers to data and information stored about a subject. Subjects could be patients in a clinic or hospital, computer stations in an office building, homes on a street, items in a store and the like. The subject record is then data and information stored about the subject. Using the above example, a subject record for a patient may be his blood glucose level as determined by a blood glucose level test. A subject record for a computer station may be the computer station's ID number. A subject record for a home may be its address, or the amount of electricity that the home used over a particular month of the year. And a subject record for an item in a store may be its price. Time-stamped data refers to stored data in which the time at which the data was recorded, or written down, is also stored with the data. Using the above examples, a longitudinal subject record for a patient in a hospital may be the blood glucose level of a patient who took a blood glucose level test once a month for a year. Each measure of the patient's blood glucose level would be stored in the subject's record along with the time at which the test was observed. Regarding a computer workstation, a longitudinal subject record may be the number of computer viruses a virus checker on the computer workstation found each Monday morning, after doing a virus check, for a period of four months. Regarding a home, a longitudinal subject record may be the amount of water used in the home each month for a period of three years. Regarding items in a store, a longitudinal subject record may be the number of sales of the item each week for a period of a month. In each of these examples, each subject has multiple records, or data, stored about it, where each stored piece of data has the particular time (i.e., a time-stamp) at which the data was recorded also stored. It is noted that the time-stamp can be represented at different levels of precision, for example, the time-stamp may specify only the date (e.g. 14/05/2004, Aug. 10, 1987 or 03-02-2001) or may include the particular time of day as well (e.g. 18:05:00, 3:56 pm or 9:03:04 am). In each of the above examples, a plurality of records for a plurality of subjects would refer to a plurality of pieces of data stored for each of a plurality of subjects.

The analysis of time-oriented data is important for many tasks in a plurality of fields, such as quality assessment, management of resources and discovery of new knowledge. For example, state of the art clinical and medical research involves the analysis of large amounts of data from multiple patients over a substantial period of time. Such data may include longitudinal medical records, such as the medical records of patients, which may include a plurality of entries representing tests, operations, procedures and other pertinent medical information recorded by a patient's medical practitioner over a period of time which may span years if not decades. A major task of clinicians and medical researchers is the ability to analyze such data to support various functions of the field of clinical and medical research, such as quality assessment tasks, the analysis of clinical trials, the management of clinical decisions and the discovery of new clinical knowledge. In another example, state of the art information security involves the analysis of large amounts of data regarding network and program activity over various periods of time. Such data may include CPU usage, changes to registry keys, lists of programs installed and the like, spanning the course of weeks, months or possibly years. The task of information security specialists is to analyze such data in order to detect intruders, such as computer hackers, or the presence of malicious software code, such as computer viruses, spyware or Trojan horses.

In the field of medical and clinical research, state of the art systems, commonly referred to as electronic medical record (herein abbreviated EMR) systems, are known which enable data and medical records relating to a patient to be accessed electronically. Whereas such systems enable clinicians and medical researchers to retrieve data relating to a patient in electronic form, such systems lack the ability to analyze the data over time, especially when data from multiple patients is to be analyzed. In addition, such systems do not enable interactive exploration of the data, such as the existence of patterns in the data over time, or the existence of correlations between the data over time. Whereas some of these tasks may by executed by using known statistical tools, such as time-oriented statistical tools, or by using advanced temporal data-mining techniques, such tools and techniques may not be adequate for a worker skilled in the art of medical and clinical research. For example, the use of advanced temporal data-mining techniques may require specialized, advanced knowledge and training to be used properly, and time-oriented statistical tools may be applicable only in particular cases.

In the field of information security, state of the art systems are known which use visualization tools for displaying network traffic on a network and for monitoring the intercommunication between various hosts on the network to assist workers skilled in the art in detecting computer attacks and reconnaissance activity on the network. One such tool, known as NVisionIP, to Lakkaraju et al., published in “NVisionIP: NetFlow Visualizations of System State for Security Situational Awareness,” Proceedings of CCS Workshop on Visualization and Data Mining for Computer Security, 2004, is directed towards a visualization tool for displaying a wide range of network characteristics. NVisionIP enables collected network data, which represents aggregated traffic between two hosts, that includes the IP address and port numbers of the source host and destination host, the start and end time of the flow between the hosts as well as the protocol used for a specific flow and the volume of traffic in the network, to be visualized.

The user interface visualization tool provides three views of the network at various zoom levels. A galaxy view provides the broadest possible view of the network. Selecting a rectangular region in the galaxy view enables a small multiple view in which traffic on ports for selected hosts can be visualized. A machine view provides a most detailed view for a single selected host, displaying network characteristics for the selected host such as the byte count and the flow on each port of the host for all TCP traffic. NVisionIP also enables the user to filter or aggregate a specified set of hosts based on any combination of IP addresses, ports or protocols. It is noted though that NVisionIP only provides a static view of the network, and that users of NVisionIP can see only the current state of the network. Additionally, alerts are not raised by the visualization tool, therefore necessitating a worker skilled in the art, such as a network analyst, to identify potential computer attacks by themselves.

Another visualization tool known in the art, PortVis, to McPherson et al., published in “PortVis: A Tool for Port-Based Detection of Security Events,” Proceedings of CCS Workshop on Visualization and Data Mining for Computer Security, 2004, is directed towards a visualization tool for port-based detection of security events. The PortVis system uses coarsely detailed data, i.e., summarized information of the activity on each TCP port during each given hour, for visualization of network traffic. Such visualizations can be used by workers skilled in the art to uncover potential security events. Three possible visualizations are available. The first, a timeline visualization, enables a visualization of the entire time range available to the PortVis system from its data source. The second, a main visualization, depicts port activity during a given time unit. It consists of a dot on a 256×256 grid for each of the 65,536 ports available on a host. The third, a port visualization, enables a view of all the data available that concerns a particular port. A common use of the PortVis tool is identifying a particular block of ports at a particular time that warrant further investigation using the timeline visualization or main visualization and then focusing on an individual suspected port using the port visualization. It is noted though that the visualizations of PortVis are based on summarized data. In addition, the workload placed on a worker skilled in the art of detecting interesting patterns and anomalies in port activity is not diminished by using PortVis, as the system uses unlabeled data which does not enable PortVis to use machine-learning techniques such as clustering.

It is noted that state of the art systems in visualization of network data and port monitoring lack the ability to analyze accumulated data over time, especially when data from multiple hosts or ports is to be analyzed. In addition, such systems do not enable interactive exploration of the data, such as the existence of patterns in the data over time, or the existence of correlations between the data over time. Furthermore, the visualization tools of the prior art are substantially task-specific, usually for detecting abnormal network activity, and cannot be easily modified to support additional tasks such as system or user activity visualization. Also, prior art systems which do support temporal visualization cannot provide meaningful summaries of large amounts of time-oriented data, thus requiring a worker skilled in the art to analyze the data by themselves.

### BRIEF DESCRIPTION OF THE DRAWINGS

The disclosed technique will be understood and appreciated more fully from the following detailed description taken in conjunction with the drawings in which:

FIG. 1 is a schematic illustration of a method for selecting, retrieving, visualizing and exploring time-oriented data, operative in accordance with an embodiment of the disclosed technique;

FIG. 2 is a schematic illustration of a system for selecting, retrieving, visualizing and exploring time-oriented data, constructed and operative in accordance with another embodiment of the disclosed technique;

FIG. 3 is a schematic illustration of interval properties, constructed and operative in accordance with a further embodiment of the disclosed technique;

FIGS. 4A-4E represent a schematic illustration of a specification language, constructed and operative in accordance with another embodiment of the disclosed technique;

FIG. 5 is an illustration showing examples of constraints specified in natural language and in an ontology-based temporal aggregation population specification language, constructed and operative in accordance with a further embodiment of the disclosed technique;

FIG. 6 is an illustration showing examples of constraints specified in an ontology-based temporal aggregation population specification language using a GUI, constructed and operative in accordance with another embodiment of the disclosed technique;

FIG. 7 is another illustration showing examples of constraints specified in an ontology-based temporal aggregation population specification language using a GUI, constructed and operative in accordance with a further embodiment of the disclosed technique;

FIGS. 8A-8C are graphs showing a method for determining delegate values for abstract concepts, operative in accordance with another embodiment of the disclosed technique; and

FIG. 9A is a schematic illustration of a method for determining a single delegate value for a raw concept, operative in accordance with a further embodiment of the disclosed technique;

FIG. 9B is a schematic illustration of a method for determining a plurality of delegate values for a raw concept, operative in accordance with another embodiment of the disclosed technique;

FIG. 9C is a schematic illustration of a method for determining a single delegate value for an abstract concept, operative in accordance with a further embodiment of the disclosed technique;

FIG. 9D is a schematic illustration of a method for determining a plurality of delegate values for an abstract concept, operative in accordance with another embodiment of the disclosed technique;

FIG. 10 is a schematic illustration of the explorer of FIG. 2, constructed and operative in accordance with a further embodiment of the disclosed technique;

FIG. 11A is an illustration showing an example of the visualization of delegate values determined from raw data values, constructed and operative in accordance with another embodiment of the disclosed technique;

FIG. 11B is an illustration showing an example of the visualization of abstracted data values, constructed and operative in accordance with a further embodiment of the disclosed technique;

FIG. 12A is an illustration showing an example of the exploration of delegate values determined from raw data values using a temporal exploration operator, constructed and operative in accordance with another embodiment of the disclosed technique;

FIG. 12B is a schematic illustration of a method for exploring delegate values determined from raw data values using a temporal exploration operator, operative in accordance with a further embodiment of the disclosed technique;

FIG. 12C is an illustration showing an example of the exploration of abstracted data values using a temporal exploration operator, constructed and operative in accordance with another embodiment of the disclosed technique;

FIG. 12D is a schematic illustration of a method for exploring abstracted data values using a temporal exploration operator, operative in accordance with a further embodiment of the disclosed technique;

FIG. 13A is an illustration showing an example of the exploration of delegate values determined from raw data values using a change delegate value operator, constructed and operative in accordance with another embodiment of the disclosed technique;

FIG. 13B is an illustration showing an example of the exploration of abstracted data values using a change delegate value operator, constructed and operative in accordance with a further embodiment of the disclosed technique;

FIG. 13C is a schematic illustration of a method for exploring delegate values determined from raw data values and abstracted data values using a change delegate value operator, operative in accordance with another embodiment of the disclosed technique;

FIG. 14A is an illustration showing an example of the exploration of delegate values determined from raw data values using a set relative time operator, constructed and operative in accordance with a further embodiment of the disclosed technique;

FIG. 14B is an illustration showing an example of the exploration of abstracted data values using a set relative time operator, constructed and operative in accordance with another embodiment of the disclosed technique; and

FIG. 14C is a schematic illustration of a method for exploring delegate values determined from raw data values and abstracted data values using a set relative time operator, operative in accordance with a further embodiment of the disclosed technique.

### DETAILED DESCRIPTION OF THE EMBODIMENTS

The disclosed technique overcomes the disadvantages of the prior art by providing a novel method and system for selecting, retrieving, visualizing and exploring time-oriented data in multiple subject records and temporal relations of multiple subject records. The time-oriented data can represent raw data as well as abstracted data. According to the disclosed technique, a specification language is generated which enables a worker skilled in the art, not having advanced training in information technologies, statistics or data-mining techniques, to specify subject records, time intervals in subject records and data in subject records as raw data and as abstracted data. It is noted that the abstracted data might require domain-specific knowledge.

Also according to the disclosed technique, corresponding subject record data between different subject records is determined which enables data from a plurality of subjects to be analyzed together. The specified data is then retrieved and displayed graphically along with exploration tools for modifying the visualization of the data. In addition, temporal relations between the specified data can be determined to generate new knowledge. The disclosed technique also relates to an architecture and a computational method for retrieving, from a database storing time-stamped raw data of multiple subject records, at least one of a list of relevant subject records, a list of time intervals or a list of desired data values in the subject records. The retrieving is based upon a set of time-oriented expressions which might rely on domain-specific knowledge.

In general, the disclosed technique can be applied to any group of subjects in any field or domain in which an ontology can be defined, thereby specifying certain domain-specific knowledge-based properties of the concepts and relations among them represented in the ontology. In order to simplify the understanding of the disclosed technique, the disclosed technique will be described herein in the fields of clinical medical research and information security. It will be noted by the worker skilled in the art that these fields are only examples of fields and domains in which the disclosed technique can be used.

In order to understand the disclosed technique, a number of definitions are required. In the fields of data retrieval and data analysis, computer databases are usually used to store large amounts of data. Such databases enable various pieces of data to be stored about particular subjects. For each subject, each piece of data stored can be referred to as a record. The structure of possible records which can be stored in a database is a function of the database's configuration. Also, such databases enable records to be searched and retrieved. Simple databases may only store a few records per subject, whereas complex database may store thousands of records per subject. For example, a simple database may be an elementary school's database of students, wherein each subject in the database represents a student in the school. The records in such a database may include the student's name, date of birth, ID number, address, parents names', name of the person to reach in an emergency, phone number of the person to reach in an emergency, year in the school and the student's grades for subjects taught in the school. Complex databases may be medical databases used in hospitals, wherein each subject in the database represents a patient in the hospital. Besides including records for demographic information about the patient, such as name, address, age, sex and the like, the database may include thousands of records representing tests and procedures the patient has undergone, medications the patient has been prescribed, and medical insurance claims the patient has made.

Unlike simple databases, such complex databases may include a time-stamp on each record. It is noted that in the disclosed technique, the term subject record database may include a plurality of databases. For example, each department in a hospital may have its own database of patients, and therefore, a subject record database of the hospital may include all these databases. Depending on the environment in which the disclosed technique is used, a subject record database may include databases of subject records in different domains.

In fields and domains where computers are used, the terms ‘data’ and ‘information’ are not used as interchangeable words. Data refers to measurements or observations of variables which are usually disorganized and without interpretation, such as a green leaf with black spots, a speed of 65 miles per hour, a concentration of 5 parts per million and the like. Such measurements and observations by themselves do not represent information, as they lack the context in which the measurement or observation was made which enables a reasonable interpretation of the measurement or observation to be given. In this regard, data can be referred to as raw data.

Information, on the other hand, is organized data, meaning data to which a reasonable interpretation has been given via the context in which the measurement or observation was made.

Information can, in this regard, be referred to as abstracted data, or interpreted data, meaning data to which a reasonable interpretation has been given. For example, a test score of 67, without the context of how much the test was out of, does not enable a teacher to give a reasonable interpretation of the test score. All that can be reasonably said was that the person received a test score of 67. Given a particular context, such as the test was out of 70, or the test was out of 100, a reasonable interpretation of the test score can be given. In an example from the medical domain, a hemoglobin (herein abbreviated HGB) value of 11.6 g/dL (grams per deciliter) represents data, or raw data, since the context of the value is not provided. The context is important since the interpretation of the data may change depending on the context. For example, an HGB value of 10.5 g/dL may indicate anemia in an otherwise healthy individual, whereas the same value may represent a normal level of HGB in a patient one week after having undergone a chemotherapy treatment.

In the field of computer science, the term ontology is used to describe a set of concepts about a particular domain and the relations between the concepts in the domain. It is noted that the ontology does not define the concepts but rather what the relevant concepts are for a domain and any relations between those concepts. Concepts substantially represent the terms and ideas used in a particular domain or field of knowledge. Concepts can represent both raw data as well as abstracted data and can be referred to respectively as raw concepts (when raw data is stored for the concept) and abstracted (or abstract) concepts (when abstracted data is stored for the concept). In other words, if a database of subject records in a particular domain is defined based on an ontology of the concepts in that domain, then raw data stored in the database represents the measured parameters for a raw concept. Abstracted data stored in the database represents the interpreted data for an abstract concept, which is sometimes referred to as an abstraction. In the disclosed technique, abstract concepts which relate to time-oriented measured parameters can be referred to as temporal abstractions. For example, concepts in the medical field may include the names of various medications, the terms used for identifying parts of the human body, the types of various surgical procedures that can be performed, names of various known medical conditions and a list of various medical tests that can be administered. An ontology of the medical field would substantially describe all such concepts as well as any relations between them.

It is noted that the relationship between concepts in an ontology may be hierarchical, with certain concepts being derived from other concepts. In this respect, concepts in an ontology can be referred to as higher level concepts or lower level concepts. Also, because abstract concepts are derived from raw concepts, and abstract concepts can also be derived from other abstract concepts, concepts can be referred to as being at a higher or lower level of abstraction. For example, a concept representing the blood cells in the body may be defined as a raw concept called white blood cell (herein abbreviated WBC) in the ontology. Based on this raw concept, additional concepts related to WBCs, such as abstract concepts relating to WBCs can be derived.

For example, in a medical ontology, a WBC-state abstract concept and a WBC-gradient abstract concept may be derived from the WBC raw concept, where the WBC-state abstract concept represents a count of white blood cells in an individual and the WBC-gradient abstract concept represents the change in the count of WBCs in an individual over time. The abstract concepts WBC-state and WBC-gradient are at a higher level of abstraction than the raw concept WBC. In another example regarding a medical ontology, a concept in such an ontology as multiple-organ toxicity pattern may be derived from three separate concepts such a renal-state abstract concept, a liver-state abstract concept and a myelotoxicity-state abstract concept, each of which may in turn be derived from other abstract concepts and raw concepts. The abstract concept multiple-organ toxicity pattern is at a higher level of abstraction than the abstract concepts renal-state, liver-state and myelotoxicity-state. Concepts in the field of information security may include terms for describing computer usage, network activity, the names of the parts of a computer, terms for describing the hierarchy of computers and servers connected as a network, and the like. As above, an ontology of the information security field would substantially describe all such concepts as well as any relations between them. It is noted that in relation to a database, the records stored for a subject in a database substantially represent the values of concepts stored for the subject in the database.

Concepts are necessary in many fields and domains of knowledge for providing the necessary context of interpretation to convert observable raw data in the field or domain to abstracted data and information in the field or domain, as shown in the examples above regarding a test score and an HGB value. As mentioned above, an ontology includes the various concepts related to a particular domain, which substantially represents the kind of data which a person skilled in the art of that domain would want to store in a database for assorted reasons, such as analysis, decision making, generation of new knowledge, resource management and the like. In some domains, such as the medical domain, such extensive lists of concepts, which are not proper ontologies, exist and are available to the public, such as the Unified Medical Language System (herein abbreviated UMLS) and the Systematized Nomenclature of Medicine—Clinical Terms (herein abbreviated SNOMED CT). Both UMLS and SNOMED CT are considered international medical standard vocabularies, which include identification codes for concepts (both raw and abstract) as well as definitions for which parameters are measured for a given raw concept and sometimes for a given abstract concept as well as. Yet such vocabularies do not represent proper ontologies, let alone knowledge bases. In other domains, such as the information security domain, such lists of concepts as well as ontologies linking such concepts may exist as proprietary ontologies or may not exist at all. It is noted that defining an ontology of concepts and building a knowledge base based on such an ontology is known in the art, with the actual structure of the ontology, including which concepts are included and which are omitted, as well as the actual structure of the knowledge base being a matter of design choice of the worker skilled in the art.

Based on the concepts defined in a domain and an ontology of those concepts that define the relations between concepts, a knowledge base (herein abbreviated KB) in the domain can be defined. A KB represents the properties and definitions of the concepts in the ontology, and substantially represents an additional level of information (i.e., knowledge) regarding the concepts in the ontology. For example, a KB in the medical domain could define which of the various medical tests in the ontology can be administered to determine the presence of which particular disease a patient may have. A KB could also define the relevant values of each respective test that determine the presence and/or severity of the disease. Such properties may also include the definition of terms such as a ‘high’ or ‘low’ level for an abstract concept that derives from a raw concept. For example, a raw concept such as hemoglobin may be defined in a medical ontology as well as an abstract concept such as hemoglobin-state, which represents the concentration of hemoglobin in the blood of a person. The ontology would also include the relationship between these two concepts. Yet the KB would include the definition for a ‘high level,’ ‘normal level’ and a ‘low level’ of the hemoglobin-state abstract concept. The KB would also include various definitions for ‘high level,’ ‘normal level’ and ‘low level’ if relevant contexts of the hemoglobin-state abstract concept change the definition of such levels. For example, for the hemoglobin-state abstract concept, the KB may store the following contexts and definitions for various levels of hemoglobin in a person, as shown in Table 1.

TABLE 1
Contexts and levels of hemoglobin in a person

| Context | Low level (g/dL) | Normal level (g/dL) | High level (g/dL) |
|---|---|---|---|
| Male Adult | <8 | 13.5-17 | >20 |
| Female | <8 | 12-15 | >20 |
| Adult | | | |
| Pregnancy | | 11-12 | |
| Newborn | | 14-24 | |
| Child | | 11-16 | |

Other properties which a KB may store can include temporal properties of concepts in the ontology, such as whether two time periods of a particular concept are concatenable as well as the time period an observation of a value of a concept is valid. For example, two neighboring time periods of high fever may be defined as one (i.e., can be concatenated) in a normal individual, but may not be in an individual following pregnancy. Also, the measured height of an individual may represent a valid observation of height for a significantly longer period of time than the time period of the validity of the measured value of an individual's hemoglobin-state abstract concept.

It is noted that in the disclosed technique, the term domain knowledge base may refer to a knowledge base that includes a plurality of domain knowledge bases. For example, a domain knowledge base may include domain knowledge bases in the domains of medicine, information security, household management and business marketing. In general, knowledge bases provide the context of the concepts defined in an ontology. Providing the context of a concept is necessary as data for a particular concept may have different, even contradictory definitions, depending on the domain in which the data is stored. Age in the domain of medicine may represent the age of a patient, whereas age in the domain of information security may represent the age of a computer. Likewise, age in the domain of information security may also represent the age of a piece of software.

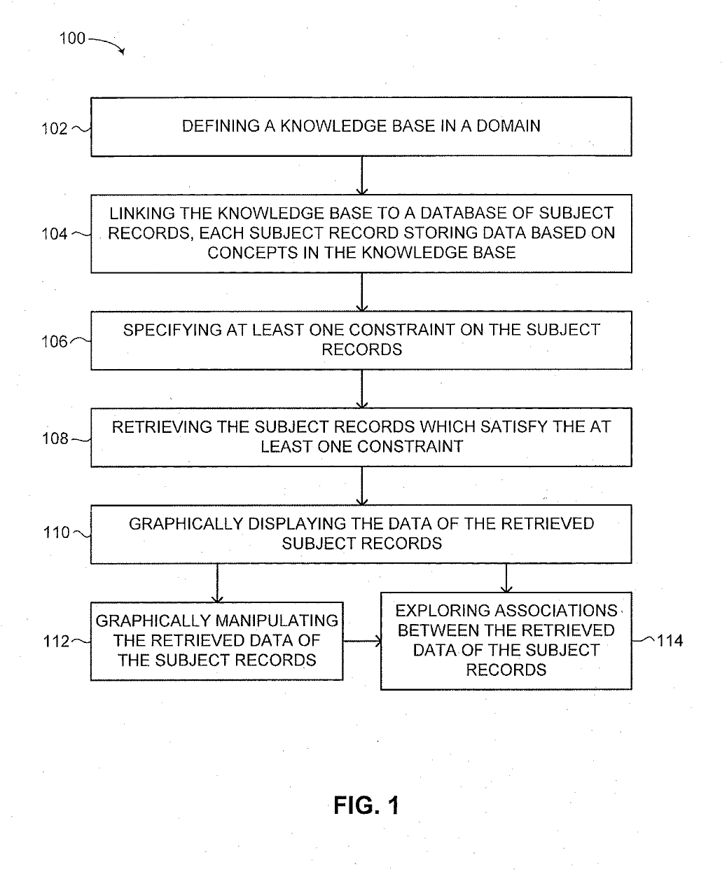

According to the disclosed technique, as described below in more detail in FIG. 1, once a knowledge base has been defined, a method known as knowledge-based temporal abstraction (herein abbreviated KBTA) can be used to derive knowledge-based interpretations of data (either raw data or abstracted data) stored in a database. The KBTA method can also be used to generate representative values of groups of data stored in the database. A KBTA method requires a set of concepts, an ontology and a knowledge base which includes, as mentioned above, the properties and definitions of the concepts in the ontology. In a KBTA method, a set of time-stamped measurable concepts, i.e., raw data, is provided as input as well as specific external events which define the contexts in which the measurable concepts were measured. The specific external events substantially create the necessary interpretation contexts for abstracting the raw data, as different contexts may change the interpretation of the data. The KBTA method outputs a set of interval-based, context-specific concepts which are at the same level of abstraction, or a higher level of abstraction than the level of abstraction of the set of time-stamped measurable concepts, as well as the respective values of the set of interval-based, context-specific concepts. For example, in the medical domain, measurable concepts may be the platelet count and the red blood cell count of an individual, and an external event may be after a bone marrow transplant. The external event substantially defines the interpretation context of the measurable concepts, for example, the platelet count and red blood cell count after a particular chemotherapy protocol was used. An example of the output of such parameters could be a period of two months of grade 1 bone marrow toxicity in the context of the particular chemotherapy protocol used, with the respective values of the platelet count and the red blood cell count for that time period.

Reference is now made to FIG. 1, which is a schematic illustration of a method for selecting, retrieving, visualizing and exploring time-oriented data, generally referenced 100, operative in accordance with an embodiment of the disclosed technique. In procedure 102, a knowledge base in a domain is defined. As mentioned above, the disclosed technique applies to any domain wherein an ontology of concepts in the domain can be defined and as such a knowledge base can be defined. In this procedure, for a particular domain, a knowledge base which provides definitions and properties about the concepts in the domain is defined. It is assumed in this procedure that the concepts and the ontology have already been defined or already exist. If not, then the concepts in a particular domain and an ontology relating the concepts to one another are first defined, and then the knowledge base is defined. As mentioned above, for example, a knowledge base in the field of information security may include an ontology of concepts such as the types of computers which can connect to a network, the types of operating systems the computers can use, as well as definitions and properties of such concepts for describing normal computer usage, such as CPU usage, memory usage, time periods of interest, including relative time periods, such as number of days after an anti-virus program was installed and the like. Each concept substantially represents either a piece of data which a user would want to store about a subject relevant to the domain of information security, the context in which the stored data is to be interpreted or an abstract concept which is derived from low level abstract concepts or from raw concepts. In the field of information security, the subject may be a computer station, with data stored about the type of computer at the computer station, the operating system it uses, various specifications about its internal parts, and the amount of memory it uses every hour. Concepts which relate to a context in such a knowledge base could include the concept of relative time after anti-virus installation. It is noted that the knowledge base defined in procedure 102 may be quite extensive and may include definitions and properties for hundreds of concepts.

In procedure 104, a database of subject records is linked to the knowledge base defined in procedure 102, with each subject record in the database being based on at least one concept defined in the knowledge base. A state of the art method for linking a knowledge base to subject records in a database has been shown in the article “An architecture for linking medical decision-support applications to clinical databases and its evaluation,” to German-Shahar et al. in The Journal of BioMedical Informatics 42(2), 2009, 203-218. In general, in the field of data analysis and data exploration, databases of data exist. In this procedure, the concepts defined in the knowledge base are linked to the subject records stored in the database such that the data in the database can be accessed according to those concepts. Using the concepts defined in the knowledge base, the database of subject records can be accessed. The database structure is a matter of design choice and depends on the domain in which the disclosed technique is used, and in particular the subject of the domain and the data regarding the subject which is to be stored in the database. At least part of the data stored in the database in procedure 104 is time-stamped data. It is noted that in most domains and fields in which the disclosed technique is used, procedures 102 and 104 are executed as knowledge bases in the domain may not exist yet databases in the field do exist and with the definition of the knowledge base, the concepts defined can be linked to the database. In select fields, a knowledge base may exist, and in these instances procedure 102 is optional. In addition, in select fields, databases of data may not exist, therefore before procedure 104 is executed in such fields, a database of data based on the concepts defined in the knowledge base must be generated first. For example, in the medical domain, vocabulary lists of medical concepts already exist, and databases of subject records based on such vocabulary lists already exist, such as the databases hospitals have of their patients, and the databases health clinics have of their clientele. Yet in this domain, knowledge bases do not necessarily exist, which must nonetheless be linked to the existing databases as per procedure 104. In the medical domain, procedures 102 and 104 are substantially mandatory procedures. In other domains, where ontologies of the concepts to be defined in the knowledge base may not exist or databases containing subject records based on the concepts defined in the knowledge base may not exist, then additional procedures, as mentioned above, are executed before procedures 102 and 104 are executed. For example, in the domain of resource management in residential homes, ontologies and databases may not exist defining the relevant concepts in the domain and storing data about resource management in residential homes. In such a domain, before procedures 102 and 104 are executed, an ontology of concepts in the domain are defined and a database of data about subject records in the domain is generated.

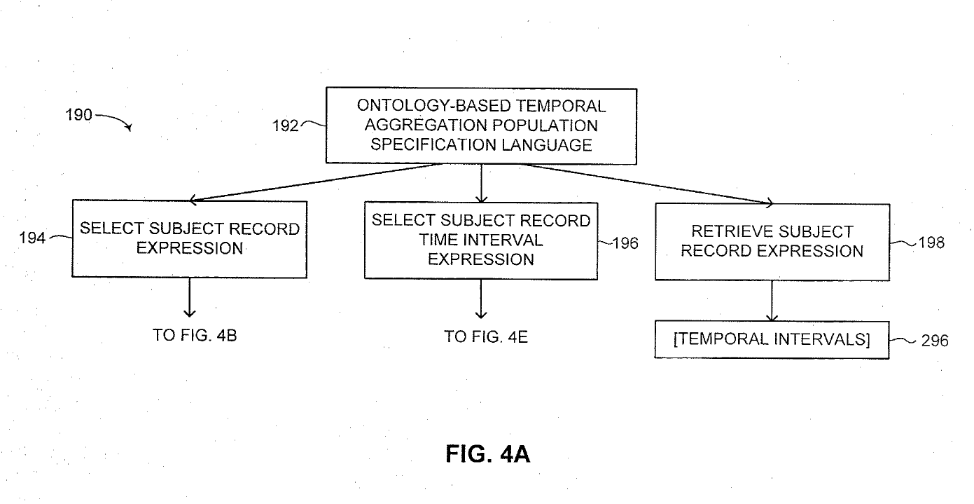

In procedure 106, at least one constraint is specified on the subject records in the database generated in procedure 104. It is noted that the database in procedure 104 requires at least one subject record. Therefore, the at least one constraint specified in procedure 106 is specified on at least one subject record in the database linked to in procedure 104. As mentioned above, the disclosed technique relates to the analysis and exploration of time-oriented raw data and abstracted data in multiple subject records. In such a task, when analyzing the data in the subject records, constraints are substantially placed on the subject records in the database to increase the likelihood that associations, in particular temporal associations, can be determined between various concepts as stored in the subject records. In this procedure, at least one constraint is placed on the subject records in the database, although a plurality of constraints may be placed. The various types of constraints which can be placed on a subject record are described below with reference to FIGS. 4A-4E. The constraints specified in this procedure are substantially equivalent to specifying a search query regarding data in a database. Just as a search query in a web browser specifies the data or information a user is looking for in a website, the constraints specified in this procedure represent a search query of the subject records in the database a user is looking for. As described below in much greater detail, the constraints which can be specified can be divided up into three different types of expressions regarding the data stored in each subject record. One type of expression concerns the subject records themselves and represents a search query of subject records satisfying the at least one constraint specified. A second type of expression concerns time intervals in the data stored in each subject record and represents a search query of time intervals in each subject record which satisfy the at least one constraint specified. It is noted that part of the data stored in the database in procedure 104 is time-oriented raw data and time-oriented abstracted data, therefore, time intervals relating to the time-oriented raw and abstracted data exist and can be searched. A third type of expression concerns the stored data itself and represents a search query of data stored in each subject record. These three types of expressions are explained below in greater detail in FIGS. 4A-4E.

In procedure 108, the subject records, time intervals or data which satisfy the at least one constraint are retrieved from the database. It is noted that depending on the constraints specified, no subject record, time interval or piece of data in the database may match the constraints specified. In such a case, nothing is retrieved. As described below, in FIGS. 4A-4E, the constraints specified may specify raw or abstracted data. In the case of raw data, if data exists in the database which satisfies the constraints specified, then the data is retrieved. In the case of abstracted data, the data may exist as stored data in the database, or the data may not exist but can be determined based on corresponding raw data stored in the database. In the former case, if the abstracted data exists in the database and satisfies the constraints specified, then the data is retrieved. In the latter case, if the abstracted data does not exist in the database (i.e., it isn't stored in the database as a record for a particular subject) but can be determined based on corresponding raw data stored in the database which satisfies the constraints specified, then in procedure 108, the abstracted data is determined and retrieved. In this procedure, the abstracted data may be determined, or derived based on a KBTA method, as mentioned above.

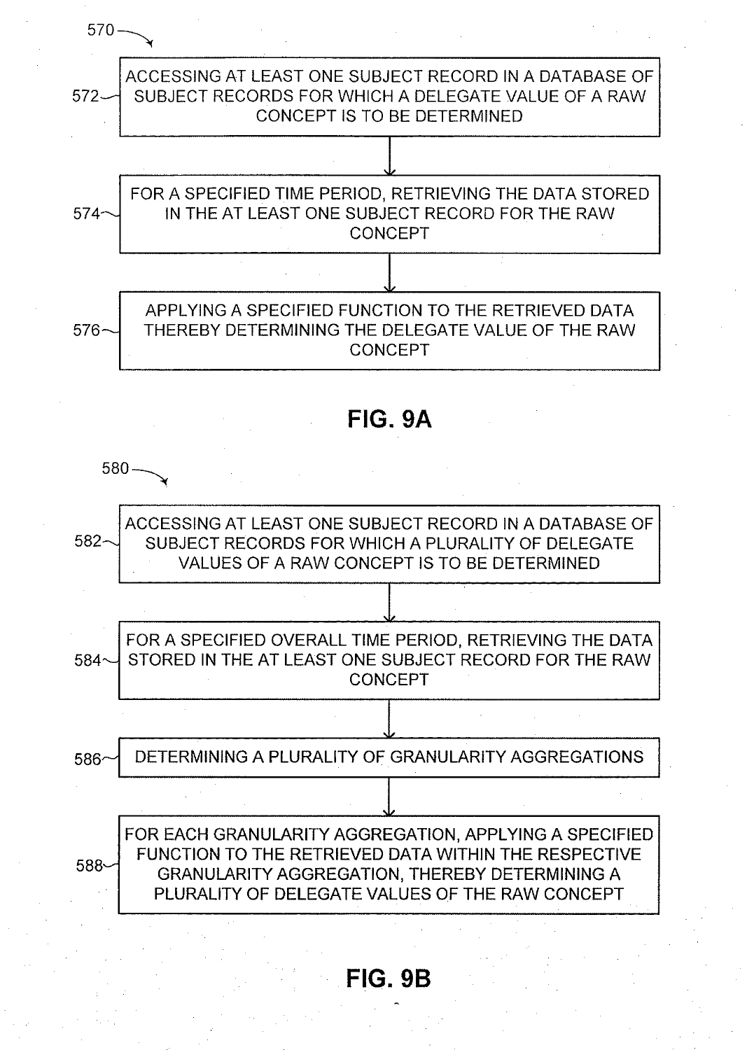

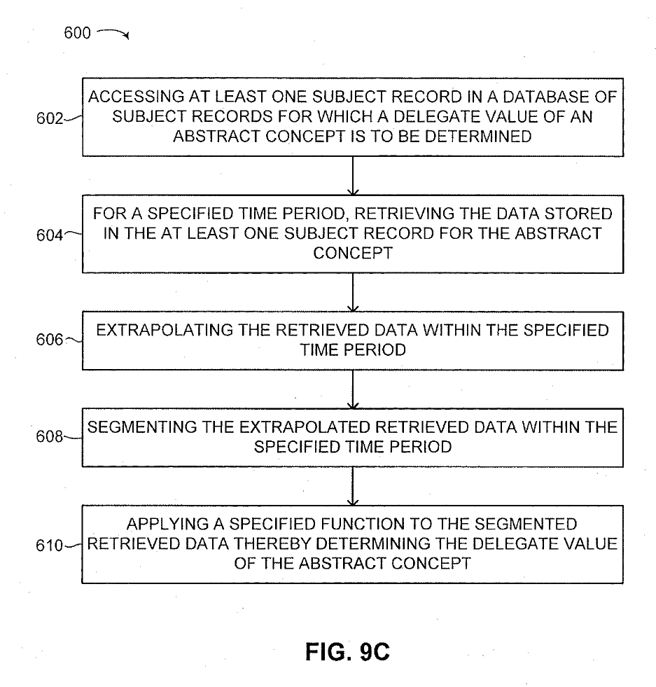

In procedure 110, the data of the retrieved subject records and time intervals are displayed graphically to the user. As specified below in FIGS. 11A, 11B, the visualization of the data enables a worker skilled in the art to view time-oriented data, stored in subject records, of a plurality of subjects. In the field of information extraction, workers skilled in the art attempt to find and derive patterns in data over time. Graphically displaying time-oriented data, including data representative of temporal abstractions, simplifies and eases the ability of the worker skilled in the art to determine patterns in the data over time, if they exist. The data displayed can be displayed in multiple forms, such as in various types of list and various types of graphs (e.g., bar graph, circle graph, line graph, histogram and the like). In general, when the data is displayed as a graph, since the stored data is time-oriented, at least one axis of the graph represents time.

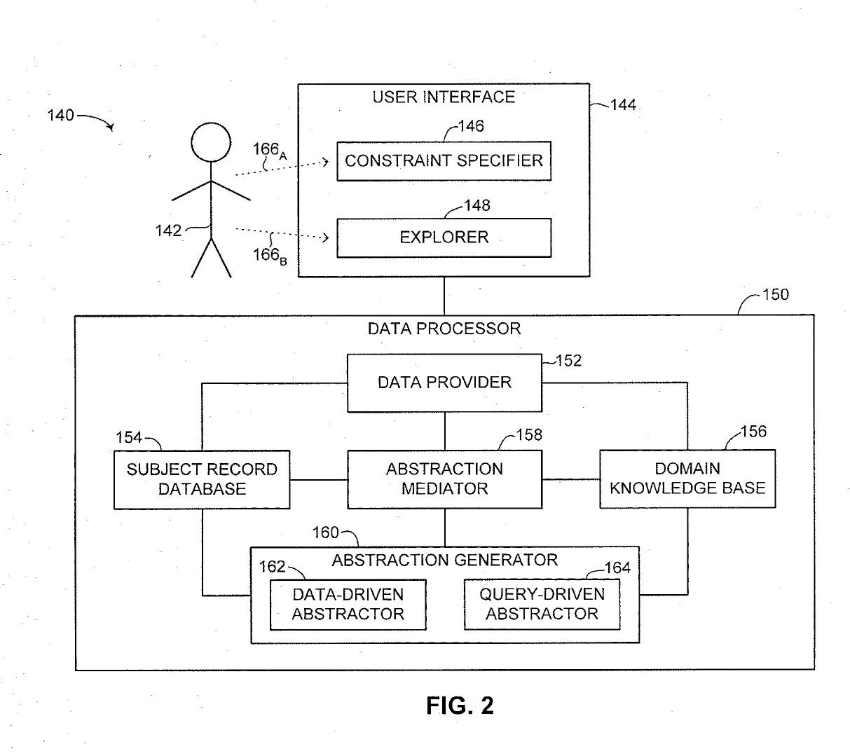

In procedure 112, the retrieved data of the subject records is manipulated graphically. As described below in FIGS. 11A, 11B, 12A, 12C, 13A, 13B, 14A and 14B, the graphical manipulations can include changing the scale at which the data is displayed at, as well as displaying statistical properties of the data shown, such as the mean, the mode, the median, the standard deviation and the like. As described below in FIG. 2, in the case of abstracted data being displayed, which is usually measured using discrete values, a change in the time scale may necessitate a recalculation of the distribution of values displayed according to the smallest unit of the time scale selected.

In procedure 114, associations between the retrieved data of the subject records' is explored. It is noted that the term ‘explore’ is used throughout the description to refer to determining whether patterns, correlations or interrelations exist in the data of a subject or in the data of multiple subjects. In this respect, in this procedure data from multiple subjects is graphically displayed and compared, to determine whether associations exist between the data.

In general, the associations which are explored are either temporal associations or statistical associations between the data of multiple subjects. Such temporal or statistical associations may represent new knowledge in the field or domain of the subjects stored in the database. It is noted that this procedure can also include at least one of retrieving, computing and displaying explored associations between the data at a specified aggregation granularity, as explained below in FIG. 4E, over a specified time period. It is noted that procedure 112 is an optional procedure and that after procedure 110 is executed, procedure 114 can be executed.

The method of FIG. 1 generates the necessary input as required in procedure 108 for a method for KBTA. Based on procedures 102-106, a set of time-stamped measurable concepts and external events, as defined by the knowledge base, are specified from the subject records stored in the database. The time-stamped measurable concepts represent the raw data which is stored in the subject records for the concepts defined in a particular domain, such as HGB value, platelet count, insulin concentration and the like in the medical domain, and CPU usage, memory usage, number of registry key changes and the like in the information security domain. The external events create the contexts in which the time-stamped measurable concepts are to be interpreted, for example, after a chemotherapy treatment, after a bone marrow transplant and the like in the medical domain, and after a firmware upgrade, after an anti-virus installation and the like in the information security domain. The external events generate necessary interpretation contexts which can change the meaning and the interpretation of the raw data stored in the subject records. In procedure 108, as part of the procedure of retrieving the subject records which satisfy the constraints specified, the KBTA method outputs a set of time interval-based, context specific concepts along with their respective values. The values either represent the raw data or abstracted data stored in the subject records or abstracted data that can be determined from the raw data using the concepts defined in the knowledge base of procedure 102. It is noted that what is outputted, i.e., what is retrieved, can be at the same level of abstraction as specified in the set of constraints or can be at a higher level of abstraction. For example, the constraints may specify that raw data is returned from the subject records or that abstracted data be returned from the subject records. Afterwards, the method of FIG. 1 enables a user to explore and manipulate the outputted data from a KBTA method to determine whether temporal associations exist between the time interval-based, context specific concepts retrieved (procedures 110-114).

Reference is now made to FIG. 2, which is a schematic illustration of a system, generally referenced 140, for selecting, retrieving, visualizing and exploring time-oriented data, constructed and operative in accordance with another embodiment of the disclosed technique. System 140 includes a user interface 144 and a data processor 150. User interface 144 includes a constraint specifier 146 and an explorer 148. Data processor 150 includes a data provider 152, an abstraction mediator 158, a subject record database 154, a domain knowledge base 156 and an abstraction generator 160. Abstraction generator 160 includes data-driven abstractor 162 and query-driven abstractor 164. User interface 144 is coupled with data processor 150. In one embodiment of the disclosed technique, user interface 144 is coupled with data processor 150 by coupling each of constraint specifier 146 and explorer 148 to data provider 152. Data provider 152 is coupled with abstraction mediator 158, subject record database 154 and domain knowledge base 156. Abstraction mediator 158 is coupled with subject record database 154, domain knowledge base 156 and abstraction generator 160. Abstraction generator 160 is coupled with subject record database 154 and domain knowledge base 156.

A user 142 interacts with system 140 via user interface 144. User interface 144 is a graphical user interface (herein abbreviated GUI) and may be constructed as a windows-based application. It is noted that other embodiments of user interface 144 are possible, such as a text-based interface, a speech-based interface and a web-based interface. In general, user 142 interacts with system 140 to execute two different, yet related functions. Recall that user 142 represents a skilled worker in a particular domain who wants to explore the existence of associations between time-stamped data of multiple subjects each having multiple subject records, such as a medical clinician or an information security analyst. One function, as shown by a dotted arrow 166_{A}, is to search a database of subjects by specifying constraints on a search query. This is executed by user 142 accessing constraint specifier 146. Constraint specifier 146 enables user 142 to specify particular constraints which either relate to subject records, time intervals in the data of subject records or the data of subject records, where data may be represented as raw data or abstracted data. The various types of constraints which can be specified in a search query of subject records are described below with reference to FIGS. 4A-4E. The constraints which can be specified are described below in a specification language which is substantially general enough to include a plurality of domains and fields. The particular values which can be constrained based on the specification language described below are specific to the domain in which system 140 is used and are defined in a knowledge base.

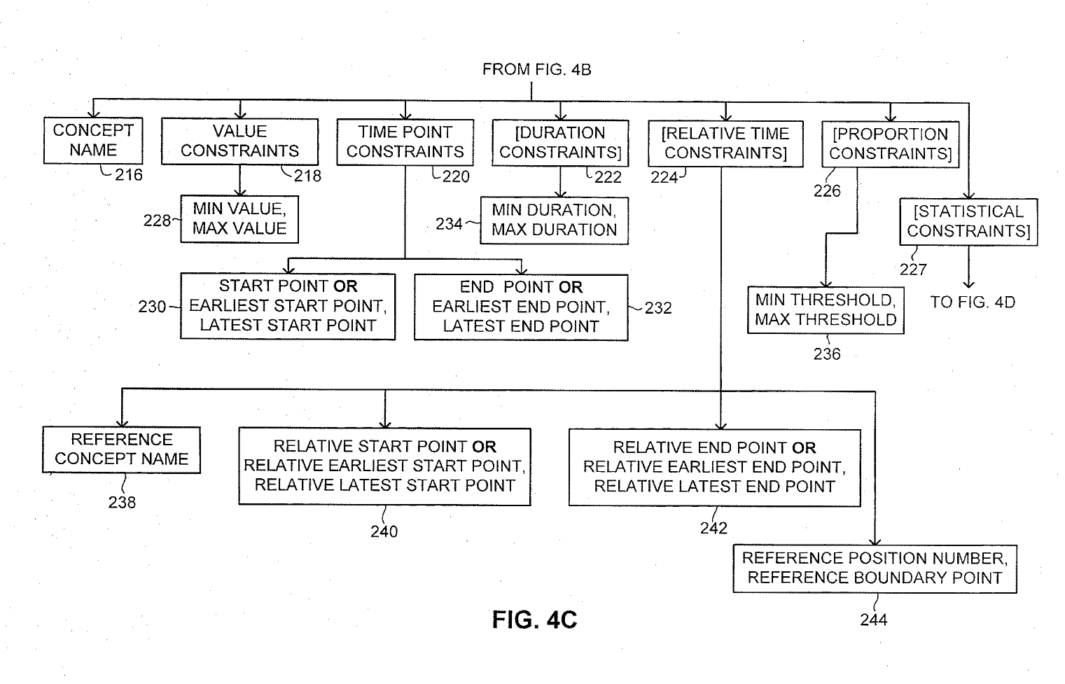

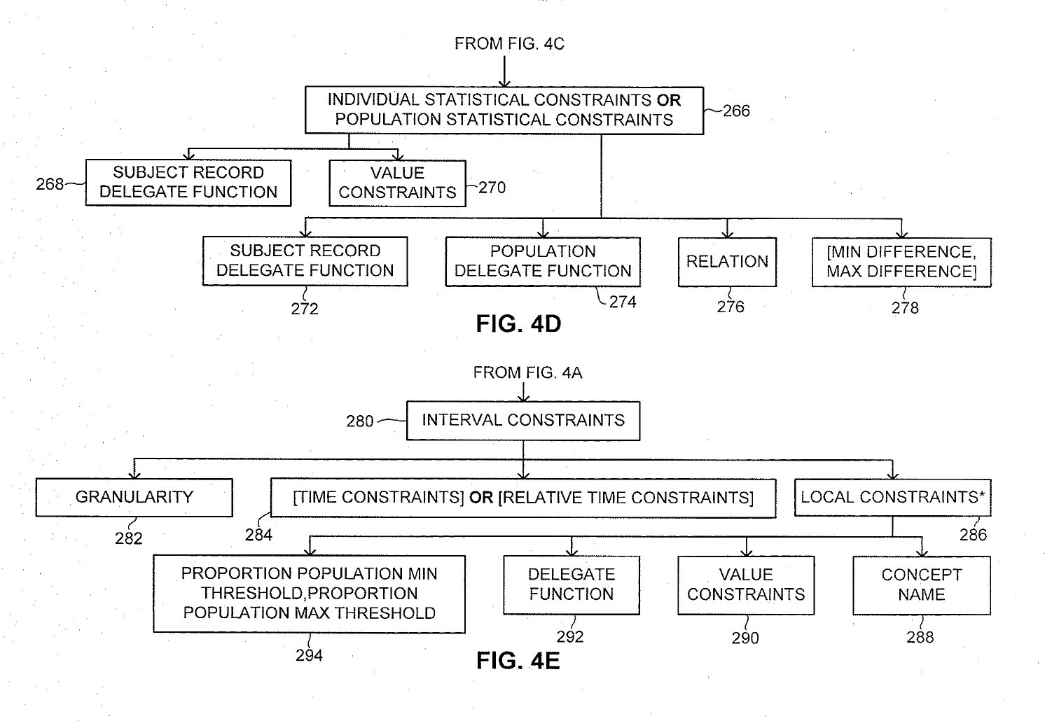

For example, in the medical domain, a concept such as HGB value can be constrained on a range of values in units of grams per deciliter, whereas in a home residence domain, a concept such as area can be constrained on a range of values in units of meters squared. Constraint specifier 146 may be embodied as a GUI search engine, as shown below and described in FIGS. 6 and 7, as well as a text-based search engine. User 142 specifies particular constraints on the subject records via constraint specifier 146, which generates a search query based on the specified constraints. The search query may be represented as an extensible markup language (herein abbreviated XML) expression. At minimum, the search query generated specifies at least one database of subject records to be searched, at least one constraint on the subject records and at least one knowledge base which includes at least one concept that defines the at least one constraint specified. Recall that system 140 enables raw data as well as abstracted data to be retrieved and that abstracted data substantially represents data interpreted in a given context, which is specified by a concept in an ontology or knowledge base. The general form of the search query is described in more detail in FIGS. 4A-4E.

The generated search query, which includes a reference to at least one database, at least one constraint and at least one knowledge base, is passed from constraint specifier 146 to data provider 152. Data provider 152 analyzes the generated search query to determine the type of the at least one constraint specified. Once the type of the constraint, or constraints, has been determined, data provider 152 searches through subject record database 154 for the subject record, time interval or piece of data in a subject record, as specified by the at least one constraint. Subject record database 154 may include a plurality of databases. It is noted that data provider 152 operates with the type of constraints specified by constraint specifier 146 as well as the values stored for concepts in subject record database 154.

If the data specified by user 142 in constraint specifier 146 is raw data, then data provider 152 accesses subject record database 154 and retrieves the requested data. As explained below, the data may be a list of subjects, data stored in the subject records or time intervals. If the data specified by user 142 is abstracted data, then data provider 152 accesses subject record database 154 to determine if the requested abstracted data is stored in subject records of subject record database 154. If the abstracted data is stored in the subject records, then data provider 152 accesses subject record database 154 and retrieves the requested data. If the requested data is not in subject record database 154, then data provider 152 provides the computational task of determining the requested data to abstraction mediator 158. Abstraction mediator 158 analyzes the computational task and determines which concepts and concept definitions in domain knowledge base 156 are required for determining the abstraction specified in the task. Recall that concept definitions can include the properties of a concept, such as how discrete values such as ‘high’ and ‘low’ are determined for the concept, if two time intervals of the concepts can be interpolated into a single time interval, and the like. It is noted that the abstraction substantially represents the properties and context in which the at least one constraint is to be interpreted in retrieving the requested data. The context of the at least one constraint is necessary as a particular constraint may have different, even contradictory definitions, depending on the domain in which the constraint is defined, as described above. The context of the at least one constraint is therefore substantially necessary in order to disambiguate the at least one constraint and better understand what user 142 is searching for. It is noted that domain knowledge base 156 may include a plurality of domain knowledge bases.

Abstraction mediator 158 also determines which subject records, and what data in these subject records, need to be accessed to generate the abstracted data requested by user 142. Abstraction mediator 158 then provides the subject records and data, from subject record database 154 and concepts from domain knowledge base 156 to abstraction generator 160. Abstraction generator 160 then provides this information to query-driven abstractor 164, which determines the requested abstracted data. The requested abstracted data is provided, via abstraction mediator 158 to data provider 152 which then provides the requested abstracted data to user 142. The requested abstracted data may also be stored in the appropriate subject records in subject record database 154.

In general, subject record database 154 only includes raw data. According to the disclosed technique, system 140 also includes data-driven abstractor 162. Data-driven abstractor 162 determines abstracted data, i.e., temporal abstractions, for all subjects stored in subject record database 154, based on the concepts defined in domain knowledge base 156. The abstracted data generated is stored in a separate layer in subject record database 154. As subjects may be constantly added to subject record database 154, and as many concepts may be defined in domain knowledge base 156, data-driven abstractor is constantly operating to generate abstracted data for all concepts for all subjects in subject record database 154. As new subjects are added to subject record database 154, and as new concepts are added to domain knowledge base 156, new abstracted data is generated and stored for all subject records in subject record database 154 by data-driven abstractor 162. Therefore, when data provider 152 is provided with a generated search query requesting abstracted data, if data-driven abstractor 162 has already calculated the requested abstracted data, then data provider 152 can access this data in subject record database 154. If data-driven abstractor 162 has not calculated the requested abstracted data, then data provider 152 provides the computational task of determining the requested abstracted data to abstraction mediator 158. Abstraction mediator 158 provides the necessary data from subject record database 154 and domain knowledge base 156 to abstraction generator 160, which provides this data to query-driven abstractor 164 which determines the abstracted data on the fly and provides it back to data provider 152. In general, abstraction generator 160 determines the necessary context of the concepts specified in the user's search query (i.e., the constraints) as well as determining the requested abstracted data. Abstraction generator 160 substantially executes the task of determining temporal abstractions (i.e., abstracted data) using a KBTA method. In one embodiment of the disclosed technique, the temporal abstraction, i.e., abstracted data, determined by query-driven abstractor 164 is also stored in subject record database 154. Therefore, if user 142 subsequently requests substantially similar abstracted data, data provider 152 can retrieve the requested data directly from subject record database 154 and the abstracted data does not need to be determined by query-driven abstractor 164 an additional time. It is noted that data provider 152, abstraction mediator 158 and abstraction generator 160 can be constructed based on different programming languages.

For example, data provider 152 can be constructed using the programming languages SQL or C# and abstraction generator 160 can be constructed using the programming languages C# or Prolog. The worker skilled in the art is aware that many other suitable programming languages exist for constructing these elements of system 140.

It is noted that data provider 152 and explorer 148 (as described below) are involved in determining aggregated values for multiple entries in a particular subject record. As described below, constraint specified 146 enables various constraints to be specified on subject records, including constraints that are time related. According to the disclosed technique, data from a plurality of subject records can be analyzed together and compared over time, even when such data, as raw data or abstracted data, is stored using different time scales. In order to compare data from a plurality of subject records, and depending on the constraints specified, the data stored in a subject record may need to be aggregated into a single value to enable a comparison. For example, in the medical research domain, a subject, such as a patient, may have multiple records for blood glucose level tests done throughout the year. In some months, there may be many such records, whereas in other months, there may be very few or none. A medical researcher may want to view and explore the blood glucose levels of such a patient on a time scale of months, even though the time-stamp for the record of blood glucose level tests is stored on a time scale of days. According to the disclosed technique, both data provider 152 and explorer 148 can determine a representative, or delegate value of a record on a specified time scale, using a representative, or delegate function to determine such a value. In the example given above, the delegate value determined by data provider 152 may be a single value representing the blood glucose level of the patient for each month. This delegate value is determined by a delegate function, which can be specified by the user in constraint specifier 146. For example, the delegate function may be the mean, i.e., the delegate value representing the blood glucose level of the patient per month will be the mean blood glucose level per month as determined according to the blood glucose levels stored in the patient's records. The delegate function could also be the maximum value, i.e., the delegate value representing the blood glucose level of the patient per month will be the maximum blood glucose level stored per month in the patient's records. In general, given a set of time-oriented values stored in a subject record for a particular concept, stored as either raw data or abstracted data on a predefined time scale, over a particular time interval, data provider 152 can determine a delegate value for the time-oriented values stored for the particular concept. The delegate value can be determined for a specified time scale at the minimum resolution of the time scale specified (e.g., if the time-oriented values stored for a particular concept are stored on a time scale of days, then a delegate value can be determined for each day of the year in which values are stored in the subject record for that particular concept, but not on a time scale smaller than days, such as hours or minutes nor on days in which no values are stored in the subject record) or for a specified time interval, using a delegate function specified by a user. It is noted that the choice of delegate function for a particular concept may be constrained by definitions in the KB. In other words, for each concept in the KB, a list of reasonable delegate functions may be stored and a user may only specify a delegate function from the list of reasonable delegate functions stored. Also, the delegate function selected may be particular to the time scale specified. The delegate value is returned by data provider 152 to user 142 via explorer 148 and represents the value for the concept specified which is used in explorer 148 for further analysis at the time scale specified, as described below.

Once the requested data by user 142 has been accessed, or generated, data provider 152 provides the requested data back to user 142 via explorer 148. At this point, the other function, as shown by a dotted arrow 166_{B}, of system 140 can be accessed by user 142 via explorer 148. Explorer 148 represents a GUI for visualizing, manipulating and exploring the requested data. In general, the requested data is visualized in explorer 148 as either a list or a type of graph, depending on whether the user 142 requested subject records to be returned, time intervals in the data of subject records to be returned or data in the subject records to be returned. It is noted that to display the requested data visually explorer 148 may need to execute calculations not performed by data provider 152, and may also need to determine requested delegate values independently of data provider 152. For example, in the information security domain, if user 142 wanted to know which computers in a network experienced above average registry key changes over the past month, a list may be returned with the ID of each computer which matches the constraint defined by the user. On the other hand, if the at least one constraint defined by the user relates to data in subject records, then the data returned may be displayed on a 2-dimensional (herein abbreviated 2D) graph. Since the data in the subject records is time-stamped, for a 2D graph, the horizontal axis is used to represent time whereas the vertical axis is used to represent the value of the data retrieved.

If the data retrieved represents raw data in the subject records, then three different types of data can be represented on the graph (this is shown in greater detail below in FIG. 11A). As an example, assume that a single concept in multiple subject records is requested as per the at least one constraint defined by the user, for example, the HGB value for a group of 60 patients over the course of the past 6 months. The first type of data displayed is the actual raw data stored in each subject record for the concept specified according to the at least one constraint. In the example given above, this would represent the data representing the HGB value of each of the 60 patients. It is noted that even though the HGB value represents a single concept in a medical ontology, because each patient may have had more than one measure of their HGB value recorded over the past 6 months, each patient may have multiple HGB value entries in their respective subject record. Therefore, the first type of data represented on the graph would be all the HGB values for all the 60 patients over the past 6 months, which could be represented as data points on the graph. The horizontal axis of the graph would represent time and would span 6 months, for example at intervals of days, whereas the vertical axis of the graph would represent the units in which an HGB value is measured, such as grams per deciliter of blood. The second type of data displayed represents time-oriented statistical values which relate to the data of the entire population of subject records displayed. Like the first type of data displayed, this type of data is displayed graphically. Using the above example, for each date on which an HGB value was entered for the 60 patients, assuming that more than one patient had an HGB value on the same day, the maximum value of the HGB value, the minimum value of the HGB value and the average value of the HGB value for that day can be displayed, with respective lines connecting the respective maximum values, minimum values and average values. In this respect, a medical clinician can determine if there has been a substantial change in the HGB value of the population of 60 patients over the past 6 months. The third type of data displayed represents statistical values which relate to all the data points of the subject records currently displayed. This type of data is displayed numerically and not graphically. For example, standard statistical values may be numerically displayed such as mean (i.e., average), mode, median, maximum value, minimum value and standard deviation, either on the graph or in a side window next to the graph. It is noted that the third type of data displayed does not take into account the time-oriented nature of the data points displayed, unlike the second type of data which does. Using the example above, the average presented numerically as the third type of data would represent the average HGB value for all HGB values for all 60 patients over the past 6 months, as displayed on the graph, i.e., a single number to represent the overall average HGB value. The average represented graphically as the second type of data would represent the average HGB value for a given day, i.e., many numbers, each representing the average HGB value of a single day, which can be connected as a line and displayed graphically.

If the data retrieved represents abstract data in the subject records, then a modified bar chart may be used to display the data (this is shown in greater detail below in FIG. 11B). Recall that abstract data is contextually sensitive. The horizontal and vertical scales used to represent the data can therefore represent respectively relative values (horizontal scale) and discrete values (vertical scale) that depend on the context of the data displayed. This is shown in greater detail below, for example, in FIGS. 11A and 11B. In addition, the horizontal and vertical scales used to represent the data can also represent respectively absolute values (horizontal scale) and continuous numeric values (vertical scale) depending on how the concepts (for which data is displayed) are defined in domain knowledge base 156. For example, if the data displayed, based on the specified constraints in constraint specifier 146, is the amount over time of a certain protein in the blood after a given surgical procedure, then the horizontal axis will represent time, although the scale may be a measure of how many days after the surgical procedure. In other words, instead of representing absolute time values, such as seconds and days, the time scale may represent relative time values, such as the number of days after the surgical procedure (e.g., 1 day after procedure, 2 days after procedure, 3 days after procedure, etc. . . . ). Although it is noted that an absolute time scale may also be used to display the data depending on how the user specified the data to be displayed. The vertical axis may also not represent a continuous numeric value, such as the concentration of the protein in the blood, but rather may represent a discrete value, such as whether the amount of protein in the blood is considered very low, low, normal, high or very high. The concept used (i.e., the type of constraint specified) to determine the context of the data displayed will affect the nature of the vertical axis. In the example above, if the constraint used is concentration of a protein, then the vertical axis will represent a continuous numeric scale, whereas if the constraint used is a state abstraction of the concentration of the protein (i.e., to what degree is the amount of protein indicative of it being low, normal, high and the like in an individual), then the vertical axis will represent a discrete scale.

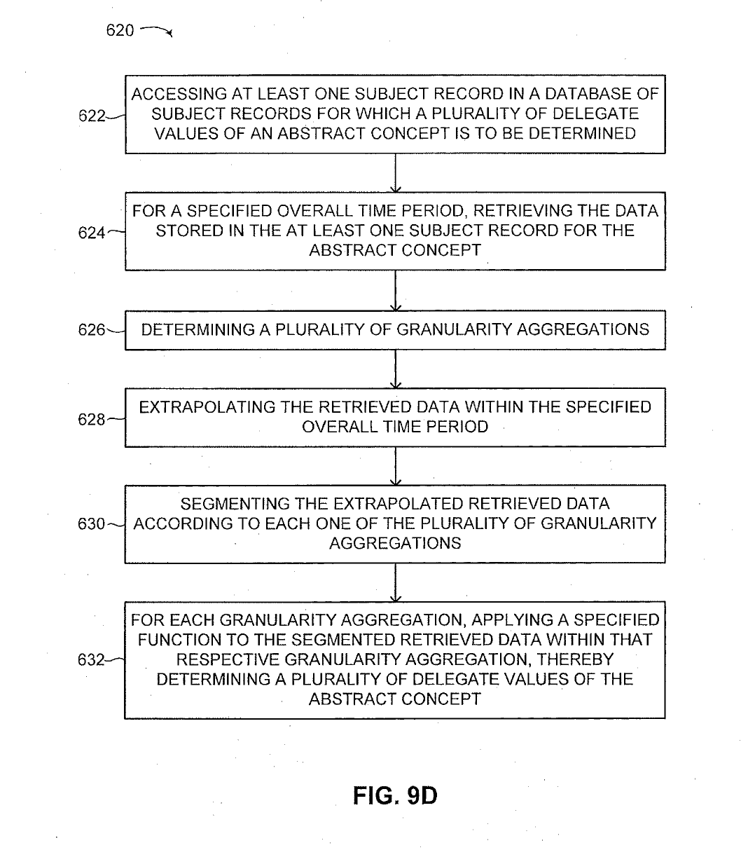

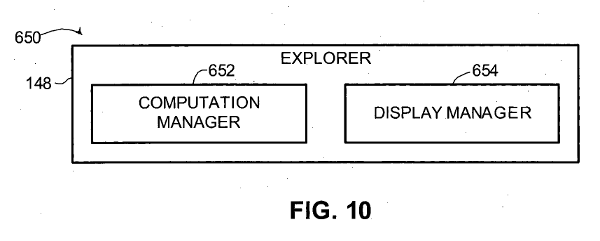

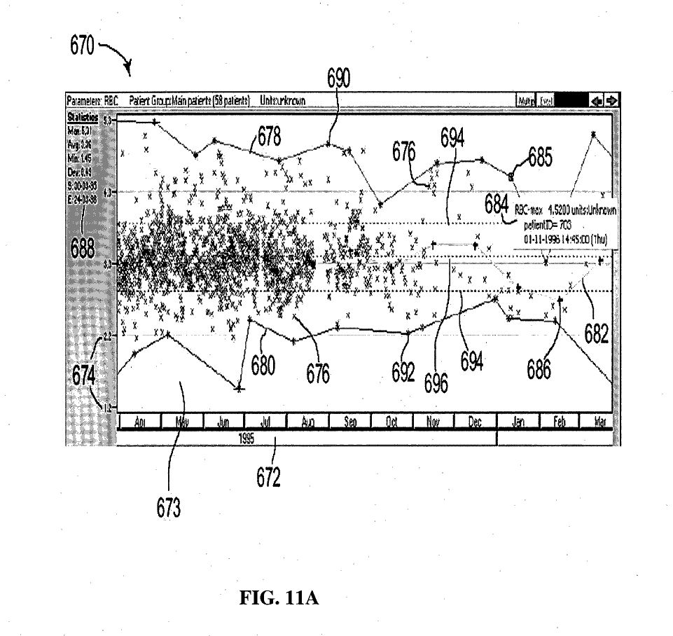

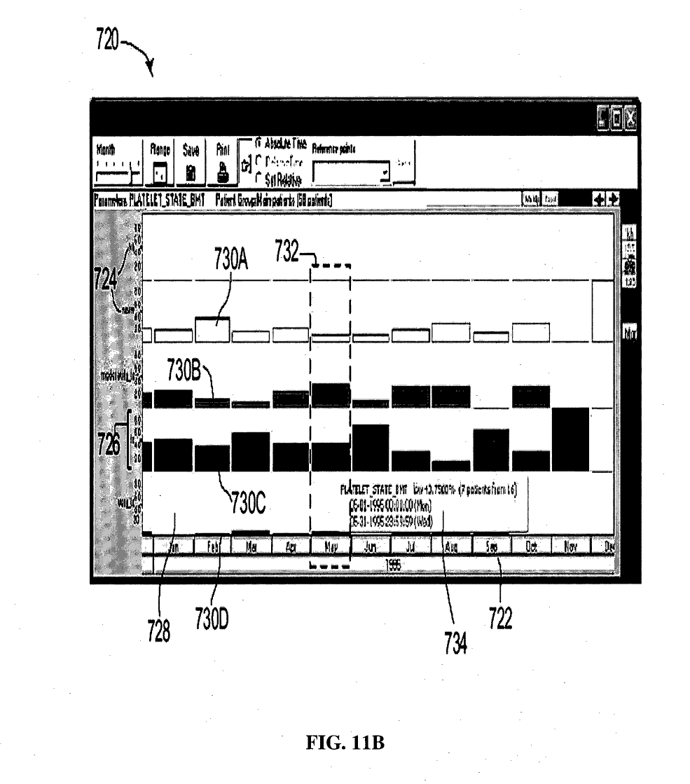

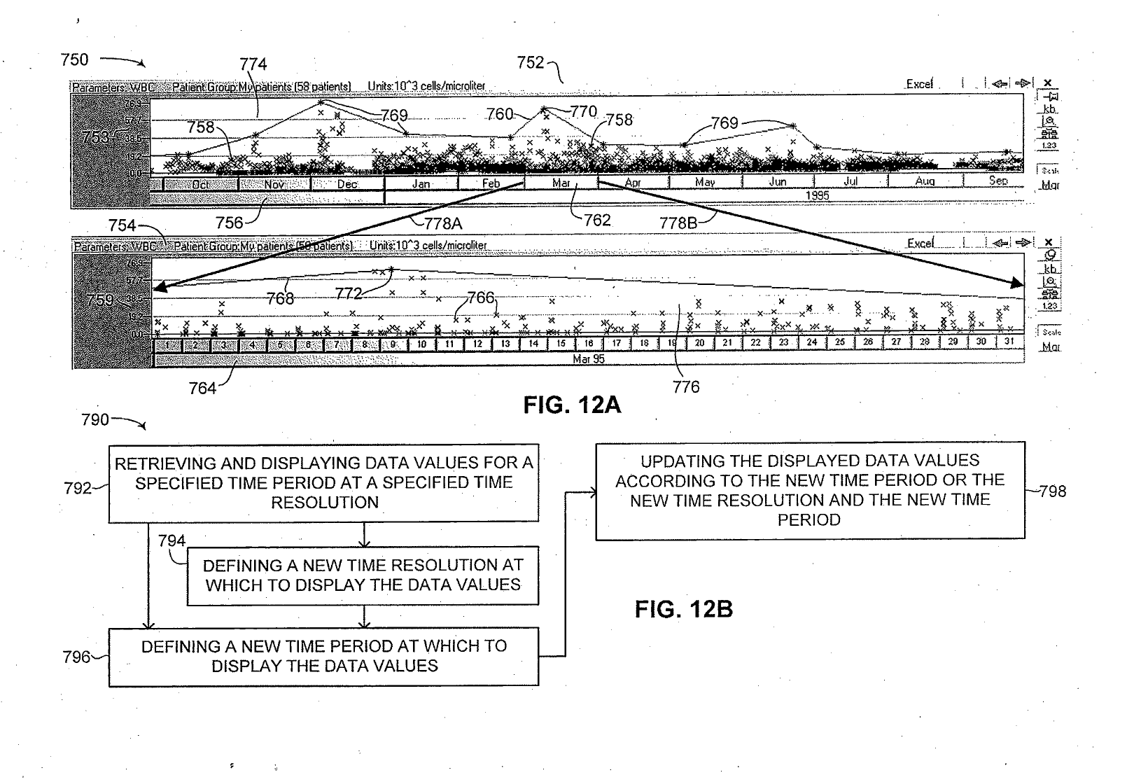

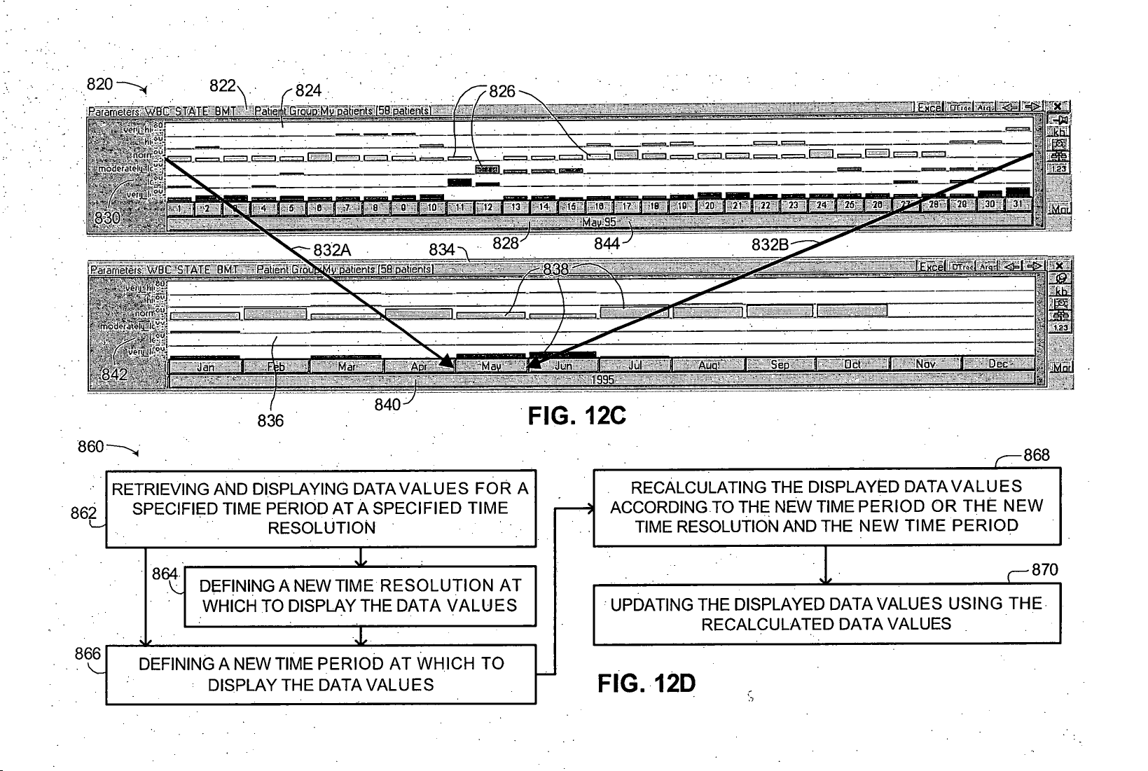

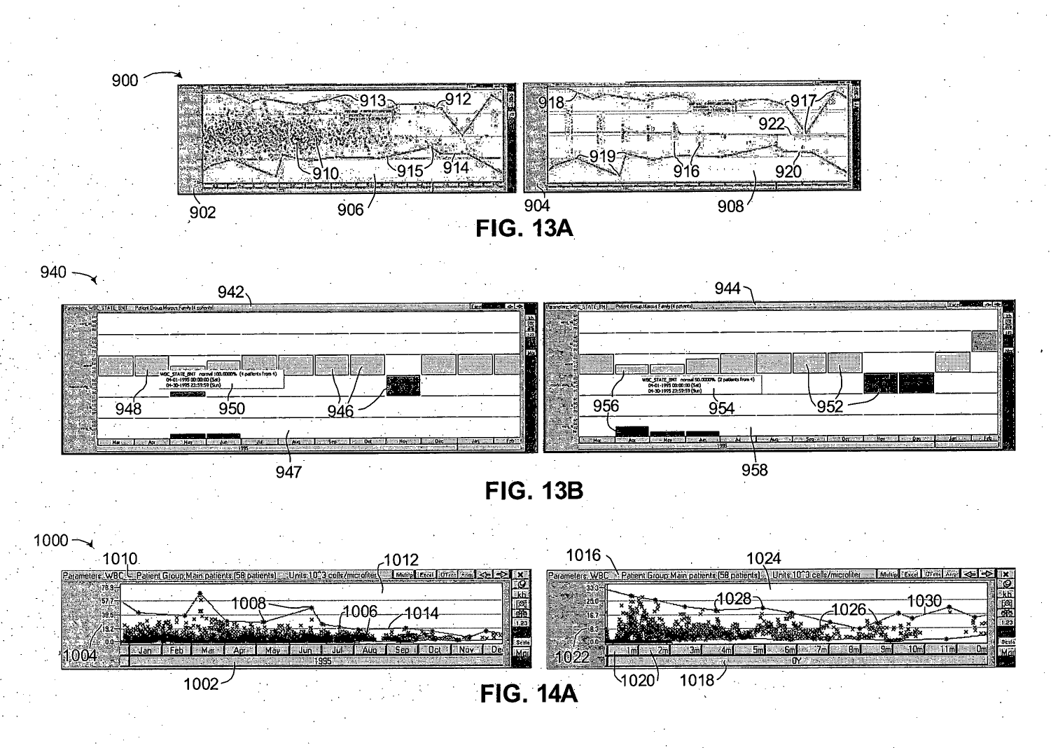

If the data retrieved is represented as a graph, then explorer 148 enables user 142 to change various aspects of the graph in order to visualize and explore the data represented. For example, the time scale used on the horizontal axis can be changed. Also, the scale used on the vertical axis can be changed. Using the above example, the time scale initially displayed was days, and the HGB value scale displayed was grams per deciliter of blood. According to the disclosed technique, user 142 can change the time scale to other predefined time scales, such as minutes, seconds, months and the like. Also, user 142 can change the vertical scale to another scale, such as a discrete scale if defined in domain knowledge base 156, which may be more indicative of new information regarding the data displayed. Changing the vertical scale in this respect substantially represents changing the concept used to display the data. Using the above example, domain knowledge base 156 may define a discrete scale for HGB value as a separate concept at a higher abstraction level, where instead of displaying the value of HGB as grams per deciliter of blood, the vertical scale may display whether the HGB value is very low, low, normal, high or very high, i.e., a discrete scale regarding the HGB value (i.e., a HGB-state concept). HGB value represents a raw concept whereas HGB-state represents an abstract concept that defines the HGB value on a scale of very low to very high. It is noted that if the time scales are changed, the data displayed may need to be recalculated by explorer. 148. It is also noted that various other exploration operators can be used to visualize and explore the data displayed and that such exploration operators can be used for displayed data which is either raw or abstracted. As described below in greater detail in FIGS. 12B, 12D and 13C, explorer 148, in addition to data provider 152, also determines delegate values for data displayed and may recalculate the delegate values used to display data if the user changes parameters in the display of the data.

Besides enabling user 142 to visualize, manipulate and explore the data shown in explorer 148, explorer 148 enables user 142 to determine whether patterns and temporal interrelations exist between different sets of data specified by constraint specifier 146, especially relations that extend over time (i.e., temporal interrelations). For example, using constraint specifier 146, different sets of data from a group of subject records may be retrieved. The different sets of data may be compared to determine if over time there is a correlation between the different data sets. According to the disclosed technique, various statistical values relating to the correlations can be displayed, such as the confidence level of a given correlation between two sets of data. As mentioned above, user 142 represents an individual attempting to determine temporal relations in time-oriented data in multiple subject records. In general, such a user using system 140 will first use constraint specifier 146 to generate a list of subject records, time intervals and data from the subject records and then use explorer 148 to explore the retrieved data in an attempt to determine if temporal relations exist in the data returned.

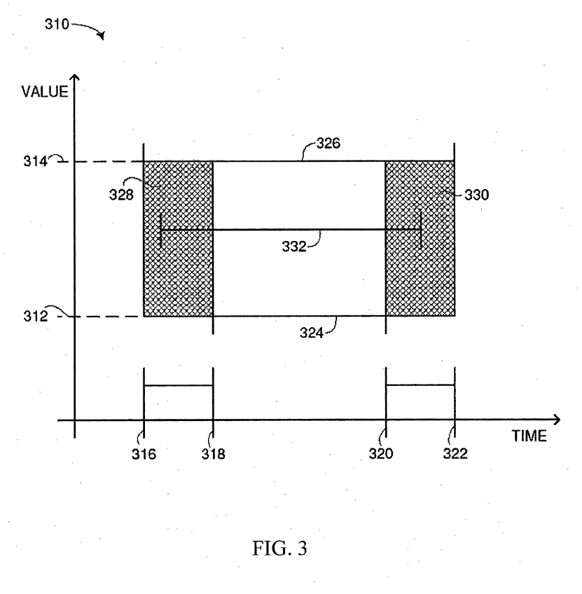

Reference is now made to FIG. 3, which is a schematic illustration of interval properties, generally referenced 310, constructed and operative in accordance with a further embodiment of the disclosed technique. As described below in greater detail, the specification language of the disclosed technique enables constraints to be defined which are time-oriented and which couple pairs of concepts defined in the KB over time. To support such constraints, interval properties can be defined regarding a particular concept, as shown in FIG. 3. It is noted that FIG. 3 relates to a single concept. In particular, interval properties 310 relates to local constraints 214 (FIGS. 4B, 4C and 4D) as described below, which substantially relate to a single concept. Interval properties 310 shows a graph which defines the relationship between a value and its duration. The horizontal axis of interval properties 310 represents time whereas the vertical axis represents value. Value represents the possible values for a particular concept defined in the KB which is time-oriented. A line 312 defines a minimum value for a concept whereas a line 314 defines a maximum value for a concept. In other words, interval properties 310 defines a possible range of values for a given concept. It is noted that a given concept may represent raw data or abstracted data. For example, for a concept such as HGB value, which represents raw data, the minimum may be defined as 4 grams per deciliter of blood, whereas the maximum may be defined as 21 grams per deciliter of blood. For a concept such as susceptibility to hacker attacks, which represents abstracted data, the minimum may be defined as ‘low,’ whereas the maximum may be defined as ‘high.’ A line 316 defines an earliest start point for the concept and a line 318 defines a latest start point for the concept. A line 320 defines an earliest end point for the concept and a line 322 defines a latest end point for the concept. In other words, the range from line 316 to line 318 defines the possible start points of the concept, whereas the range from line 320 to line 322 defines the possible end points of the concept. A range 324 defines the minimum possible duration of a concept, from line 318, i.e. the latest start point, to line 320, i.e., the earliest end point. A range 326 defines the maximum possible duration of a concept, from line 316, i.e. the earliest start point, to line 322, i.e., the latest end point. A box 328 defines the possible values and start times a concept can have whereas a box 330 defines the possible values and end times a concept can have. A line 332 defines one possible set of values and durations.

As an example in the domain of information security, lines 316 and 318 may represent the range of earliest times when an installed anti-virus software program started scanning a computer for viruses and lines 320 and 322 may represent the range of latest times when the anti-virus software program finished scanning the computer for viruses with the time axis representing the time from when the anti-virus software was installed on the computer. Based on a relative timeline of time from when the anti-virus software was installed on the computer, line 316 may represent 5 minutes (after anti-virus installation) and line 318 may represent 10 minutes (after anti-virus installation). Line 320 may represent 50 minutes and line 322 may represent 1 hour. The value axis may represent susceptibility to hacker attacks, with line 312 representing a moderate level susceptibility and line 314 representing a high level susceptibility. A natural language search expression using the representation of lines 312, 314, 316, 318, 320 and 322 may then be “Find all computers which have a moderate to high level of susceptibility to hacker attacks in which an anti-virus software program was installed on the computer and an anti-virus scan of the computer started between 5 and 10 minutes from the installation of the anti-virus software on the computer and finished scanning the computer between 50 minutes and 1 hour from the time the anti-virus software was installed on the computer.”

Reference is now made to FIGS. 4A-4E, which represent a schematic illustration of a specification language, generally referenced 190, constructed and operative in accordance with another embodiment of the disclosed technique. FIGS. 4A-4E represent the structure of the specification language used by constraint specifier 146 (FIG. 2) to enable a user to place constraints on the subject records searched. As explained below in greater detail, the specification language structure enables various types of constraints, including temporal and knowledge-based constraints, to be placed on subject records. As mentioned in FIG. 2, the specification language can be implemented in a GUI to enable a user to graphically select the desired constraints. It is recalled that constraints are selected by a user to define a subset of the subject records which the user wants to explore for the determination of associations and interrelations, especially ones that are temporal. As seen in FIGS. 4A-4E, the constraints specified in the specification language shown are general enough to define values of the constraints over a plurality of domains and fields. It is also noted that in general, the constraints specified in the specification language shown substantially relate to the concepts defined in a KB used with the disclosed technique. FIG. 4A includes an ontology-based temporal aggregation population specification language 192 (herein abbreviated OBTAL). OBTAL 192, as shown in FIGS. 4A-4E, includes a set of operators and constraints that enable a user to generate three types of expressions, a select subject record expression 194, a select subject record time interval expression 196 and a retrieve subject record expression 198. Select subject record expression 194 enables a user to specify constraints on subject records, which will return a set of subject records that satisfy the constraints specified. Select subject record time interval expression 196 enables a user to specify a time interval, which will return a set of time intervals in subject records that satisfy the time interval constraints specified. Once a set of subject records has been returned along with a set of time intervals, retrieve subject record expression 198 enables a user to specify what data stored in the returned subject records in the specified time intervals should be retrieved and presented to the user for further analysis and exploration, such as by explorer 148 (FIG. 2).

It is noted that OBTAL 192 is not a general expression language, but rather a structure for specifying a syntax that a user can use to specify either sets of subject records, time intervals or values stored in subject records. In FIG. 2, for constraint specifier 146 (FIG. 2) to operate, it is assumed that subject record database 154 (FIG. 2) includes a set of values which are time-stamped, and that domain knowledge base 156 (FIG. 2) defines concepts which are time-oriented. As shown below, OBTAL 192 enables constraints to be specified on raw data as well as abstracted data (i.e., raw data interpreted in a given context). The constraints defined by each of select subject record expression 194, select subject record time interval expression 196 and retrieve subject record expression 198 will now be defined and explained. As mentioned above, select subject record expression 194 enables a set of subject records to be retrieved from a database which satisfy a set of at least one constraint. The possible constraints which can be placed in a select subject record expression are shown in FIGS. 4A-4E, starting with FIG. 4B to which reference is now made. As FIGS. 4A-4E represent the structure of a specification language, the hierarchy of the possible constraints which can be specified can be written out formally. For the purposes of clarity, the formal representation of the hierarchy of the constraints will be shown in the text in the description of FIGS. 4A-4E. An expression defined by select subject record expression 194 can be expressed formally as

SelectSubjectRecordExpression (DB,KB,<SubjectRecordConstraint>)→<SubjectRecordID>* (1)

where SelectSubjectRecordExpression( ) defines a select subject record expression. The values in the brackets of Equation (1) represent what needs to be specified in a valid select subject record expression. In Equation (1), a database (abbreviated DB) of subject records, a knowledge base (abbreviated KB) of concepts in the domain of the subject records, as well as at least one subject record constraint need to be specified. Values in angular brackets, such as <SubjectRecordConstraint> represent sets of at least one, for example <SubjectRecordConstraint> is a set that includes at least one subject record constraint. The right side of the arrow → in Equation (1) represents what is returned from, or outputted by the expression, in this case a set of subject records characterized by their identification data (abbreviated ID). <SubjectRecordID>* represents the set of subject records that match the specified constraints in <SubjectRecordConstraint>. An asterisk * represents zero or more repetitions, i.e., no repetitions as well as the possibility of at least one repetition. For example, in Equation (1), the set <SubjectRecordID>* may have no repetitions as there may not be a subject record which satisfies the constraints specified in Equation (1). In Equation (1), the constraints which are specified are used to search the DB specified for subject records that satisfy the constraints specified. In other words, DB represents the queried database. The KB specified in Equation (1) includes the definitions and interpretation contexts of the constraints specified in <SubjectRecordConstraint>.

<SubjectRecordConstraint> in Equation (1) is represented as subject record constraints 200 in FIG. 3B. Subject record constraints 200 defines two basic types of constraints, static constraints 202 and temporal constraints 210. Formally, this can be represented as

<SubjectRecordConstraint>≡<StaticConstraints>operator<TemporalConstraints> (2)

where <StaticConstraints> represents a set of static constraints and <TemporalConstraints> represents a set of temporal constraints. The term ‘operator’ represents a Boolean relation operator and can be either the AND operator or the OR operator. The symbol V represents the English expression ‘is defined as.’ Subject Record Constraints 200 substantially represents a list of static constraints 202 and temporal constraints 210 coupled by the operators AND and/or OR. Static constraints 202 relate to properties of subject records which are constant or in which only the last current value is valid. In the field of clinical research, static constraints 202 for subject records could include age, sex, physician, ID number and the like. In the field of information security, static constraints 202 for subject records could include operating system, video memory size, presence of a DVD drive and the like. The constraints defined depend on concepts defined in the KB.

Static constraints 202 includes a set of local constraints 204. It is noted that local constraints 204 has an asterisk, meaning that no local constraints need to be specified in a select subject record expression. Formally, this can be represented as

<StaticConstraints>≡operator(<LocalConstraints>*) (3)

where operator represents a Boolean relation operator and can be either the AND operator or the OR operator. According to Equation (3), the static constraints specified can be coupled together as a set of local constraints separated by the AND operator or the OR operator. Local constraints 204 includes a concept name 206 and a min value, max value 208. Min value, max value 208 has an asterisk. Concept name 206 represents the concepts used in the KB to define respective constraints and min value, max value 208 represents a range of values for a given concept as a constraint. Formally, this can be represented as

<LocalConstraints>≡(<ConceptName>operator<MinValue,MaxValue>*) (4)

where <ConceptName> represents the name of a static constraint defined in the KB and <MinValue,MaxValue>* represents a list of boundaries that can be placed on the constraint specified. A constraint defined in Equation (4) is satisfied if the value for the constraint (i.e., the concept) stored in a subject record in the DB falls in the range defined by <MinValue,MaxValue> and according to the Boolean operator used. The semantics of a particular static constraint depend on the definition of that constraint (i.e., concept) defined in the KB. For example, in the domain of medical research, a select subject record expression 194 using static constraints 202 may be “Find all male patients, who are younger than 20 years of age or older than 70 years of age.” In such an expression, two static constraints are defined, sex and age, which are both in the set of <ConceptName>. Sex is defined by two possibilities, male and female; there is therefore no range of values specified. Age on the other hand, has a range specified, either from 0-20 years of age or above 70 years of age. As a formal expression, the subject record constraints could be specified as

<SubjectRecordConstraint>≡AND (Sex, ‘Male’)(Age, OR (0,20)(70,120)) (5)

where ‘Male’ represents the selected sex, 0,20 defines a range of 0 years to 20 years and 70,120 defines a range of 70 years to 120 years. Note that the OR operator is used to couple the age ranges such that the constraint is satisfied if the subject is either less than 20 years old or older than 70 years old and that the AND operator is used to coupled the sex constraint with the age constraint. In the case of the sex constraint, the constraint is defined by a nominal list, which includes only two entries ‘female’ and ‘male.’ In the case of the age constraint, an ordinal list is defined in which a range can be specified. It is noted that depending on how a concept is defined in the KB, the range for a concept can be defined by words and/or by numbers. For example, a particular concept may be defined on a range from ‘very low’ to ‘very high.’ It is also noted that even though the term ‘operator’ in Equations (2)-(4) was defined as either the AND operator or the OR operator, the term ‘operator’ in any of the Equations already presented and presented herein can refer to any Boolean relation operator, such as NOT, XOR, NOR and NAND and the like. According to one embodiment of the disclosed technique, only the Boolean relation operators AND and OR are used in expressions in OBTAL 192, to simplify the selection of constraints. Other embodiments using more Boolean relation operators are possible.

Temporal constraints 210 relate to properties of subject records which are time-oriented, such as when an antivirus software program was installed in a computer or when a patient underwent a chemotherapy procedure. As explained below, temporal constraints 210 can relate to raw data as well as to abstracted data. Temporal constraints 210 substantially enable a user to place time constraints on subject records, such as how long (i.e., duration) a particular constraint is valid, or a start and end period for a particular constraint. According to the disclosed technique, absolute as well as relative timelines are supported, based on how concepts are defined in the KB. An absolute timeline refers to a timeline that references the calendar, whereas a relative timeline refers to a timeline that references a particular event as a start time. The particular event may have significance according to the domain in which the disclosed technique is used, as the ontology and KB of the domain may define significant events in particular contexts. For example, defining a duration constraint on an absolute timeline might refer to defining a period from May 25, 2006 to Jun. 26, 2006. Defining a duration constraint on a relative timeline might refer to defining a period of time following a particular event, such as one week after the start of a fever, 3 days after the installation of an antivirus software program and the like. A significant event may be defined as the start point of a relative timeline. For example, in the medical domain, significant events may be the start of a type of therapy, the birth of a child and the start of a fever.

Temporal constraints 210 can be divided into two types of constraints, local constraints 214 and global pairwise constraints 212. Local constraints 214 refer to various types of temporal constraints that relate to a single concept, whereas global pairwise constraints 212 refer to temporal constraints which couple pairs of concepts defined in the KB over time. Formally, temporal constraints 210 can be represented as

<TemporalConstraints>≡(operator(<LocalConstraints>*))[<GlobalPairwiseConstraints>*] (6)

<LocalConstraints> refers to temporal constraints of a single concept, whereas <GlobalPairwiseConstraints> refers to temporal constraints between two concepts. As described above in FIG. 3, to support such temporal constraints, interval properties can be defined for a particular concept. Reference is now made to FIG. 4C, which shows what can be specified under local constraints 214. Local constraints 214 includes a concept name 216, a value constraints 218, a time point constraints 220, a duration constraints 222, a relative time constraints 224, a proportion constraints 226 and a statistical constraints 227. Under local constraints 214, it is noted that duration constraints 222, relative time constraints 224, proportion constraints 226 and statistical constraints 227 are optional constraints and are shown in FIG. 4C in square brackets. Local constraints 214 can be written out formally as

<LocalConstraints>*≡(<ConceptName>,<ValueConstraints>,<TimePointConstraints>, [<DurationConstraints>],[<RelativeTimeConstraints>],[<ProportionConstraints>], [<StatisticalConstraints>]) (7)

Concept name 216 refers to the name of the concept stored as data in the subject record as it appears in the KB. It is noted that concept name is specific for a particular type of data in the knowledge base of a domain, such that a similar measure of a particular concept may have a different concept name for raw data stored for the concept and for abstracted data stored for the concept. For example, in the medical research field, the knowledge base may define the concept ‘WBC count’ in a plurality of ways depending on the context of the concept. One may be named ‘raw WBC count’ to define the actual WBC count from a WBC count test (i.e., a raw concept). Another may be named ‘WBC-state’ to define whether a particular WBC count is considered normal or not (i.e., an abstracted concept). Yet others may be named for WBC counts after particular medical procedures. It is also noted that in the knowledge base, each concept is usually defined with an associated standardized measurement unit. ‘raw WBC count’ may be defined in units of cells/mL, whereas ‘WBC-state’ may be defined on an ordinal scale that include ‘very low, low, normal, high, very high.’ As shown below, concept name 216 determines which concept is to be referenced in the KB which affects the other constraints defined in local constraints 214 (FIGS. 4B-4D).

Value constraints 218 refers to constraints on values for a given concept and includes a min value, max value 228. Formally, this can be written out as

<ValueConstraints>≡(<Min Value,MaxValue>) (8)

Min value, max value 228 refers to the boundaries a value can have for a concept. As mentioned above, since each concept in the KB is stored with an associated measurement unit, therefore a minimum and maximum value for a concept can be defined in value constraints 218. Min value, max value 228 can represent values as defined in raw data or in abstracted data. For example, in the case of WBC count, min value, max value 228 can represent 0 cells/mL to 3000 cells/mL, since WBC count is a raw concept for which raw data is stored. In the case of WBC-state, min value, max value 228 can represent ‘very low’ to ‘very high,’ since WBC-state is an abstraction for which abstracted data is stored. For each concept, the KB may also specify default minimum and maximum values for the concept. Time point constraints 220 includes a start point or earliest start point, latest start point 230 and an end point or earliest end point, latest end point 232. Formally, this can be written out as

<TimePointConstraints>≡(<StartPoint/<EarliestStartPoint,LatestStartPoint>>, <EndPoint/<EarliestEndPoint,LatestEndPoint>>) (9)

The start point and the end point in Equation (9) refer to a time period in which the value defined in value constraints 218 holds. This was described earlier in FIG. 3 as interval properties. The symbol ‘|’ refers to the OR Boolean operator. For example, a select subject record expression 194 in the information security domain using time point constraints 220 may be “Find computer stations that have been operating at a CPU usage of more than 50% from Nov. 4, 2008 to Nov. 10, 2008.” In other words, Nov. 4, 2008 defines a start point, Nov. 10, 2008 defines an end point, and only computer stations which have a recorded value of 50% CPU usage or more for that entire time period will satisfy the constraint specified. It is noted that time point constraints 220 refers to time points that are defined on an absolute timeline. As shown below, relative time constraints 224 can be used to specify constraints on a relative timeline. In addition, using interval properties as defined in FIG. 3, a range for a start time point and/or a range for an end time point can be defined in start point or earliest start point, latest start point 230 and end point or earliest end point, latest end point 232. For example, a select subject record expression 194 in the medical research domain using time point constraints 220 may be “Find patients who had a very low WBC-state starting from anywhere between May 4, 2003 and May 6, 2003 until anywhere between May 14, 2003 and May 20, 2003.” In this example, a range for the start point of the value ‘very low’ for the concept WBC-state is defined as May 4, 2003 to May 6, 2003 and a range for the end point of the value ‘very low’ for the concept WBC-state is defined as May 14, 2003 to May 20, 2003. In one embodiment of the disclosed technique, start point or earliest start point, latest start point 230 and end point or earliest end point, latest end point 232 have default values defined the KB, such as Jan. 1, 1900 as a start point, and the current time, including the seconds, as an end point. Default start point ranges and end point ranges may also be defined in the KB.

Duration constraints 222 includes a min duration, max duration 234. Formally, this can be written out as

[<DurationConstraints>]≡(<MinDuration,MaxDuration>) (10)

Duration constraints 222 refers to constraints on the duration of an interval for which a value specified in value constraints 218 is satisfied for the interval specified in min duration, max duration 234. For example, a select subject record expression 194 in the medical research domain using duration constraints 222 may be “Find patients who have had a very high value in their WBC-state for at least four days but not more than seven days.” In this example, four days represents the minimum duration for which the specified value ‘very high’ must be satisfied whereas seven days represents the maximum duration for which the specified value must be satisfied.

Relative time constraints 224 includes a reference concept name 238, a relative start point or relative earliest start point, relative latest start point 240, a relative end point or relative earliest end point, relative latest end point 242 and a reference position number, reference boundary point 244. Relative time constraints 224 refers to time points constraints on values in subject records in which a relative timeline is used. A KB may define significant relative time points for a given concept, such as the start of a high fever, the installation of a firewall program, the upgrade of a computer or the start of a chemotherapy treatment. Relative time constraints 224 enables a user to specify time constraints based on these significant relative time points, in which the significant relative time point specified is used as the reference or start time in a select subject record expression. Formally, relative time constraints 224 can be written out as

[<RelativeTimeConstraints>]≡(<ReferenceConceptName>, <RelativeStartPoint/<RelativeEarliestStartPoint,RelativeLatestStartPoint>>, <RelativeEndPoint/<RelativeEarliestEndPoint, RelativeLatestEndPoint>>, <ReferencePositionNumber,ReferenceBoundaryPoint>) (11)

Reference concept name 238 refers to the significant relative time point for the concept defined in concept name 216 as defined in the KB. Reference concept name 238 substantially provides the context in which the relative time constraints are specified. For example, reference concept name 238 may refer to the time a PC is upgraded or the time bone marrow was transplanted in a patient. Relative start point or relative earliest start point, relative latest start point 240 and relative end point or relative earliest end point, relative latest end point 242 refer to boundary points of a specified interval for which the value specified in value constraints 218 is to be satisfied. Unlike start point or earliest start point, latest start point 230 and end point or earliest end point, latest end point 232, relative start point or relative earliest start point, relative latest start point 240 and relative end point or relative earliest end point, relative latest end point 242 refer to relative time periods starting from the significant time point referred to in reference concept name 238. Reference position number, reference boundary point 244 refers to two separate additional reference positions regarding reference concept name 238. The parameter ReferencePositionNumber in Equation (11) refers to the ordinal position (e.g., first, second, third) of the significant time point event specified in reference concept name 238 if more than one instance of the event exists and is stored in the subject record. For example, in the medical research field, if a patient underwent the same chemotherapy treatment three times, then the parameter ReferencePositionNumber enables a user to specify which of the three times should be used as the starting time for specifying an interval. The default ReferencePositionNumber may be the last instance of the event. The parameter ReferenceBoundaryPoint in Equation (11) refers to the boundary point of the significant time point event to be used as the starting time for specifying an interval. The reference boundary point can either be the start or the end of the significant event. For example, for a reference concept name such as ‘heart surgery,’ the reference boundary point may either be specified as either the start of the heart surgery or the end of the heart surgery. The default ReferenceBoundaryPoint may be the end of the significant time point event. An example of a select subject record expression 194 in the clinical research domain using relative time constraints 224 may be, “Find patients with a very low level hemoglobin level during the first ten days after a bone marrow transplant (herein abbreviated BMT).” In this example, the reference concept name is BMT, meaning the interval specified as ten days is to start from after a BMT. In this example, only a relative start time and a relative end time were specified (i.e., from zero to ten days after a BMT), and by default, the reference boundary point used was the end of the reference concept name, i.e., starting from the end of a BMT.

Proportion constraints 226 includes min threshold, max threshold 236. Formally, this can be written out as

[<ProportionConstraints>]≡(<MinThreshold,MaxThreshold>) (12)

Min threshold, max threshold 236 refers to a percentage, ranging from 0% to 100%, for which a value defined in value constraints 218 is satisfied in a given time period. The given time period can either be specified under time points constraints 220, duration constraints 222 or relative time constraints 224. In the case of a value for which raw data is stored, min threshold, max threshold 236 refers to the relative portion of the values in the subject record for which the specified value constraints and time point constraints are satisfied. For example, “Find patients for which the WBC count was at least 3000 cells/mL in 50% of the WBC count tests done for the patient in March 2008.” In this example, 50% represents the minimum threshold, whereas the maximum threshold is at the default of 100%. In the case of a value for which abstracted data is stored, min threshold, max threshold 236 refers to the relative portion of the duration of the time interval specified for which the value constraints are satisfied. For example, “Find patients for which the WBC-state was high for at least 75% of the first month after BMT.”

Statistical constraints 227 refers to constraints which enable a user to specify and filter data on subject records using statistical operators and functions. The parameters for specifying statistical constraints are shown in FIG. 4D, to which reference is now made. Statistical constraints 227 can be subdivided into two different types of constraints, those that relate to the values stored in a single subject record or those that relate to the values stored in a population of subject records. Accordingly, statistical constraints 227 includes individual statistical constraints or population statistical constraints 266. Formally, this can be written out as

<StatisticalConstraints>≡<IndividualStatisticalConstraints>/<PopulationStatisticalConstraints> (13)

Individual statistical constraints refers to statistical constraints placed on the data stored in a single subject record. As such, individual statistical constraints or population statistical constraints 266 includes a subject record delegate function 268 and a value constraints 270 for specifying statistical constraints on a single subject record. This can be written out formally as

<IndividualStatisticalConstraints>=(<SubjectRecordDelegateFunction>,<ValueConstraints>) (14)

Value constraints 270 refers to a range of values in a subject record on which the user wants to specify a statistical constraint. Subject record delegate function 268 refers to the statistical function (i.e., the delegate function) to be used to aggregate the range of values of the subject record specified in value constraints 270. It is noted that time period for which the range of values is to be aggregated in Equation (14) is specified either under time point constraints 220, duration constraints 222 or relative time constraints 224 (all in FIG. 4C). In other words, the data of the subject record aggregated according to subject record delegate function 268 is specified to fall within the range defined by value constraints 270. For example, a select subject record expression 194 in the medical research domain using individual statistical constraints may be, “Find patients who have a mean blood glucose level greater than or equal to 130 g/dL.” In this example, subject record delegate function 268 is the mean, as the mean is a statistical function, and greater than or equal to 130 g/dL refers to value constraints 270, which specifies a range for which the user wants to specify a statistical constraint. The blood glucose level represents concept name 216, which was defined as a local constraints 214.

Individual statistical constraints or population statistical constraints 266 also includes a subject record delegate function 272, a population delegate function 274, a relation 276 and a min difference, max difference 278 for specifying statistical constraints that relate to subject records as compared to an entire population of subject records. This can be written out formally as

<PopulationStatisticalConstraints>≡(<SubjectRecordDelegateFunction>,<PopulationDelegateFunction>,<Relation>, [<MinDifference,MaxDifference>]) (15)

Subject record delegate function 272 refers to the statistical function used to aggregate the data specified in concept name 216 as a single value, whereas population delegate function 274 refers to the statistical function used to aggregate the data specified in concept name 216 for an entire population as a single value. It is noted that in Equation (15), the time period for which the data specified in concept name 216 is to be aggregated is specified under local constraints 214 under either time point constraints 220, duration constraints 222 or relative time constraints 224 (all in FIG. 4C). By default, the population is considered to be all the subject records in the DB which have data stored for the concept name specified. Relation 276 refers to the qualitative relation between the aggregated values determined by subject record delegate function 272 and population delegate value 274, and can include relations such as greater than, less than, equal to and the like. Min difference, max difference 278 represents an optional parameter for specifying a quantitative minimum difference and maximum difference between the aggregated values determined by subject record delegate function 272 and population delegate value 274. In one embodiment of the disclosed technique, subject record delegate function 272 is by default the exist function, which means that at least one instance of the data in a subject record satisfies the constraints specified, and population delegate value 274 is by default the mean. For example, a select subject record expression 194 in the medical research domain using population statistical constraints may be, “Find patients whose mean blood glucose levels are greater than 5 g/dL than the population's mean blood glucose level.” In this example, both subject record delegate function 272 and population delegate function 274 are the mean, relation 276 is represented as greater than and min difference, max difference 278 defines a minimum difference of 5 g/dL. It is noted that blood glucose level was specified in concept name 216 and that each concept is associated with a standardized measurement unit as specified in the KB. In this example, this unit is g/dL (grams per deciliter).

Reference is now made back to FIG. 4B. Global pairwise constraints 212 has an asterisk and is also surrounded by square brackets. The square brackets represent an optional type of constraint, i.e., in a given select subject record expression 194 (FIG. 4A), global pairwise constraints 212 does not need to be defined. The asterisk represents the possibility of no repetitions. As described above, <GlobalPairwiseConstraints> refers to temporal constraints between two concepts. In order to generate a select subject record expression 194 (FIG. 4A) using global pairwise constraints 212, at least two local constraints 214 need to be defined on two separate concepts such that a comparison between them can be made. As explained above, temporal constraints 210 and in particular local constraints 214 refer to constraints that define time periods to be searched for in a subject record. Once at least two different time periods, or intervals, have been defined, using global pairwise constraints 212, the intervals can then be compared to determine if there is any overlap.

Global pairwise constraints 212 is divided into two different types of constraints, pairwise value constraints 246 and pairwise temporal constraints 248. Formally, this can be written out as

<GlobalPairwiseConstraints>≡(<PairwiseValueConstraints>,<PairwiseTemporalConstraints>) (16)

As explained above in FIG. 2, values for a particular concept in a subject record (i.e., multiple records of a particular concept for a particular subject), as defined in the KB, may be aggregated together to form a representative value for that concept (i.e., record) over a particular time period. Such a value can be referred to as a delegate value. It is noted that the particular time period over which a delegate value is determined is not limited to the time scale at which the values for the particular concept are stored at, but can be any time period as specified by a user. For example, one of the records stored in a subject record in the information security domain may be the number of attempted hacker attacks in a 12-hour period. A DB of subject records may contain a value representing the number of attempted hacker attacks in a 12-hour period, for each 12-hour period over the course of a month, i.e., multiple records for a single concept of a single subject record. A user may want to explore the number of attempted hacker attacks over the course of a two week period, with one value representing the number of attempted hacker attacks for a two week period; such a value would be the delegate value of the number of attempted hacker attacks for every two weeks. As described below, many functions can be used to determine the delegate value. Pairwise value constraints 246 refers to constraints wherein the delegate values for two different time periods in a subject record are compared. Such constraints can be used if the data stored in the subject record for the two time periods refers to the same concept. For example, in the medical research domain, such a constraint may refer to the following natural language select subject record expression, “Find patients for whom the WBC count 1 week after a BMT was greater than the WBC count 3 weeks after the BMT.” In such an expression, one concept, WBC count is being compared between two different time periods; it is noted that the WBC count is stored as raw data. It is also noted that time periods stated above, i.e. 1 week and 3 weeks, were specified for each concept (WBC count in the context of different time periods after a BMT) under local constraints 214, since each concept had to have been specified first as a local constraints 214 before global pairwise constraints 212 could be specified for the two concepts. Alternatively such constraints can be used if the data stored in the subject record for the two time periods refers to different concepts yet the concepts are measured on similar scales. For example, in the medical research domain, such a constraint may refer to the following natural language select subject record expression, “Find patients for whom the value of the WBC-state during the first week following a BMT was lower than the value of the Platelet-state during the second week after the BMT.” In this example, the WBC-state is being compared with the Platelet-state, both of which are stored as abstract data, over two time periods, and defined in the KB. Also, both concepts have a common context which is the time period following a BMT. Even though the two concepts are not the same, to be compared (i.e., to use pairwise value constraints 246) the two concepts are required to be defined on a similar scale such that the values of one concept can be compared to the values of the other concept.

Pairwise value constraints 246 includes a concept name_{I} 250, a concept name_{J} 252, a relation 254 and a delegate function 256. To define an expression using pairwise value constraints 246, two concepts, concept name_{I} 250 and concept name_{J} 252, must have been already specified under local constraints 214. Concept name_{I} 250 and concept name_{J} 252 each represent the name of a concept such that it can be referenced in the KB if necessary, as well as the respective value for each concept which is to be compared. Relation 254 represents the qualitative relation between the two value to be compared, such as greater than, less than, equal to and the like. Delegate function 256 represents the function used to determine the delegate value for each of the concepts defined in concept name_{I} 250 and concept name_{J} 252. As mentioned above, the time period over which the delegate value is determined was already specified for each concept under local constraints 214. Formally, this can be written out as

<PairwiseValueConstraints>≡(<ConceptName_{I}>,<ConceptName_{J}>,<Relation>,<DelegateFunction>) (17)

In one embodiment of the disclosed technique, before Equation (17) is used to generate a select subject record expression 194, a Pair Exist function is used to determine if at least one pair of values in each of the specified concepts exists that satisfies the relation defined in Equation (17).

Pairwise temporal constraints 248 refers to constraints in which boundary time points for a particular concept can be defined. Pairwise temporal constraints 248 includes a concept name_{I} and boundary time point_{I} 258, a concept name_{J} and boundary time point_{J} 264, a relation 260 and a min difference, max difference 262. Formally, pairwise temporal constraints 248 can be written out as

<PairwiseTemporalConstraints>^{1,2,3,4}≡(<ConceptName_{I},BoundaryTimePoint_{I}>,<ConceptName_{J},BoundaryTimePoint_{J}>,<Relation>,[<MinDifference,MaxDifference>]) (18)

Similar to pairwise value constraints 246, pairwise temporal constraints 248 enables either two values for a similar concept to be compared or two values for two concepts to be compared provided that the scale of the values being compared are similar. In addition, temporal constraints 248 enables boundary time points for each concept to be defined. As shown above in FIG. 3, using defined interval properties, a concept may be defined in the KB as having a range of starting points as well as a range of ending points. Therefore, a quantitative comparison between values in a concept can be enabled using pairwise temporal constraints 248 by defining a starting point as well as an ending point for each concept. It is noted that besides defining interval properties for pairwise temporal constraints 248, since intervals are compared using this constraint, interval relations may need to be defined as well, such as Allen's Interval Algebra. As shown in FIG. 3, a line 332 (FIG. 3) represents a possible set of durations for a concept. The duration for a given concept can also be referred to as a temporal gap. In this respect, pairwise temporal constraints 248 enables a quantitative comparison of temporal gaps between values in two different concepts. In a pairwise temporal constraint expression, since each concept compared has a start time and an end time defined in the KB, up to four possible comparisons can be made between the two concepts: start time of concept_{I} to start time of concept_{J}, start time of concept_{I} to end time of concept_{J}, end time to concept_{I} to start time of concept_{J} and end time of concept_{I} to end time of concept_{J}. As such, pairwise temporal constraints 248 is represented in FIG. 4B as having superscripts 1, 2, 3 and 4 to show that up to four different sets of pairwise temporal constraints 248 can be defined for a given set of concepts. In Equation (18), BoundaryTimePoint_{I} represents the boundary time point chosen for ConceptName_{I}, which can either be its start time or end time and likewise for BoundaryTimePoint_{J}. The <Relation> parameter in Equation (18) refers to the qualitative relation (e.g., less than, greater than, equal to and the like) between the boundary time points specified. <MinDifference,MaxDifference> refers to an optional (as shown by the square brackets in Equation (18)) parameter that quantitatively defines the minimum temporal gap and maximum temporal gap between the boundary time points defined. For example, in the information security domain, such a constraint may refer to the following natural language select subject record expression, “Find computer stations for which no user activity was registered during a time period of at least 5 seconds where the CPU-state had a value of ‘very-high’ and the TCP connection-state had a value of at least ‘high.’ The overlap of the concepts mentioned above represents a port-scanning malware concept. In this example, two concept names are specified, CPU-state and TCP connection-state, both of which represent abstract concepts for which abstracted data is stored. The boundary time points for the specified concepts may be the start or the end of the period when the value stored for each concept was the value specified above in the select subject record expression. For example, one pairwise temporal constraint may be between the start of the very-high value for the CPU-state and the start of the high value for the TCP connection-state. A second pairwise temporal constraint may be between the end of the very-high value for the CPU-state and the start of the high value for the TCP connection-state. A third pairwise temporal constraint may be between the end of the very-high value for the CPU-state and the end of the high value for the TCP connection-state. For the three pairwise temporal constraints specified, relation 260 specified may be greater than, greater than and less than, respectively. The second pairwise temporal constraint may specify a minimum difference of 5 seconds. Accordingly, a subject record satisfying the constraints specified will be a computer station for which the CPU-state had a value of ‘very-high’ for at least 5 seconds, the TCP connection-state had a value of ‘high’ for at least 5 seconds, and the two concepts overlapped in time for at least 5 seconds.

The constraints defined by select subject record time interval expression 196 will now be defined and explained. As mentioned above, select subject record time interval expression 196 enables a user to specify a time interval, which will return a set of time intervals in subject records that satisfy the time interval constraints specified. The possible constraints which can be placed in a select subject record time interval expression are shown in FIG. 4E to which reference is now made. Select subject record time interval expression 196 (FIG. 4A) includes an interval constraints 280, which includes granularity 282, time constraints or relative time constraints 284 and local constraints 286. Local constraints 286 includes a concept name 288, a value constraints 290, a delegate function 292 and a proportion population minimum threshold, proportion population maximum threshold 294. Using select subject record time interval expression 196 enables a user to determine when a portion of the subject records in the DB being searched had a specific value for raw data or abstracted data stored in respective subject records for a predefined time interval. As an example of a select subject record time interval expression 196 in the field of information security, such an expression can be used to determine which days, following the Nimda worm propagation on the internet, during which 30% on the computers listed as subject records in a specified DB were down. An expression defined by select subject record time interval expression 196 can be expressed formally as

SelectSubjectRecordIntervalExpression (DB,KB,<IntervalConstraints>,<SubjectRecords>)→<StartTime,EndTime>* (19)

where DB is the database being searched and KB is the knowledge base to be accessed which includes definitions and contexts for the constraints specified in <IntervalConstraints>. <IntervalConstraints> represents a set of at least one constraint which relates to a time interval. These constraints are not applied to all subject records in the DB but rather to the subject records specified in <SubjectRecords>, which represents a list of subject records to which the constraints specified in <IntervalConstraints> are applied to. It is noted that in general, a user will first specify constraints in a select subject record expression 194 which will return a list of subject records that meet the specified constraints. Then, based on the returned subject records, a select subject record time interval expression 196 can be used to find time intervals of interest in the returned subject records. Based on Equation (19), what is returned from a select subject record time interval expression 196 is a list of time intervals which are specified by a start time and an end time. <StartTime,EndTime> is asterisked indicating that the constraints specified may yield no repetitions, i.e., no time interval exists in the subject records specified which satisfies the constraints specified.

<IntervalConstraints> can be defined formally as <IntervalConstraints>≡<Granularity>, [<TimeConstraints>/<RelativeTimeConstraints>], (operator<LocalConstraints>*) (20)

where <Granularity> refers to the time scale, or smallest time unit, of the interval to be searched for. In general, any number of time scales can be defined in the KB. For example, one set of time scales may include seconds, minutes, hours, days, months and years. In such an example, the lowest granularity level or time resolution level to be searched for in subject records is seconds, whereas the highest granularity level or time resolution level to be searched for in subject records is years. <TimeConstraints> and <RelativeTimeConstraints>, which are separated by the symbol ‘|’ representing the Boolean operator OR, represent optional time constraints that limit the time range to be searched in the subject records listed in <SubjectRecords>: <TimeConstraints> represent time constraints specified on an absolute timeline whereas <RelativeTimeConstraints> represent time constraints specified on a relative timeline. Operator represents the Boolean operators AND or OR and specifies the relationship between the constraints specified under local constraints 286.

<LocalConstraints> can be defined formally as <LocalConstraints>≡<ConceptName>,<ValueConstraints>,<DelegateFunction>, <ProporationPopulationMinThreshold, ProportionPopulationMaxThreshold> (21)

where concept name 288 represents the name of a constraint as specified in the KB. Concept name 288 can represent any of the constraints specified in a select subject record expression 194 under temporal constraints 210 (FIG. 4B). Concept name 288 is substantially equivalent to concept name 216 (FIG. 4C). Value constraints 290 represents constraints on the values stored in a subject record as specified by concept name 288. Delegate function 292 represents the function be to used to aggregate the data in a subject record to determine a value for a particular concept name according to the time unit specified by granularity 282. Proportion population minimum threshold, proportion population maximum threshold 294 represent the minimum and maximum portion of the subject records which have a value, calculated by delegate function 292, in the value range defined by value constraints 290. For example, a select subject record time interval expression 196 in the medical research domain may be, “Find months following chemotherapy treatment during which the WBC-state was less than or equal to low and the platelet count was between 1000 to 5000 cells/mL, for at least 25%, but no more than 50% of patients.” In this expression, an interval of time is requested by the user, i.e., find months in which the following constraints hold for subject records, here patients, in a medical database. The granularity 282 here is defined as months, and a relative time constraint is defined, i.e., after chemotherapy treatment is considered the start point of where the relative time constraint begins. In this example, two local constraints, WBC-state and platelet count, are defined and are coupled with the AND operator. The WBC-state has ‘WBC-state’ as the concept name 280, a value constraint 290 of ‘less than low’ (i.e., from very low to low) and a delegate function 292 of ‘longest time’ (i.e., aggregate a subject record's WBC-state per month to determine in which months was the WBC-state per day less than or equal to low for most days of the month). Platelet count has ‘platelet count’ as the concept name 280, a value constraint 290 of ‘between 1000 and 5000 cells/mL’ and a delegate function 292 of ‘mean’ (i.e., the average platelet count per month). Both local constraints have a proportion population minimum threshold, proportion population maximum threshold 294 of minimum 25%, maximum 50%. The results of such an expression will be a list of the month or months in which the raw data (i.e., platelet count) and the abstracted data (i.e., WBC-state) as specified by the select subject record time interval expression 196 satisfy the constraints specified in the expression.

The constraints defined by retrieve subject record expression 198 will now be defined and explained. As mentioned above, retrieve subject record expression 198 enables a user to specify what data stored in the returned subject records in the specified time intervals should be retrieved and presented to the user for further analysis and exploration. The possible constraints which can be placed in a retrieve subject record expression are shown in FIG. 4A to which reference is now made. Retrieve subject record expression 198 includes a temporal intervals 296. Given a concept and a list of subject records (as specified in select subject record expression 194) and optionally a list of time intervals (as specified in select subject record time interval expression 196), retrieve subject record expression 198 enables the at least one value stored for the concept, optionally within the selected time intervals, to be retrieved for the specified subject records. An expression defined by retrieve subject record expression 198 can be expressed formally as

RetrieveSubjectRecordExpression (DB,KB,<Concept>,<SubjectRecords>,[<TemporalIntervals>])→<SubjectRecordₙ,Concept,StartTime_{n,m},EndTime_{n,m},Value_{n,m}>*1≦n≦N, 1≦m≦Mₙ (22)

where DB represents the database searched, KB represents the knowledge base where definitions and contexts of concepts are stored, <Concept> represents the data of the concept to be retrieved, <SubjectRecords> represents a list of subject records, for example according to an ID number, for which the concept defined in <Concept> should be retrieved and <TemporalIntervals> represents an optional constraint that limits the time interval of the data to be retrieved. What is returned in Equation (22) is a list of subject records from 1 to N, where N represents the total number of subject records specified in <SubjectRecords>, and Mₙ represents the total number of different data entries stored for subject record n. For a specified concept and subject recordₙ, the value_{n,m} for concept m of subject recordₙ is returned along with the interval, i.e., the time period, in which the value occurs. In one embodiment of the disclosed technique, the default list used for <SubjectRecords> is the entire database specified under DB and temporal intervals 296 are not specified, i.e., values for the entire timeline stored in the DB are retrieved. It is noted that a retrieve subject record expression 198 is in general not an expression that is constructed from scratch. Rather, first subject records are selected using a select subject record expression 194, and optionally a select subject record time interval expression 196 is then used to select specific time intervals. Once these selections have been made, then a retrieve subject record expression 198 can be specified. It is noted that a retrieved subject record expression 198 can be constructed from scratch by explicitly listing in <SubjectRecords> which subject records are to be retrieved.

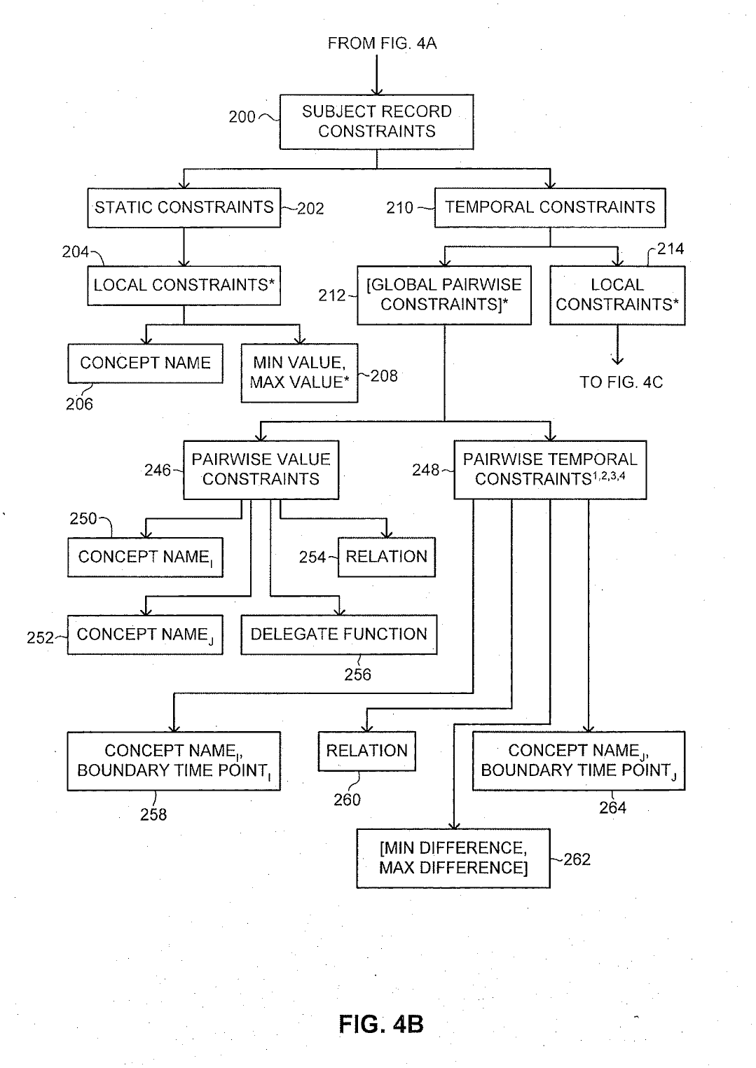

Reference is now made to FIG. 5, which is an illustration showing examples of constraints specified in natural language and in an ontology-based temporal aggregation population specification language (abbreviated as above as OBTAL), constructed and operative in accordance with a further embodiment of the disclosed technique. As mentioned above, the disclosed technique enables a user to retrieve, visualize and explore temporal relations in time-oriented data in multiple subject records. In order to retrieve time-oriented data in multiple subject records, a user must specify what they are looking for. As shown in FIG. 4A-4E, a specification language is defined according to the disclosed technique which enables a user to specify subject records to be retrieved, time intervals in subject records to be retrieved, and/or data in subject records to be retrieved. FIG. 5 includes three expressions, a select subject record expression 350, a select subject record time interval expression 352 and a retrieve subject record expression 354 to illustrate how the specification language can be used to specify constraints in a database of a domain to be explored by a user. These expressions represent search constraints on subject records in the domain of medical and clinical research and are brought as examples. In each expression, the expression is shown in a natural language format and in an XML format based on an OBTAL constructed according to the disclosed technique. The natural language format and the XML format for each expression are equivalent in terms of the constraints specified. The XML format substantially shows how the constraints specified in a natural language format can be categorized according to an OBTAL. The particular tags used in the XML format for each expression are a design choice of the worker skilled in the art.

Select subject record expression 350 includes a natural language select subject record expression 356 and an XML select subject record expression 358. Select subject record time interval expression 352 includes a natural language select subject record time interval expression 360 and an XML select subject record time interval expression 362. Retrieve subject record expression 354 includes a natural language retrieve subject record expression 364 and an XML retrieve subject record expression 366. Natural language select subject record expression 356 specifies static constraints such as age and gender as well as temporal constraints such as WBC count and hemoglobin-state. It is noted that age and gender are specified as constraints on raw data whereas both the WBC count and the hemoglobin-state are specified as constraints on abstracted data. In addition, a relative timeline is specified in the expression as the first month following an allogenic bone marrow transplant (herein abbreviated BMT_Al). The result to be returned from select subject record expression 350 is a list of patients in the database searched which satisfy the constraints specified. XML select subject record expression 358 categorizes the constraints specified in natural language select subject record expression 356 according to an OBTAL constructed according to the disclosed technique to be used in the medical research domain. For example, static constraints such as age and gender are categorized as demographic constraints 368. Temporal constraints such as HGB-state 370 and WBC-gradient 372 are categorized as local time and value constraints 374. Time constraints such as start date 376 and end date 378 are represented as being based on a relative timeline 380 following a reference event defined as BMT_Al. It is noted that default constraints in the XML select subject record expression 358 can be filled in automatically using a knowledge base. For example, the minimum and maximum age defined in the KB may be 0 years and 100 years respectively, and the minimum and maximum value for HGB-state 370 defined in the KB may be ‘very low’ to ‘high’ respectively. In natural language select subject record expression 356 only younger than 20 years and older than 70 years was specified, and the HGB-state was specified as at least moderately-low or higher. In XML select subject record expression 358, the minimum age of 0 years and the maximum age of 100 years were added, as well as the maximum value for HGB-state 370 of ‘high’ to specify the constraints more precisely. XML select subject record expression 358 also categorizes the pairwise relation specified in natural language select subject record expression 356 between the hemoglobin-state and the WBC count as a pairwise temporal constraint 382. As mentioned above in FIG. 4B, to define a global pairwise constraint, at least two concepts need to be defined and specified.

Natural language select subject record time interval expression 360 specifies a minimum and maximum threshold on the percentage of the population for which the other constraints specified should satisfy, i.e., between 50% and 90% of the patients searched in the DB. In addition, the value constraints which are specified are specified for raw data, such as the platelet value in units of cells/mL, as well as abstracted data, such as the WBC count. Also, a relative timeline is specified in the expression as the days following a BMT_Al. The result to be returned from select subject record time interval expression 352 is a list of days, relative to the BMT_Al, in the database searched which satisfy the constraints specified. XML select subject record time interval expression 362 categorizes the constraints specified in natural language select subject record time interval expression 360 according to an OBTAL constructed according to the disclosed technique to be used in the medical research domain. The time scale of the time interval to be searched for is specified in granularity 384 as ‘days.’ For each value constraint, the minimum and maximum threshold on the percentage of the population 386 is specified. In this example, the constraint on the percentage of the population for each value constraint was equivalent, although such a constraint could be specified differently for each value constraint. It is noted that for the WBC-state constraint, a delegate function of longest time 388 was specified, whereas for the platelet constraint, a delegate function of mean 390 was specified. Both of these delegate functions were specified at a granularity 384 of days. As in XML select subject record expression 358, default constraints in the XML select subject record time interval expression 362, such as ‘very-low’ for the WBC-state constraint, can be filled in automatically using a knowledge base.

Natural language retrieve subject record expression 364 specifies the particular data stored in a patient's subject record in a database to be retrieved, i.e., the hemoglobin-state value. In addition, the patients from which the specified data should be retrieved are specified, i.e., patients #1 to #10 in the database, as well as the time period in which the data should be retrieved, i.e., the first two weeks following a bone marrow transplant. The result to be returned from retrieve subject record expression 354 is a list of values from the constraints specified (i.e., the list of values from the patients specified in the time interval specified). In general, as mentioned above, once subject records have been specified and searched and once time intervals have been specified and searched, the resulting lists of subject records and time intervals are then used to retrieve data from the subject records returned in the time intervals returned. XML retrieve subject record expression 366 categorizes the constraints specified in natural language retrieve subject record expression 364 according to an OBTAL constructed according to the disclosed technique to be used in the medical research domain. The data to be retrieved from the subject records is specified as HGB-state 392. The particular subject records from which the data should be retrieved are specified by an attribute of the subject records, such as an ID number 394 of the subject records. Temporal intervals, as shown in FIG. 4A, are specified in XML retrieve subject record expression 366 as ranging from 0 seconds to 14 days, based on a relative timeline starting from a reference point 396, which is specified as the time following a bone marrow transplant.

Reference is now made to FIG. 6, which is an illustration showing examples of constraints specified in an ontology-based temporal aggregation population specification language using a GUI, generally referenced 420, constructed and operative in accordance with another embodiment of the disclosed technique. FIG. 6 includes two example GUIs, a first GUI 422 and a second GUI 424. Both first GUI 422 and second GUI 424 represent a graphical user interface equivalent to select subject record expression 350 (FIG. 5). First GUI 422 includes a constraints panel 426 where a user can graphically select constraints to place on a search of the subject records in a database. The constraints available to the user depend on the concepts defined in the ontology of the domain in which the disclosed technique is used as well as the knowledge base defined for the domain. In first GUI 422, two major categories of constraints are defined in a tab 427, namely demographical constraints and knowledge base constraints. Within each major category of constraints, a user can select a particular type of constraint within the category, referred to as an attribute in the figure. For example, in constraints panel 426, under the major category of demographical constraints, the user has selected the attributes of gender and age. For each type of constraint selected, a user can add a condition to limit the attribute using an add condition button 428. The possible conditions which a user can add depend on the definition of the type of constraint in the ontology and knowledge base used with the disclosed technique. In the example shown, for the attribute of age, the user has added two conditions using add condition button 428, a first condition 430 and a second condition 432. First condition 430 specifies that the age of the patients to be searched for is from minus infinity (i.e., substantially zero years) to twenty years. Second condition 432 specifies that the age of the patients to be search for is from seventy years to plus infinity (i.e., from seventy years and on). Radio buttons 434 enable the user to specify the relationship between the conditions. For example, since the radio button ‘Any’ is selected, the relationship between the two conditions is a Boolean OR relationship. Had the radio button ‘All’ been selected, the relationship between the two conditions would have been a Boolean AND relationship. As the user interactively selects constraints and conditions from constraints panel 426, an expression representing the constraints specified is generated automatically in an expression panel 436 as the user generates their select subject record expression graphically. For example, section 438 shows that the user has already selected the gender constraint and has specified the condition that all patients searched should be male (i.e., value Equal M). Section 440 shows that the user has already entered in first condition 430, specifying that the age of the patients to be searched should be from minus infinity to twenty years of age. Since second condition 432 has not been entered (i.e., green tick button 433 has not been clicked), the condition has not yet been added to the expression generated in expression panel 436.

In second GUI 424, the user has continued to add additional constraints and conditions to their select subject record expression. Under constraints tab 427, the user has selected the knowledge base constraints tab which has brought up a list of the concepts specified in the ontology and defined in the knowledge base, shown in constraints panel 444. As concepts specified in the ontology and defined in the knowledge base may represent raw concepts or abstracted concepts (i.e., concepts for which raw data is stored or concepts for which abstracted data is stored), constraints panel 444 includes a tab 446 for shifting the view of the concepts shown in constraints panel 444 between a regular view and a context view. In the context view, the concepts are displayed in a hierarchical view according to contexts and sub-contexts, as concepts can be defined at different levels of abstraction. In the regular view, concepts are displayed in groupings of their specific type and domain. As constraints panel 444 may include hundreds of concepts, a search panel 448 is provided to aid a user in finding the concepts they're looking for.

For each concept selected, a user is displayed a panel in which conditions on the concept can be specified. For example, for the selected concept HGB_STATE_BMT_{—}1, the user has selected values ranging from ‘moderately-low’ to ‘high’ in combo boxes 452 and a relative timeline for specifying the starting point of the condition specified in relative time panel 454. To visually aid the user, a graphical representation of the conditions selected for a concept is displayed as a graph 450. Graph 450 shows that for the condition of the HGB-state, the values selected (as shown on the y-axis of the graph) range from moderately-low to high. According to the conditions selected, the values selected are to be limited to a one month period (as shown on the x-axis of the graph), starting from (i.e., relative to) the time when an allogenic bone marrow transplant was completed. The units of the y-axis of graph 450 depend on the definition of the concept selected in the knowledge base. The units of the x-axis of graph 450 depend on the granularity of the time condition selected, which can range from seconds to years, for example. For the selected concept WBC_GRADIENT_BMT_{—}1, the user has selected a value defined as ‘inc’ (i.e., increasing) for a limit of a one month period (as shown on the x-axis of the graph), starting from (i.e., relative to) the time when an allogenic bone marrow transplant was completed. In the example shown in second GUI 424, the combo boxes, radio buttons and other GUI elements for specifying conditions on the selected concept WBC_GRADIENT_BMT_{—}1 are not visible. The resultant conditions specified are seen in a graph 456. In second GUI 424, the user has also selected a global pairwise constraint as shown in section 458. A panel 460 shows that the user has selected a pairwise temporal constraint (displayed as a time pairwise constraint), and has specified a temporal condition of ‘during.’ The possible temporal conditions depend on the interval relations defined to be used with the disclosed technique. In the example shown in FIG. 6, Allen's Interval Algebra is used, meaning that thirteen different temporal conditions are defined. Once the temporal condition is selected, the parameters relating to the time pairwise constraint are filled in automatically. As can be seen in second GUI 424, additional parameters on the time pairwise constraint can be added by the user. As in first GUI 422, expression panel 436 shows the select subject record expression generated according to the concepts selected and the conditions specified. Section 462 shows the concepts selected and conditions specified in first GUI 422. As can be seen, the line specifying the second condition on the concept age has now been added to the expression, i.e., from seventy to plus infinity years. Section 464 shows the knowledge base concepts and their specified conditions, including the selected values, the reference point for a relative timeline, as well as the duration for the values selected. Section 466 shows the pairwise constraints selected on the pairwise concepts of WBC_GRADIENT_BMT and HGB_STATE_BMT.

Reference is now made to FIG. 7, which is another illustration showing examples of constraints specified in an ontology-based temporal aggregation population specification language using a GUI, generally referenced 480, constructed and operative in accordance with a further embodiment of the disclosed technique. FIG. 7 include a GUI 482 which represents a graphical user interface equivalent to select subject record time interval expression 352 (FIG. 5). GUI 482 includes a constraints panel 484 which lists all the concepts in the ontology and the knowledge base used with the disclosed technique. In this example, the ontology represents a medical ontology and the knowledge base a medical knowledge base. As the ontology and knowledge base include definitions and contexts for the concepts listed, a tab 486 for shifting the view of the concepts shown in constraints panel 484 between a regular view and a context view is provided. Also, as the number of concepts in constraints panel 484 may be substantially large, a search panel 488 is provided to aid a user in finding the concepts they're looking for. GUI 482 represents an expression in which a time interval is to be returned, and as such, the time scale of the time interval to be returned is specified in granularity section 490. Relative timeline section 492 enables a user to specify a relative timeline if necessary. For each concept selected from constraints panel 484, a user can specify various conditions on the concept as defined in the OBTAL generated according to the disclosed technique. In panel 494, for the concept WBC_STATE_BMT, a user can select a range regarding the percentage of patients with the specified constraints, the range of values as well as the delegate function to be used to aggregate the data stored for the concept in each subject record. The delegate functions used to aggregate the data stored (i.e., the delegate values) are determined according to the granularity specified in granularity section 490. This is similarly shown in panel 496 for the concept PLATELET. As shown in the GUIs of FIG. 6, an expression panel 498 is provided which automatically generates a select subject record time interval expression based on the concepts and conditions specified in GUI 482. It is noted that the GUIs shown in FIGS. 6 and 7 are brought as examples and that the actual implementation of a GUI for an OBTAL is a matter of design choice of the worker skilled in the art, as many GUI designs and implementations are possible.

Reference is now made back to FIG. 2. As described above, data provider 152 and explorer 148 are involved in determining aggregated values for multiple entries in a particular subject record. According to the disclosed technique, data from a plurality of subject records can be analyzed together and compared over time, even when such data, as raw data or abstracted data, is stored using different time scales. In order to compare data from a plurality of subject records, and depending on the constraints specified, the data stored in a subject record may need to be aggregated into a single value to enable a comparison. According to the disclosed technique, data provider 152 and explorer 148 can determine a representative, or delegate value of a record on a specified time scale, using a representative, or delegate function to determine such a value. It is also noted that in certain fields, a plurality of values may be stored as records for a particular subject record in subject record database 154 during a specified time period at a particular granularity. Recall that the term granularity is used in the description to refer to the time scale on which a value is stored at, or as a constraint in constraint specifier 146, such as seconds, minutes, day, weeks, months, years and the like. For example, in the medical research domain values for a concept, such as blood glucose level, may be stored as at a granularity of minutes, and that for a particular time period, such as a day, a subject record may include multiple values representing the blood glucose level of an individual, each stored with a time-stamp that includes the date of when the blood glucose level was measured as well as the time of day at a resolution of minutes. At the same time, a medical researcher may require a single representative value, i.e., a delegate value, for an individual's blood glucose level at a granularity of a day, meaning one value of the blood glucose level of the individual to represent the plurality of values stored for the blood glucose level of that individual over a given day. In general, data provider 152 determines delegate values for concepts specified by constraint specifier 146 in order to return a search result based on a user's search query, i.e., given a particular search query of subject record database 154 from constraint specifier 146, data provider 152 determines the delegate value or values as specified by the user (e.g., determine the mean population value for a concept and compare it to each subject record's delegate value for the concept) and returns the search result to explorer 148. Data provider 152 determines delegate values when a user specifies in constraint specifier 146 that such delegate values should be retrieved in a retrieve subject record expression 198 (FIG. 4A). Such delegate values are returned to the user. Explorer 148 determines delegate values for concepts to represent the requested data by user 142 graphically in explorer 148. As described in more detail below, explorer 148 can also recalculate delegate values shown graphically based on specific parameters selected by a user. What follows is a more detailed description of how data provider 152 determines delegate values for a concept specified by constraint specifier 146. The method of how explorer 148 determines delegate values is substantially similar to how data provider 152 determines delegate values. Further on, a detailed description is provided of how explorer 148 displays determined delegate values graphically for a concept specified by user 142. It is noted that requested data by user 142 as specified in a retrieve subject record expression 198 may be significantly different than requested data by user 142 which is to be displayed graphically and manipulated and analyzed in explorer 148.

Constraint specifier 146 enables a user to specify that a delegate value for data stored in a subject record should be determined for either a single subject record or for a plurality of subject records. In this respect, delegate values can be determined for an individual subject record or for a population of subject records. For example, using Equation (13), a constraint can be specified on subject record database 154 that refers to either an individual subject record or a population of subject records. In addition, constraint specifier 146 also enables a user to specify whether the delegate value determined is for data stored for a raw concept (i.e., raw data) or data stored for an abstract concept (i.e., abstracted data). In other words, unlike the prior art, the disclosed technique enables statistical aggregation of concepts that may be stored not only on a continuous numeric scale but also on a discrete value scale. For example, in the information security domain, subject record database 154 may store an abstract concept for subject records (e.g. computer stations) such as ‘network threat’ to represent the level of threat to the safely of the network from a particular computer station. The values stored for such a concept may be on a discrete value scale, such as a scale ranging from ‘very low’ to ‘very high.’ For a given subject record, network threat values may be stored at a granularity of days, meaning each day, subject record database 154 stores a value representing the network threat of each computer station on the network defined in the database. For example, for a four week period, a computer station may have stored for the concept ‘network threat’ the values ‘very low’ twice, ‘low’ thirteen times, ‘very high’ eight times and ‘average’ five times. A worker skilled in the art may want to explore the network threat of computer stations at a granularity of months, i.e., which computer stations at the time scale of months represent network threats. As described below, the disclosed technique enables data provider 152 to determine a delegate value for abstract concepts such as ‘network threat’ which are measured and stored on a discrete value scale.

Furthermore, constraint specifier 146 also enables a user to specify whether a single delegate value determined is for a particular time period, or whether a series of delegate values is to be determined for a particular time period at a particular time granularity. For example, in the medical research domain, subject record database 154 may have stored for the concept HGB value for a particular subject record three measures of the HGB value on Feb. 15, 2004, two measures of the HGB value on Feb. 20, 2004, and two measures of the HGB value on Feb. 21, 2004. Using constraint specifier 146, user 142 can specify that a single delegate value be determined for the HGB value of the subject record in the example above for the time period of Feb. 14, 2004 to Feb. 24, 2004. In other words, user 142 can request that a single value be determined for the HGB value of the subject record specified to represent the HGB value of the subject record over the time period specified. In addition, also using constraint specifier 146, user 142 can specify that a series of delegate values be determined for the HGB value of the subject record in the example above at a granularity of days. In other words, user 142 can request that a series of delegate values be determined for the HGB value of the subject record specified to represent the HGB value per day of the subject record over the time period specified. In this example, three delegate values would be returned, one to represent the HGB value of Feb. 15, 2004, a second to represent the HGB value of Feb. 20, 2004 and a third to represent the HGB value of Feb. 21, 2004. Since no records were stored for the HGB value on the other days specified in the time period, no delegate values are determined for those days. To summarize, data provider 152 can determine eight different types of delegate values based on what user 142 specifies in constraint specifier 146. For a specification of either a delegate value for a single subject record or a population of subject records, user 142 can specify if the delegate value is to be for a raw concept or for an abstract concept. For each of a raw concept and an abstract concept, user 142 can specify if a single delegate value is to be determined or a series of delegate values is to be determined.

As mentioned above, time-oriented values stored in a subject record for a particular concept can be aggregated into a delegate value using a particular function. This function is referred to as a delegate function and represents the function by which the values to be aggregated are aggregated. Such functions can include, for example, the mean, the mode, the median, the maximum value, the minimum value and the like. In general, the delegate function can be substantially any function which receives as input a plurality of values and outputs a single value, provided that the domain and units of the inputted values are preserved in the outputted value by the delegate function. It is noted that the choice of delegate function for a particular concept may be constrained by definitions in the KB. In other words, for each concept in the KB, a list of reasonable delegate functions may be stored and a user may only specify a delegate function from the list of reasonable delegate functions stored. Also, the delegate function selected may be particular to the time scale specified.

In order to enable data provider 152 to determine any delegate value or values as specified by user 142, a number of requirements may need to be placed on constraint specifier 146 as well as subject record database 154. A first requirement is that the granularity levels which can be specified in constraint specifier 146 are finite and defined. For example, by default the granularity levels possible may be seconds, minutes, hours, days, months and years. It is noted that in specified domains, additional and/or different granularity levels may be necessary, such as semesters in the academic domain and quarters in the financial domain. If the disclosed technique is used in such domains then additional granularity levels may be defined as requirements for constraint specifier 146 and subject record database 154. In it also noted that according to another embodiment of the disclosed technique, a plurality of granularity levels may be defined by user 142, above and beyond the default granularity levels specified above. For example, if in a particular domain, a time period of 2 days and 6 hours has particular significance, then a granularity of such a time period may be defined and specified as a requirement in constraint specifier 146 and subject record database 154. A second requirement may be that the data stored, for any concept stored in subject record database 154, is not stored at a granularity that is finer than the smallest granularity level defined by the first requirement. A corollary of this requirement is that for the smallest defined granularity level, for any concept stored in subject record database 154, not more than one value is stored. For example, if the finest granularity level defined in constraint specifier 146 is seconds, then no values for concepts stored in subject record database 154 are stored at a time resolution (i.e., granularity) less than seconds (e.g., milliseconds, microseconds, nanoseconds, etc. . . . ). In addition, for any concept, no two values stored for that concept can have the same time-stamp at the lowest granularity level. For example, if the time-stamp for a concept such as blood glucose level is given at a granularity of seconds, such as May 23, 2002, 18:45:23 (i.e., hours:minutes:seconds), then no two values for the concept blood glucose level can have the same time-stamp at the level of seconds (i.e., two values of the blood glucose level, both with the time-stamp May 23, 2002, 18:45:23). A third requirement may be that for a single delegate value, any time period at any granularity level (as defined by the first requirement) can be specified, but for a series of delegate values, the time period specified must be a whole multiple of the granularity level specified. For example, if user 142 wants a series of delegate values to be determined for a particular concept at a granularity level of months, then the time period specified for which the delegate values are to be determined must be a whole number of months, i.e., January 2007 to March 2008 and not Feb. 13, 2005 to Jul. 7, 2006. It is noted that in another embodiment of the disclosed technique, the third requirement mentioned above is modified to state that for a single delegate value, any time period at any granularity level can be specified, whereas for a series of delegate values, any time period may be specified but the granularity specified must be a whole multiple of the granularity levels defined in the first requirement above. For example, if user 142 wants a series of delegate values to be determined for a particular concept at a granularity level of months, then the time period specified for which the delegate values are to be determined can be any time period, such as from Feb. 13, 2005 to Jul. 7, 2006. Yet in such an example, each delegate value will represent a calendar month as the granularity specified must be a whole multiple of the granularity levels defined. Therefore, for the month of February 2005, values having a time stamp from Feb. 13 until the end of that month will be used to determine the delegate value for February 2005 and for the month of July 2006, values having a time stamp from July 1 until July 7 will be used to determine the delegate value for July 2006.

A fourth requirement may be that for a particular concept, user 142 cannot request a series of delegate values for that concept at a granularity level which is smaller than the granularity level at which values for the concept were stored at. For example, for the concept WBC-state, if values for the concept are stored at a granularity of days, then user 142 cannot specify that a series of delegate values be determined for the concept over a time period of three days at a granularity of hours, meaning that a delegate value should be determined for each hour over the time period of three days specified. A fifth requirement may be that for time-oriented data stored in subject record database 154, which represents the data for which delegate values can be determined for, for any time-oriented concept, the data stored has a general structure which can be defined formally as

InputData≡<SubjectRecordₙ,Concept_{c},TStart_{n,c,m},TEnd_{n,c,m},Value_{n,c,m}>*1≦n≦N, 1≦c≦C, 1≦m≦Mₙ (23)

where InputData represents the stored subject record which is used to determine a delegate value. N represents the total number of subject records in the database and C represents the total number of concepts stored for each subject record in the database. Mₙ represents the total number of values for Concept_{c} in SubjectRecordₙ and can vary for each subject record. TStart_{n,c,m} and TEnd_{n,c,m} represent, respectively, the start time and the end time at which the m^{th} value (Value_{n,c,m}) for Concept_{c} for SubjectRecordₙ was determined. It is noted that depending on the concept for which data is stored for, TStart_{n,c,m}, and TEnd_{n,c,m} may be equivalent, so long as the seconds value, if it is stored, is not the same, as per the second requirement above. The asterisk * represents zero or more repetitions, i.e., no repetitions as well as the possibility of at least one repetition. As example of the data structure in Equation (23) is provided below in Table 2. The example in Table 2 is taken from the medical research domain.

TABLE 2
Data structure of time-oriented data in a subject record database

| Subject | | | | |
|---|---|---|---|---|
| Record ID | Concept | Start Time | End Time | Value |
| (SubjectRecordₙ) | (Concept_{c}) | (TStart_{n,c,m}) | (TEnd_{n,c,m}) | (Value_{n,c,m}) |
| Patient 1 | HGB | 23-10-01 | 23-10-01 | 9.6 |
| | value | 24-10-01 | 24-10-01 | 9.3 |
| | (g/dL) | 01-11-01 | 01-11-01 | 9.1 |
| | Raw WBC | 15-03-04 - | 15-03-04 - | 6000 |
| | count | 09:04:34 | 09:10:39 | |
| | (number/ | 15-03-04 - | 15-03-04 - | 7500 |
| | mL of | 11:23:49 | 11:26:03 | |
| | blood) | | | |

In Table 2, Mₙ for the concept HGB value is 3 whereas for the concept WBC count is it 2. The data shown in Table 2 is an example of a part of the data stored for a single subject record. Whereas the exact data structure of subject record database 154 is a matter of design choice of the worker skilled in the art, according to the fifth constraint, time-oriented data to be used in the determination of delegate values requires that values for concept be recorded and time-stamped with a start time and an end time, as per Equation (23).

The eight different types of delegate values which data provider 152 can determine are now described in terms of how data provider 152 determines them. To determine a single delegate value for a single subject record of data stored for a raw concept over a particular time period, data provider 152 must be provided a number of constraints from constraint specifier 146 as follows: the subject record to be accessed, denoted as subject record n, the concept for which a delegate value is to be determined, denoted as concept c, the delegate function to be used to aggregate the data into a single value, denoted as DF_{c} and the time period over which the data for the concept is to be aggregated into a single value, denoted as TAggr (i.e., a specified aggregation time period). It is noted that DF_{c} may be specific for concept c and for the granularity at which data is stored for concept c. Given the constraints from constraint specifier 146, data provider 152 accesses subject record database 154 and retrieves the data values for subject record n, for concept c that fall within the time period specified by TAggr. Data provider 152 then accesses domain knowledge base 156 and determines any properties or definitions relating to DF_{c}. For example, domain KB. 156 may specify a default delegate function for a given concept. Data provider 152 then applies the delegate function DF_{c} to the retrieved data values and returns the output of DF_{c} to user 142 via explorer 148. Formally, TAggr can be defined as follows:

TAggr=[TAggrₛₜₐᵣₜ,TAggr_{end}] (24)

Where TAggrₛₜₐᵣₜ represents the start of the aggregation time period and TAggr_{end} represents the end of the aggregation time period. Formally, data provider 152 solves the following equation to determine the delegate value:

DelegateValue_{n,c,TAggr}≡DF_{c}](TStart_{n,c,I},TEnd_{n,c,I},Value_{n,c,I}) . . . (TStart_{n,c,i} ,TEnd_{n,c,i},Value_{n,c,i}) . . . (TStart_{n,c,K},TEnd_{n,c,K},Value_{n,c,K})]1≦n≦N, 1≦c≦C, 1≦i≦K (25)

where DelegateValue_{n,c,TAggr} represents the delegate value for subject record n, for concept c in time period TAggr. K is the total number of values stored for concept c in TAggr, where K≦M. It is noted that TAggrₛₜₐᵣₜ≦TStart_{n,c,i} and that TEnd_{n,c,i}≦TAggr_{end}. It is noted that K varies per subject record, per concept and per aggregation time period specified. As mentioned above, the DF_{c} can be a default delegate function defined in domain knowledge base 156 or can be a delegate function chosen by user 142 as specified using constraint specifier. As shown below, in explorer 148, user 142 may be able to change the delegate function used to determine a delegate value. An example, from the medical research domain, of a delegate value determined using Equation (25) may be to determine a delegate value for a patient's platelet count after a bone marrow transplant procedure for a given day. Assume that on a given day, the patient had two platelet counts recorded and stored in a subject record database, such as 22000 cells/mL at 10:00 a.m. and 17000 cells/mL at 9:00 p.m. If the default DF for the concept platelet count is the mean, then the delegate value determined for the given day will be 19500 cells/mL. As mentioned above, in explorer 148, the user may be able to select a different delegate function to aggregate the platelet counts of a single day into a delegate value, such as the median or the maximum value. It is also noted, as described further below with regards to determining a series of delegate values at a given granularity, that unlike standard statistical functions, the delegate functions used with the disclosed technique aggregate a plurality of values at a specified aggregation time period for a given granularity.

To determine a series of delegate values for a single subject record of data stored for a raw concept over a particular time period at a specified granularity, data provider 152 must be provided a number of constraints from constraint specifier 146 as follows: the subject record to be accessed, denoted as subject record n, the concept for which a delegate value is to be determined, denoted as concept c, the delegate function to be used to aggregate the data into a series of values, denoted as DF_{c}, the overall time period over which the data for the concept is to be aggregated into a series of values, denoted as TOverall (i.e., an overall aggregation time period) and the granularity at which each delegate value of the series of delegate values is to be determined at, denoted as TGran. It is noted that n, c and DF_{c} are as defined above. It is also noted that TOverall is substantially similar to TAggr, as defined above. TAggr can represent any specified aggregation time period for which a single delegate value will be determined. TOverall represents any specified aggregation time period for which a series of delegate values will be determined at a granularity specified by TGran. Whereas a single delegate value determined within TAggr is not limited to a defined granularity level, TGran represents an aggregation time period at one of the granularity levels defined as specified above in the first requirement. It is noted that one of the differences between the determination of a single delegate value as compared to the determination of a series of delegate values relates to this difference between. TAggr and TGran. For a single delegate value, TAggr can represent any specified aggregation time period, such as from Aug. 23, 2004 at a time of 9:23 am to Sep. 14, 2004 at a time of 5:34 pm (i.e., a time period of 22 days, 8 hours and 11 minutes), whereas for a series of delegate values, the aggregation time period (TGran) for each delegate value within TOverall must be at one of the granularity levels defined, as specified above in the first requirement (i.e., either whole seconds, whole minutes, whole hours, whole days, whole months or whole years). Formally, TOverall and TGran can be defined as follows:

TOverall≡[TOverallₛₜₐᵣₜ,TOverall_{end}] (26)

TGran≡[TGranₛₜₐᵣₜ,TGran_{end}] (27)

Given the constraints from constraint specifier 146, data provider 152 accesses subject record database 154 and retrieves the data values for subject record n, for concept c that fall within the time period specified by TOverall. Data provider 152 then accesses domain knowledge base 156 and determines any properties or definitions relating to DF_{c}. For example, domain KB 156 may specify a default delegate function for a given concept. Based on TGran, data provider 152 then applies the delegate function DF_{c} to the retrieved data values for each aggregation time period TGran in TOverall. The output of each DF_{c} is returned to user 142 via explorer 148 as a series of delegate values over the overall aggregation time period TOverall. Formally, data provider 152 solves the following equation to determine the series of delegate values:

DelegateValues_{n,c,TOverall}≡<SubjectRecordₙ, Concept_{c}, TGran_{start,n,c,j}TGran_{end,n,c,j},DelegateValue_{n,c,j}>*1≦n≦N, 1≦c≦C, 1≦j≦J_{n,c} (28)

where N represents the number of subject records in the subject record database and J_{n,c} represents the total number of delegate values for concept c of subject record n based on TGran and TOverall. J_{n,c} can be defined mathematically as

$${J}_{n , c} = \frac{TOverall}{TGran} \qquad ( 29 )$$

meaning that the total number of delegate values is substantially the time, period of TOverall, measured at the granularity level of TGran, divided by TGran. If TOverall is 7 months and TGran is months, then J_{n,c} will be 7, meaning 7 delegate values will be calculated for the time period of TOverall. According to another embodiment of the disclosed technique, Equation (29) is modified to include the possibility that TOverall is not a whole number, for example if TOverall is specified as being from Mar. 25, 2007 to Nov. 13, 2007. In such an example TOverall includes 7 whole months as well as two additional months for which a portion of the month is specified. In this example, if TGran is months, J_{n,c} will be 9, as delegate values will be determined for the months of March and November, even though not all the values stored in those months will be used in the calculation, as values with time stamps beyond the time period specified in TOverall will not be included in the calculation. It is noted that J_{n,c} varies per subject record, per concept and in accordance with the time duration of TOverall. TGran_{start,n,c,j} and TGran_{end,n,c,j} represent the start and end times of the aggregation time period TGran_{n,c,j} for the j^{th} delegate value for subject record n and concept c. The values for TOverallₛₜₐᵣₜ and TOverall_{end} can be defined formally as:

TGran_{start,n,c,1}=BeginningOf(TStart_{n,c,1})≧TOverallₛₜₐᵣₜ (30)

TGran_{end,n,c,ln,c}=EndOf(TEnd_{n,c,K})≦TOverall_{end} (31)

In other words, according to Equation (30), the first aggregation time period at the level of the specified granularity, TGranₛₜₐᵣₜ, is equal to the beginning of the time period of the first value (i.e., value 1) for subject record n, for concept c, which is equal to or greater than the start of the overall time period for which data is to be aggregated (i.e., TOverallₛₜₐᵣₜ). According to Equation (31), the last aggregation time period at the level of the specified granularity, TGran_{end}, is equal to the end of the time period of the last value (i.e., value K, where K≦Mₙ) for subject record n, for concept c, which is less than or equal to the end of the overall time period for which data is to be aggregated (i.e., TOverall_{end}).

An example, from the medical research domain, of a series of delegate values determined using Equation (28) may be to determine delegate values for a patient's lipoprotein panel over the course of half a year (6 months) at a granularity of months. Assuming that in the first month, patient n had 5 measures of their lipoprotein panel, during the second month, the patient had 3 measures of their lipoprotein panel and during the fifth month, the patient had 7 measures of their lipoprotein panel. If the default DF for the concept lipoprotein panel is the maximum value, then for each aggregation time period TGran, which in this example is specified at a granularity of months, the delegate value determined will be the maximum value of the lipoprotein panel for that month. What will be returned to user 142 is a delegate value for each month specified in the overall time aggregation period of 6 months. Since for some months, no measures were made of the lipoprotein panel, then for those months, no delegate values will be determined. As mentioned above, in explorer 148, the user may be able to select a different delegate function to aggregate the lipoprotein panel of a given month into a delegate value, such as the median or the mean. It is noted that in the disclosed technique, the delegate functions used to aggregate a plurality of values into a series of delegate values are applied at specified aggregation time periods at a given granularity. As per the example above, the delegate function specified is applied to measurements of the lipoprotein panel on a per month basis. It is also noted that a user can specify TOverall at a finer granularity than the granularity of TGran. Using the example above, TOverall may represent a time period of approximately 6 months starting from the middle of the month, for example, from Jan. 15, 2004 (TOverallₛₜₐᵣₜ) until Jul. 22, 2004 (TOverall_{end}), with TGran still being at a granularity of months. In this example, for the first and last delegate values in the series, only the values which fall within the time period defined by TOverall will be used to determine the delegate value for that month. In other words, for the month of January, only values with a time stamp of Jan. 15, 2004 and onwards will be used to determine the delegate value for the month of January even though values may exist for the concept specified in January, albeit with a time stamp being before Jan. 15, 2004. A delegate value for the month of January will be determined even though not all the values stored for the concept with a time stamp of January 2004 will be used in the determination. The same goes for the month of July.

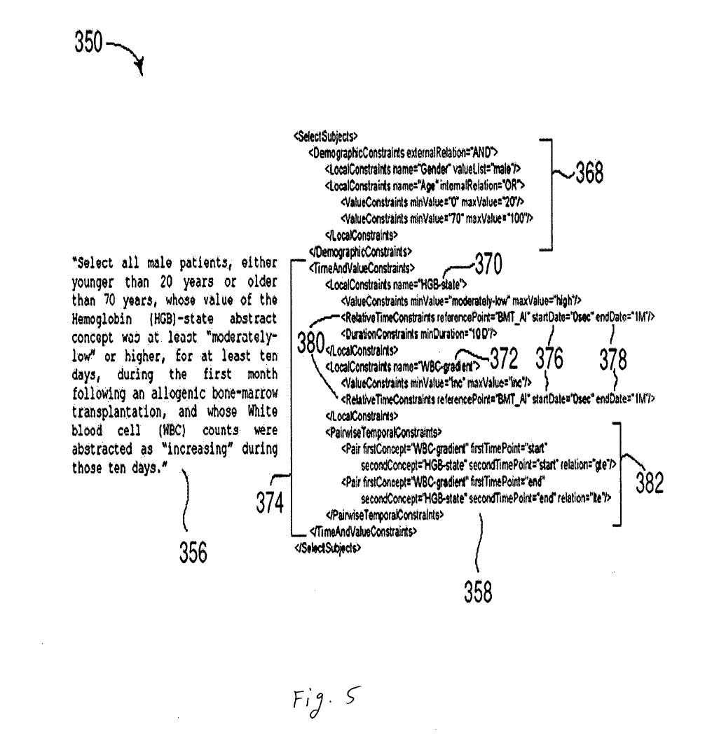

Determining a single delegate value for a single subject record of data stored for an abstract concept over a particular time period is determined in a manner substantially similar to the determination of a single delegate value for a single subject record of data stored for a raw concept over a particular time period, as described above. Likewise, determining a series of delegate values for a single subject record of data stored for an abstract concept over a particular time period at a specified granularity is determined in a substantially similar manner to the determination of a series of delegate values for a single subject record of data stored for a raw concept over a particular time period at a specified granularity, as described above. In the case of a delegate value, or a series of delegate values of an abstract concept for a single subject record, standard statistical functions for use as delegate functions, such as mean, mode, maximum value and the like, are substantially not sufficient for aggregating a plurality of values into a single value or into a series of values. Recall that abstract concepts as they relate to the disclosed technique refer to time-oriented concepts for which data is stored using a discrete value scale. In other words, for abstract concepts, data is stored on a discrete value scale having a particular time period or time interval (as shown above in Table 2). For example, in the information security domain, an abstract concept may be ‘network threat,’ as defined above. Assume that during an aggregation time period of a month, 12 measures of the network threat of a computer station were stored in a subject record database. Recall that each measure of the network threat may have a particular time duration, such as 2 hours, 3 days or 24 minutes. If user 142 wants a delegate value to represent the network threat of the computer station for the month, then a delegate function such as mean or mode will not be sufficient for determining such a delegate value, as the standard statistical functions MEAN or MODE do not take into consideration the time duration of a measurement. Using the example above, assume that 11 of the 12 measures stored a value of ‘high’ for the concept network threat, but each had a time duration of 5 minutes, whereas 1 measure stored a value of ‘normal’ for the concept network threat, but had a time duration of 20 days. Using standard statistical functions, such as MEAN or MODE, a delegate value of ‘high’ will be determined. Yet such a delegate value is not substantially representative of the network threat for a month since the time duration of each measure is not taken into consideration when determining the delegate value. In addition, if a series of delegate values is to be determined, then situations may arise wherein for a given TGran_{n,c,j} different discrete values may be stored in the subject record database, and standard statistical functions may not be able to determine a suitable delegate value for a given TGran_{n,c,j}. An example of such a situation in described below in FIG. 8A. As such, according to the disclosed technique, domain knowledge base 156 may define specific delegate functions for abstract concepts in which the value for an abstract concept as well as its duration are taken into account. Such specific delegate functions may include a maximal cumulative duration delegate function and a maximal value-time period delegate function, both of which are explained below in FIGS. 8A-8C.

Reference is now made to FIGS. 8A-8C, which are graphs showing a method for determining delegate values for abstract concepts, generally referenced 520, operative in accordance with another embodiment of the disclosed technique. In each of FIGS. 8A-8C, similar elements are labeled with equivalent numbers. FIG. 8A graphically shows abstracted data stored for an abstract concept which is time oriented. FIG. 8A includes a time axis 522, a first aggregation time period 524, a second aggregation time period 526, a third aggregation time period 528 and a discrete value axis 530. Also included are specific stored values for the abstract concept which are a first value 532, a second value 534, a third value 536, a fourth value 538 and a fifth value 540. Time axis 522 represents time and graphically shows the time-stamp of each of first value 532, second value 534, third value 536, fourth value 538 and fifth value 540. Whereas the specific units of time axis 522 are not shown, it can be seen that second value 534 is relatively short and third value 536 is relatively long as compared to first value 532, fourth value 538 and fifth value 540. Discrete value axis 530 shows the discrete values which can be stored for the abstract concept, shown in FIG. 8A as ‘high,’ ‘moderate’ and ‘low.’ As an example, the abstract concept graphically shown in FIGS. 8A-8C may be an individual's WBC-state. Therefore, first value 532 shows that during the time period spanning first value 532, the individual's WBC-state was stored as being ‘low.’ Second value 534 shows that during the time period spanning second value 534, the individual's WBC-state was stored as being ‘low.’ Third value 536 shows that during the time period spanning third value 536, the individual's WBC-state was stored as being ‘high.’ Fourth value 538 shows that during the time period spanning fourth value 538, the individual's WBC-state was stored as being ‘low.’ Fifth value 540 shows that during the time period spanning fifth value 540, the individual's WBC-state was stored as being ‘moderate.’

In FIG. 8A, it is assumed that a user has requested a series of delegate values spanning an overall aggregation time period, TOverall, shown as a line 523, starting from the beginning of first aggregation time period 524 and ending at the end of third aggregation time period 528. According to the granularity specified by the user, three aggregation time periods (referred to above as TGran) have been specified, shown in FIG. 8A as first aggregation time period 524, second aggregation time period 526 and third aggregation time period 528. It is noted that the time period of first value 532, third value 536 and fifth value 540 overlaps the specified aggregation time periods specified by a user. In such a situation, a standard statistical function cannot be used to determine a delegate value, for example, for first aggregation time period 524. In the situation shown in FIG. 8A, a maximal cumulative duration delegate function may be used by data provider 152 in Equations (25) and (28). A maximal cumulative duration delegate function represents a delegate function for which the delegate value for a specified aggregation time period is the value of the abstracted concept that has the maximal cumulative duration in the specified aggregation time period. This is shown graphically in FIGS. 8B and 8C.

Reference is now made to FIG. 8B. As shown in that figure, for each value within TOverall, the value stored is extrapolated in terms of its time duration according to a knowledge-based temporal interpolation function stored in domain knowledge base 156. Extrapolation in this context refers to extending the time duration for a value stored as abstracted data. The knowledge-based temporal interpolation function may be specific for each abstract concept defined in the KB. As shown, first value 532 is extrapolated to include extrapolated first value 532′, second value 534 is extrapolated to include extrapolated second value 534′ and extrapolated second value 534″, third value 536 is extrapolated to include extrapolated third value 536′ and extrapolated third value 536″, fourth value 538 is extrapolated to include extrapolated fourth value 538′ and extrapolated fourth value 538″, and fifth value 540 is extrapolated to include extrapolated fifth value 540′. It is noted that since the start of first value 532 and the end of fifth value 540 are beyond the boundaries of TOverall, the start of first value 532 and the end of fifth value 540 are not extrapolated. The extrapolation of the time duration of each of first value 532, second value 534, third value 536, fourth value 538 and fifth value 540 may be necessary in order to apply the specific delegate functions defined in the KB for abstract concepts. The knowledge-based temporal interpolation function used in FIG. 8B for the extrapolation of the values shown can be denoted as a Δ function and may be defined in the domain knowledge base 156. The Δ function defines the maximal time duration space between equivalent two values stored for a given raw concept or abstract concept, in a specific context, each having a particular time duration which does not overlap, for which the two values can be concatenated into a single value (which is substantially an interpolation). The concatenated single value will have a time duration of the first value, the second value and the time duration space between the two values. As a default, the (0,0) value of the Δ function can be used to determine how much the time duration of a value can be extrapolated. The (0,0) value of the Δ function (Δ(0,0)) represents the maximal time duration space between two equivalent values which can be concatenated into a single value when the time duration for each of the two values is substantially zero, i.e., the maximal time duration space between two equivalent points each having a different time-stamp. In the example shown in FIG. 8B, each of the start and end of a value is respectively extrapolated by half the (0,0) value of the Δ function (Δ(0,0)/2). As is shown in FIG. 8B, the amount of extrapolation for a particular value is proportional to the time duration of the value. As can be seen, the extrapolation of third value 536 is substantially larger than the extrapolation of fourth value 538, since the time duration of third value 536 is substantially larger than the time duration of fourth value 538. As mentioned above, it is noted that the determination of the extrapolated values can be determined by data provider 152 or explorer 148.

Reference is now made to FIG. 8C. Once each of the values shown has been extrapolated, the value and its respective extrapolated section or sections are concatenated and segmented according to the aggregation time period, or each aggregation time period TGran, specified by user 142. As shown in FIG. 8C, the part of first value 532 which falls within TOverall and extrapolated first value 532′ are concatenated and segmented into a modified first value 542. Second value 534, extrapolated second value 534′ and extrapolated second value 534″ are concatenated into a modified second value 544. Third value 536, extrapolated third value 536′ and extrapolated third value 536″ are concatenated and segmented into three modified third values, modified third value 546A, modified third value 546B and modified third value 546C. Each of the three modified third values is segmented according to a particular one of the aggregation time periods. Fourth value 538, extrapolated fourth value 538′ and extrapolated fourth value 538″ are concatenated into a modified fourth value 548. And the part of fifth value 540 which falls within TOverall and extrapolated fifth value 540′ are concatenated and segmented into a modified fifth value 550. As mentioned above, the segmentation and concatenation of the extrapolated values can be determined by data provider 152 or explorer 148. Once the values have been concatenated and segmented if required, the maximal cumulative duration delegate function is used by data provider 152 in each time aggregation time period to determine the delegate value for that aggregation time period. The maximal cumulative duration represents the value which has the longest time duration for a given aggregation time period mode. For example, for first aggregation time period 524, the delegate value determined will be the discrete value ‘low’ since modified first value 542 and modified second value 544, both of which have a value of ‘low,’ jointly have a longer time duration than modified third value 546A, which has a value of ‘high.’ It is noted that in this respect the maximal cumulative duration is similar to the standard statistical function MODE. For second aggregation time period 526, the delegate value determined will be the discrete value ‘high.’ For third aggregation time period 528, the delegate value determined will also be the discrete value ‘high’ since the time duration of modified third value 546C is longer than either modified fourth value 548, which has a discrete value of ‘low’ or modified fifth value 550, which has a discrete value of ‘moderate.’ It is noted that the delegate value for third aggregation time period 528 is ‘high’ even though the time duration of fourth value 538 is longer than the time duration of third value 536 that falls within third aggregation time period 528. It is also noted that another specific delegate function used to determine the series of delegate values for the example shown in FIGS. 8A-8C may change the determined delegate values. Had user 142 requested a single delegate value for an aggregation time period equaling TOverall, which in this case would have been defined as TAggr, then a maximal value-time period delegate function may have been used to determined the delegate value. Using such a delegate function, the delegate value would be the value within the specified aggregation time period having the longest time duration.

To summarize, for determining a single delegate value for a single subject record of data stored for an abstract concept over a particular time period and for determining a series of delegate values for a single subject record of data stored for an abstract concept over a particular time period at a specified granularity, as shown above, data provider 152 uses Equations (25) and (28) to determine the specified delegate value or values, except that specific delegate functions are used to aggregate the values within the particular time period, as shown above in FIGS. 8A-8C. The modified values required for the specific delegate functions may be determined by data provider 152 or explorer 148. Such modified values are then used to determine the specified delegate value or specified series of delegate values. It is noted in particular that first value 532, second value 534, third value 536, fourth value 538 and fifth value 540 may be determined by data-driven abstractor 162 (FIG. 2) or query-driven abstractor 164 (FIG. 2). Extrapolated first value 532′, extrapolated second value 534′, extrapolated second value 534″, extrapolated third value 536′, extrapolated third value 536″, extrapolated fourth value 538′, extrapolated fourth value 538″ and extrapolated fifth value 540′ as well as modified first value 542, modified second value 544, modified third value 546A, modified third value 546B, modified third value 546C, modified fourth value 548 and modified fifth value 550 may be determined by explorer 148 (FIG. 2) or data provider 152 (FIG. 2).

Reference is now made back to FIG. 2. Determining a single delegate value for a population of subject records of data stored for a raw concept over a particular time period is substantially similar to determining a single delegate value for a single subject record of data stored for a raw concept over a particular time period. Likewise determining a single delegate value for a population of subject records of data stored for an abstract concept over a particular time period is substantially similar to determining a single delegate value for a single subject record of data stored for an abstract concept over a particular time period. In both determinations just mentioned, the main difference is that the delegate value determined is for a population of subject records and not for a single subject record. In other words, instead of aggregating the values for a concept c over a particular time period for a single subject record n, the values for a concept c over a particular time period are aggregated from a population of subject records n, where n ranges from 1 to N, with N being the number of subject records in the population having a value stored for concept c. As above, a particular time period in which values are to be aggregated for a population is defined as TAggr, as per Equation (24) above, in the case that a single delegate value is to be determined. In the case that a series of delegate values is to be determined, TOverall and TGran, as per Equations (26) and (27) above are used. Unlike the description above, instead of just accessing the values for concept c in TAggr for subject record n, data provider 152 accesses the values for concept c in TAggr for a population of subject records stored in subject record database 154. It is noted that the population of subject records can be all the subject records for which a value for concept c is stored or a subset of those subject records. In addition, the delegate value is determined using a population delegate function, denoted as PDF, which aggregates the values for concept c over the specified aggregation time period TAggr for a population of subject records. As above, the PDF may be specific for concept c and for the granularity at which values are stored in the DB for concept c. In the case of a raw concept, PDF can be any statistical function which can be applied to all the values of concept c within TAggr for all the subject records specified and which returns a single value in the same domain with the same units. In the case of an abstract concept, PDF may be one of the specific delegate functions described above which can determine a delegate value for concepts which are time-oriented and are measured on a discrete value scale. A single delegate value for a population of subject records for concept c, for either a raw concept or an abstract, can be stated formally as:

PopulationDelegateValue_{c,TAggr}≡PDF_{c}[(TStart_{n,c,I},TEnd_{n,c,I},Value_{n,c,I}) . . . (TStart_{n,c,i},TEnd_{n,c,i},Value_{n,c,i}) . . . (TStart_{n,c,K},TEnd_{n,c,K},Value_{n,c,K})]1≦n≦N, 1≦c≦C, 1≦i≦K (32)

where the time boundaries of TAggr are defined formally as TAggrₛₜₐᵣₜ≦TStart_{n,c,i} and TEnd_{n,c,i}≦TAggr_{end}. All other parameters in Equation (32) are as defined above. N represents the total number of subject records in the population for which the population delegate value is determined for. K represents the number of values stored for concept c for subject record n within the aggregation time period TAggr. An example from the medical research domain of a population delegate value determined using Equation (32) by data provider 152 would be to determine the maximal value of the HGB value for a specified group of subject records, such as subject records with IDs from 1 to 500, during the aggregation time period ranging from Apr. 5, 2001 to Apr. 21, 2001. In this example, the maximal value is used as the PDF to return a single delegate value representing the HGB value for a group of subject records within a specified TAggr.

Determining a series of delegate values for a population of subject records of data stored for a raw concept over a particular overall aggregation time period is substantially similar to determining a series of delegate values for a single subject record of data stored for a raw concept over a particular overall aggregation time period. Likewise determining a series of delegate values for a population of subject records of data stored for an abstract concept over a particular overall aggregation time period is substantially similar to determining a series of delegate values for a single subject record of data stored for an abstract concept over a particular overall aggregation time period. In both determinations just mentioned, the main difference is that the series of delegate values determined is for a population of subject records and not for a single subject record. In other words, instead of aggregating the values for a concept c at specified aggregation time periods (i.e., at a particular granularity) for the duration of an overall aggregation time period for a single subject record n, the values for a concept c over specified aggregation time periods are aggregated from a population of subject records n, where n ranges from 1 to N, with N being the number of subject records in the population having a value stored for concept c. As above, an overall time period over which the data for the concept is to be aggregated into a series of values is defined as TOverall and the granularity at which each delegate value of the series of delegate values is to be determined at is defined as TGran. TOverall and TGran are defined above in Equations (26) and (27). Unlike the description above, instead of just accessing the values for concept c in TOverall for subject record n, data provider 152 accesses the values for concept c in TOverall for a population of subject records stored in subject record database 154. It is noted that the population of subject records can be all the subject records for which a value for concept c is stored or a subset of those subject records. In addition, the series of delegate values is determined using a population delegate function, denoted as PDF, which aggregates the values for concept c over the specified aggregation time periods TGran for a population of subject records. As above, the PDF may be specific for concept c and for the granularity at which values are stored in the DB for concept c. In the case of a raw concept, PDF can be any statistical function which can be applied to all the values of concept c within each TGran for all the subject records specified and which returns a single value per TGran in the same domain with the same units. In the case of an abstract concept, PDF may be one of the specific delegate functions described above which can determine a delegate value for concepts which are time-oriented and are measured on a discrete value scale. A series of delegate values for a population of subject records for concept c, for either a raw concept or an abstract, can be stated formally as:

PopulationDelegateValues_{c,TOverall}≡<Concept_{c}, TGran_{start,c,j},TGran_{end,c,j},PopulationDelegateValue_{cj}>*1≦n≦N, 1≦c≦C, 1≦j≦J_{c} (33)

where the time boundaries of TGran_{start,c,j} and TGran_{end,c,j} are defined as the particular aggregation time period at the specified granularity for the j^{th} population delegate value. All other parameters in Equation (33) are as defined above. N represents the total number of subject records in the population for which the population delegate value is determined for. J_{c} represents the total number of population delegate values for concept c for the specified population within the overall aggregation time period TOverall. An example from the medical research domain of a series of population delegate values determined using Equation (33) by data provider 152 would be to determine the maximal values of the HGB value for a specified group of subject records, such as subject records with IDs from 1 to 500, each month during the overall aggregation time period ranging from Jan. 1, 2002 to Dec. 31, 2002. In this example, the maximal value is used as the PDF to return a population delegate value representing the HGB value for the group of subject records for each month TGran within the specified TOverall.

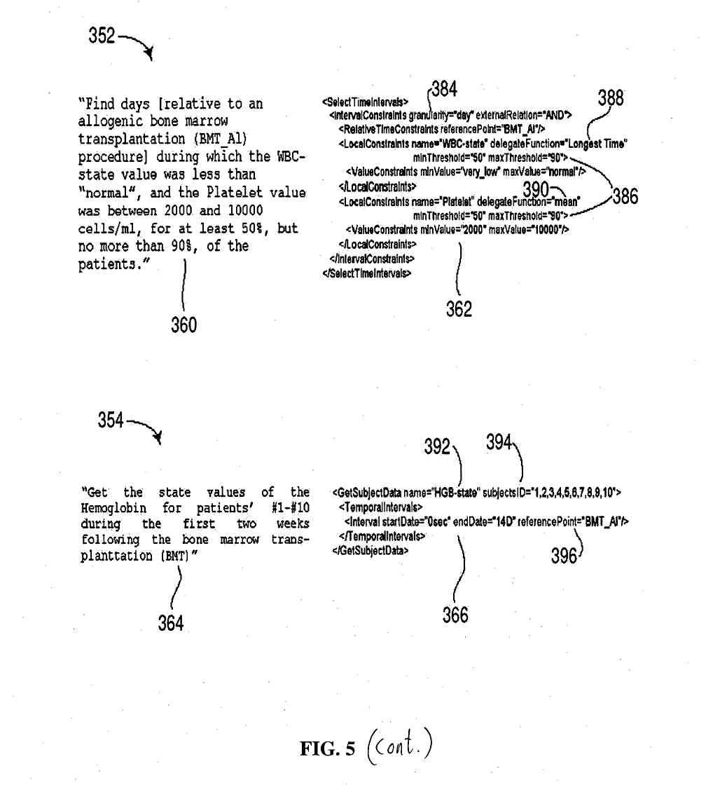

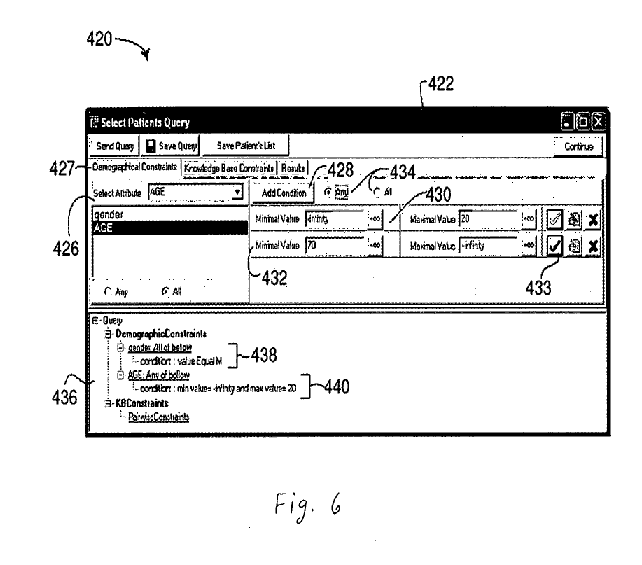

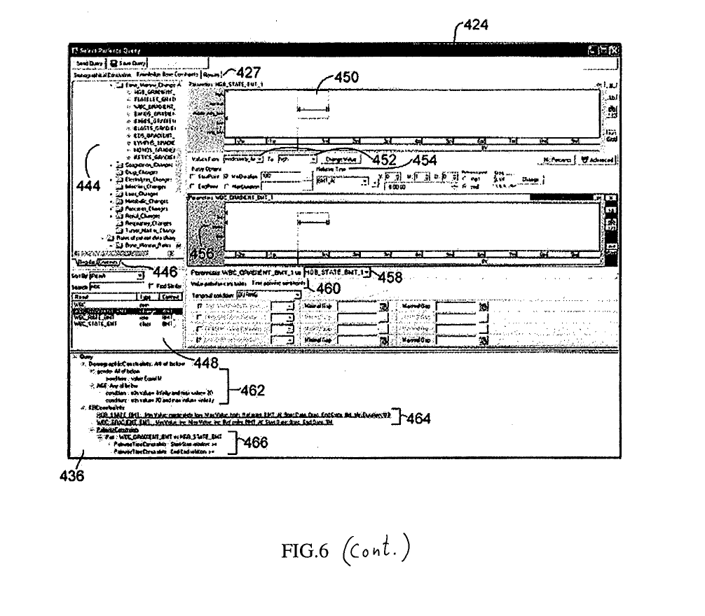

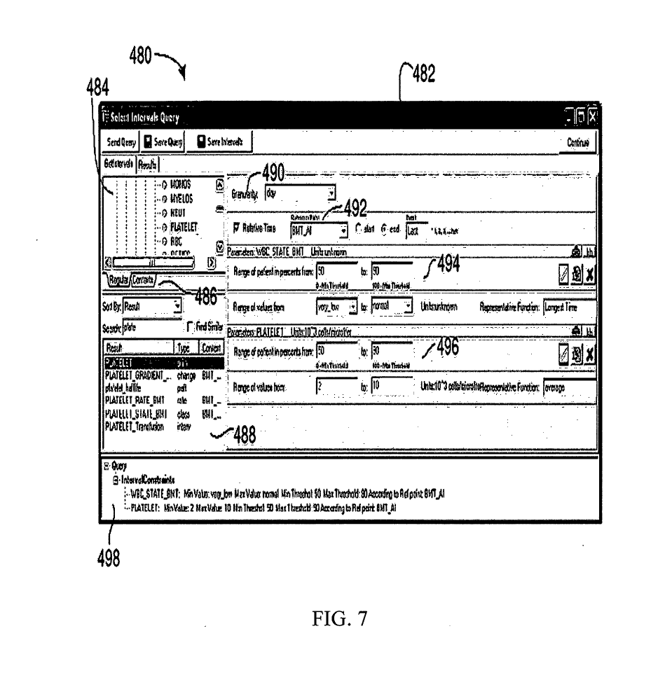

Reference is now made to FIG. 9A, which is a schematic illustration of a method for determining a single delegate value for a raw concept, generally referenced 570, operative in accordance with a further embodiment of the disclosed technique. In procedure 572, at least one subject record in a database of subject records is accessed for which a delegate value of a raw concept is to be determined. With reference to FIG. 2, based on at least one constraint specified by constraint specifier 146 (FIG. 2), data provider 152 (FIG. 2) accesses at least one subject record in subject record database 154 (FIG. 2) for a specified raw concept. In procedure 574, the data stored in the at least one subject record for the raw concept to be determined, having a time-stamp within a specified time period, is retrieved. The specified time period may be an aggregation time period, as specified above in Equation (24). With reference to FIG. 2, data provider 152 accesses subject record database 154 and retrieves the data values for subject record n, for concept c that fall within the time period specified by TAggr. In procedure 576, a specified function, such as a specified delegate function, is applied to the retrieved data, thereby determining a delegate value for the raw concept. It is noted that the specified function can be substantially any function which outputs a single value based on a plurality of inputted values. With reference to FIG. 2, data provider 152 accesses domain knowledge base 156 (FIG. 2) and determines any properties or definitions relating to DF_{c}. Data provider 152 then applies the delegate function DF_{c} to the retrieved data values and returns the output of DF_{c} to user 142 (FIG. 2) via explorer 148 (FIG. 2). It is noted that method 570 can be used to determine a single delegate value for a raw concept for a single subject record or for a population of subject records, depending on how many subject records are accessed in procedure 572.

Reference is now made to FIG. 9B, which is a schematic illustration of a method for determining a plurality of delegate values for a raw concept, generally referenced 580, operative in accordance with another embodiment of the disclosed technique. In procedure 582, at least one subject record in a database of subject records is accessed for which a plurality of delegate values of a raw concept is to be determined. With reference to FIG. 2, based on at least one constraint specified by constraint specifier 146 (FIG. 2), data provider 152 (FIG. 2) accesses at least one subject record in subject record database 154 (FIG. 2) for a specified raw concept. In procedure 584, the data stored in the at least one subject record for the raw concept to be determined, having a time-stamp within a specified overall time period, is retrieved. The specified overall time period may be an overall aggregation time period, as specified above in Equation (26). With reference to FIG. 2, data provider 152 accesses subject record database 154 and retrieves the data values for subject record n, for concept c that fall within the time period specified by TOverall.

In procedure 586, a plurality of granularity aggregations is determined. Each granularity aggregation represents an aggregation time period within the specified overall time period at a specified granularity. Each granularity aggregation can be specified as shown above in Equations (27), (30) and (31). With reference to FIG. 2, data provider 152 is provided with a number of constraints from constraint specifier 146 as follows: the subject record to be accessed, denoted as subject record n, the concept for which a delegate value is to be determined, denoted as concept c, the delegate function to be used to aggregate the data into a series of values, denoted as DF_{c}, the overall time period over which the data for the concept is to be aggregated into a series of values, denoted as TOverall (i.e., an overall aggregation time period) and the granularity at which each delegate value of the series of delegate values is to be determined at, denoted as TGran. In procedure 588, for each granularity aggregation, a specified function, such as a specified delegate function, is applied to the retrieved data in its respective granularity aggregation, thereby determining a series of delegate values for the raw concept. It is noted that the specified function can be substantially any function which outputs a single value based on a plurality of inputted values. With reference to FIG. 2, data provider 152 then accesses domain knowledge base 156 (FIG. 2) and determines any properties or definitions relating to DF_{c}. Based on TGran, data provider 152 then applies the delegate function DF_{c} to the retrieved data values for each aggregation time period TGran in TOverall. The output of each DF_{c} is returned to user 142 (FIG. 2) via explorer 148 (FIG. 2) as a series of delegate values over the overall aggregation time period TOverall. It is noted that method 580 can be used to determine a plurality of delegate values, such as a series of delegate values, for a raw concept for a single subject record or for a population of subject records, depending on how many subject records are accessed in procedure 582.

Reference is now made to FIG. 9C, which is a schematic illustration of a method for determining a single delegate value for an abstract concept, generally referenced 600, operative in accordance with a further embodiment of the disclosed technique. In procedure 602, at least one subject record in a database of subject records is accessed for which a delegate value of an abstract concept is to be determined. With reference to FIG. 2, based on at least one constraint specified by constraint specifier 146 (FIG. 2), data provider 152 (FIG. 2) accesses at least one subject record in subject record database 154 (FIG. 2) for a specified abstract concept. In procedure 604, the data stored in the at least one subject record for the abstract concept to be determined, having a time-stamp within a specified time period, is retrieved. The specified time period may be an aggregation time period, as specified above in Equation (24). With reference to FIG. 2, data provider 152 accesses subject record database 154 and retrieves the data values for subject record n, for concept c that fall within the time period specified by TAggr. In procedure of 606, the retrieved data is extrapolated within the specified time period. The extrapolation may be executed according to a knowledge-based temporal interpolation function which is specific to the abstract concept for which a delegate value is to be determined. The extrapolation may also include concatenating the extrapolated values of the data with the original values of the retrieved data. It is noted that the extrapolation is executed only on data within the specified time period. Therefore, if the retrieved data has a duration which exceeds the duration specified by the specified time period, then only the portion of the retrieved data within the specified time period is extrapolated. With reference to FIG. 8B, first value 532 (FIG. 8B) is extrapolated to include extrapolated first value 532′ (FIG. 8B), second value 534 (FIG. 8B) is extrapolated to include extrapolated second value 534′ (FIG. 8B) and extrapolated second value 534″ (FIG. 8B), third value 536 (FIG. 8B) is extrapolated to include extrapolated third value 536′ (FIG. 8B) and extrapolated third value 536″ (FIG. 8B), fourth value 538 (FIG. 8B) is extrapolated to include extrapolated fourth value 538′ (FIG. 8B) and extrapolated fourth value 538″ (FIG. 8B), and fifth value 540 (FIG. 8B) is extrapolated to include extrapolated fifth value 540′ (FIG. 8B).

In procedure 608, the extrapolated retrieved data within the specified time period is segmented. With reference to FIG. 8C, once each of the values shown has been extrapolated, the value and its respective extrapolated section or sections are concatenated and segmented according to the aggregation time period specified by user 142 (FIG. 2). The part of first value 532 (FIG. 8C) which falls within TOverall and extrapolated first value 532′ (FIG. 8C) are concatenated and segmented into a modified first value 542 (FIG. 8C). In procedure 610, a specified function, such as a specified delegate function, is applied to the segmented retrieved data, thereby determining a delegate value for the abstract concept. It is noted that the specified function can be a specific delegate function for aggregating values of an abstract concept, such as a maximal cumulative duration delegate function or a maximal value-time period delegate function. With reference to FIGS. 2 and 8C, data provider 152 (FIG. 2) uses Equations (25) or (32), to determine the specified delegate value or values, except that specific delegate functions are used to aggregate the values within the particular time period. The modified values required for the specific delegate functions may be determined by data provider 152 (FIG. 2) or explorer 148 (FIG. 2) which are then used to determine the specified delegate value or specified series of delegate values. It is noted that method 600 can be used to determine a single delegate value for an abstract concept for a single subject record or for a population of subject records, depending on how many subject records are accessed in procedure 602.

Reference is now made to FIG. 9D, which is a schematic illustration of a method for determining a plurality of delegate values for an abstract concept, generally referenced 620, operative in accordance with another embodiment of the disclosed technique. In procedure 622, at least one subject record in a database of subject records is accessed for which a plurality of delegate values of an abstract concept is to be determined. With reference to FIG. 2, based on at least one constraint specified by constraint specifier 146 (FIG. 2), data provider 152 (FIG. 2) accesses at least one subject record in subject record database 154 (FIG. 2) for a specified abstract concept. In procedure 624, the data stored in the at least one subject record for the abstract concept to be determined, having a time-stamp within a specified overall time period, is retrieved. The specified overall time period may be an overall aggregation time period, as specified above in Equation (26). With reference to FIG. 2, data provider 152 accesses subject record database 154 and retrieves the data values for subject record n, for concept c that fall within the time period specified by TOverall. In procedure 626, a plurality of granularity aggregations is determined. Each granularity aggregation represents an aggregation time period within the specified overall time period at a specified granularity. Each granularity aggregation can be specified as shown above in Equations (27), (30) and (31). With reference to FIG. 2, data provider 152 is provided with a number of constraints from constraint specifier 146 as follows: the subject record to be accessed, denoted as subject record n, the concept for which a delegate value is to be determined, denoted as concept c, the delegate function to be used to aggregate the data into a series of values, denoted as DF_{c}, the overall time period over which the data for the concept is to be aggregated into a series of values, denoted as TOverall (i.e., an overall aggregation time period) and the granularity, or the specific time period at which each delegate value of the series of delegate values is to be determined at, denoted as TGran.

In procedure of 628, the retrieved data is extrapolated within the specified overall time period. The extrapolation may be executed according to a knowledge-based temporal interpolation function which is specific to the abstract concept for which a plurality of delegate values is to be determined. The extrapolation may also include concatenating the extrapolated values of the data with the original values of the retrieved data. It is noted that the extrapolation is executed only on data within the specified time period. With reference to FIG. 8B, first value 532 (FIG. 8B) is extrapolated to include extrapolated first value 532′ (FIG. 8B), second value 534 (FIG. 8B) is extrapolated to include extrapolated second value 534′ (FIG. 8B) and extrapolated second value 534″ (FIG. 8B), third value 536 (FIG. 8B) is extrapolated to include extrapolated third value 536′ (FIG. 8B) and extrapolated third value 536″ (FIG. 8B), fourth value 538 (FIG. 8B) is extrapolated to include extrapolated fourth value 538′ (FIG. 8B) and extrapolated fourth value 538″ (FIG. 8B), and fifth value 540 (FIG. 8B) is extrapolated to include extrapolated fifth value 540′ (FIG. 8B). In procedure 630, the extrapolated retrieved data is segmented according to each one of the plurality of granularity aggregations determined in procedure 626. With reference to FIG. 8C, once each of the values shown has been extrapolated, the value and its respective extrapolated section or sections are concatenated and segmented according to each aggregation time period TGran as specified by user 142 (FIG. 2). The part of first value 532 (FIG. 8C) which falls within TOverall and extrapolated first value 532′ (FIG. 8C) are concatenated and segmented into a modified first value 542 (FIG. 8C). Third value 536 (FIG. 8C), extrapolated third value 536′ (FIG. 8C) and extrapolated third value 536″ (FIG. 8C) are concatenated and segmented into three modified third values, modified third value 546A (FIG. 8C), modified third value 546B (FIG. 8C) and modified third value 546C (FIG. 8C). Each of the three modified third values is segmented according to a particular one of the aggregation time periods. In procedure 632, for each granularity aggregation, a specified function, such as a specified delegate function, is applied to the segmented retrieved data within its respective granularity aggregation, thereby determining a plurality of delegate values for the abstract concept. It is noted that the specified function can be a specific delegate function for aggregating values of an abstract concept, such as a maximal cumulative duration delegate function or a maximal value-time period delegate function. With reference to FIGS. 2 and 8C, data provider 152 (FIG. 2) uses Equations (28) or (33), to determine the specified delegate value or values, except that specific delegate functions are used to aggregate the values within the particular time period. The modified values required for the specific delegate functions may be determined by data provider 152 (FIG. 2) or explorer 148 (FIG. 2) which are then used to determine the specified delegate value or specified series of delegate values. It is noted that method 620 can be used to determine a plurality delegate values, such as a series of delegate values, for an abstract concept for a single subject record or for a population of subject records, depending on how many subject records are accessed in procedure 622.

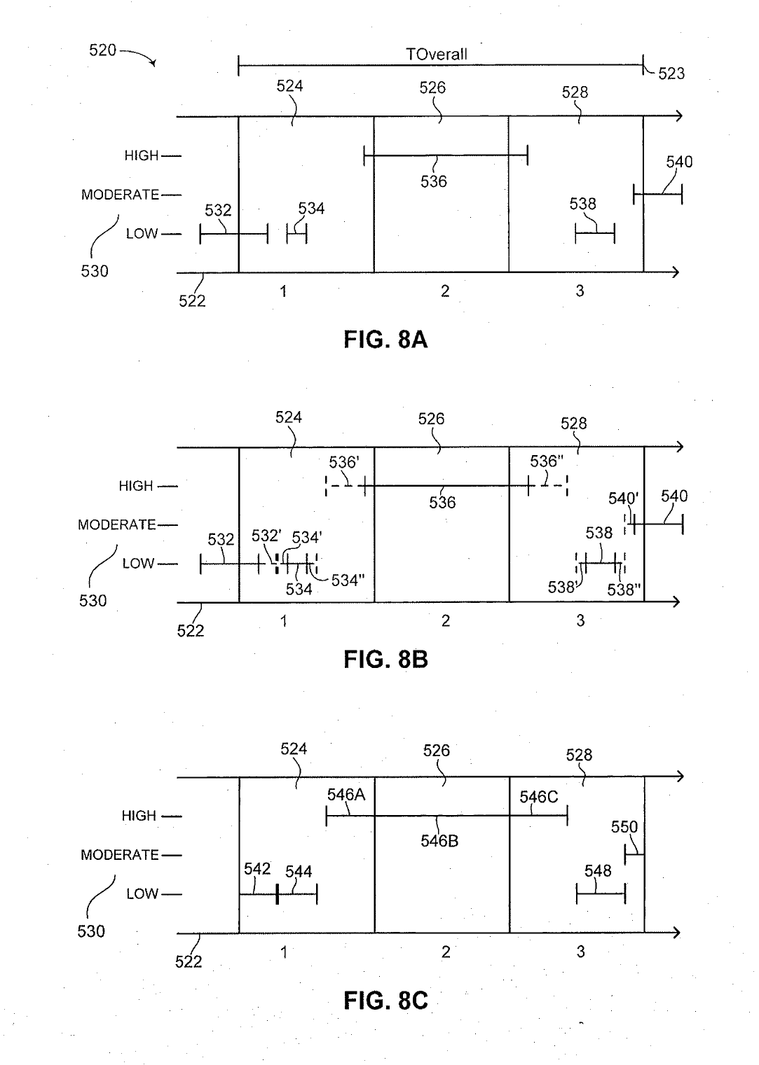

Reference is now made to FIG. 10, which is a schematic illustration of the explorer of FIG. 2, generally referenced 650, constructed and operative in accordance with a further embodiment of the disclosed technique. FIG. 10 shows explorer 148 (as shown in FIG. 2). Explorer 148 includes a computation manager 652 and a display manager 654. As mentioned above in the description of FIG. 2, explorer 148 represents a GUI for visualizing, manipulating and exploring the requested data. In general, the requested data is initially visualized in explorer 148 as a list depending on whether the user 142 (FIG. 2) requested subject records to be returned (displayed as a list of subject record IDs), time intervals in the data of subject records to be returned (displayed at a list of time intervals) or data in the subject records to be returned (displayed as a list of the requested data). If data in the subject records is returned, then explorer can subsequently display the data in a type of graph, when can then be explored and manipulated. As described below, computation manager 652 and display manager 654 substantially manage the visualization, manipulation and exploration of the requested data, in particular when user 142 requested that data in the subject records specified be returned. As mentioned above, when requested data is displayed according to the disclosed technique, the data is displayed on a 2D graph, with the horizontal axis representing the time and the vertical axis representing the value of the data displayed in its respective units, since the data which is displayed is in general time-oriented.

Computation manager 652 stores parameters related to the data to be displayed. Recall that based on specified constraints by user 142, data provider 152 (FIG. 2) retrieves and/or determines the requested data, which is then provided to explorer 148. Computation manager 652 receives the data retrieved from data provider 152 and stores certain parameters of the data, including parameters related to the constraints specified which resulted in the respective data being retrieved. These parameters, as described below simplify computations regarding how the requested data is to be visualized and also simplify the computations required for manipulating and exploring the visualized data. Recall that the data to be displayed substantially represents a concept defined in the KB. In the case that the data retrieved represents a raw concept for a single subject record, then computation manager 652 stores parameters relating to the data having the following data structure:

<Concept_{c},InputData*,Gran_{aggr},DF_{c}>, 1≦c≦C (34)

where concept c represents the name of the concept of the retrieved data to be displayed. C represents the total number of concepts defined in the KB. InputData* was defined above in Equation (23) and represents the original data retrieved from subject record database 154 (FIG. 2) by data provider 152, which is used to determine a delegate value. It is noted that InputData* represents data retrieved from subject record database 154 based on a retrieve subject record expression, as shown above in FIG. 4A. In general, each data point displayed in a graph in explorer 148 is displayed as a delegate value even if the delegate value is at the same granularity as the raw data values stored in InputData*. In other words, each delegate value can represent at least one single raw data value. Explorer 148 may include GUI controls which enable a user to specify certain parameters regarding how retrieved data is to be displayed. Two of these parameters include Gran_{aggr} and DF_{c}. As all data points displayed in explorer 148 are substantially delegate values, Gran_{aggr} represents the granularity at which data points are to be displayed in explorer 148 as a graph and DF_{c} represents the delegate function, specific to concept c, which should be used to determine the delegate value or delegate values for the subject record specified in InputData* at the granularity level of Gran_{aggr}. Gran_{aggr} can be any granularity specified according to the first requirement mentioned above regarding constraint specifier 146 (FIG. 2). In the case that user 142 did not request that data be retrieved, in other words, only subject records should be retrieved, or time intervals in the data of subject records should be retrieved, then nothing is stored in computation manager 652. For example, Gran_{aggr} may be specified as ‘day’ and DF_{c} may be the mean, i.e., the user wants to display and explore the data values stored in InputData* for concept c at a granularity of days, where the delegate value representing concept c is aggregated into a single value for each day using the mean. As another example, Gran_{aggr} may be ‘month’ and DF_{c} may be the maximum value, i.e., the user wants to display and explore the data values stored in InputData* concept c at a granularity of months, where the delegate value representing concept c is aggregated at one delegate value per month, using the maximum value each month. As described below, depending on length of the time period which a user may want to explore in the data values stored in InputData* and the Gran_{aggr} the user chooses, a single delegate value or a series of delegate values may be displayed. Also, as described below regarding the exploration of the retrieved data, based on the data structure shown in Equation (34), computation manager 652 can also determine delegate values for concept c. Furthermore, as described below, for exploring the data values stored for a concept c, for subject record n, denoted as Mₙ above, the data values may be aggregated using a delegate function specific to concept c and to Gran_{aggr}. For example, if a concept c has several data values stored per day, then when the data values are displayed for exploration, at a granularity level of days, the maximum value per day may be displayed since a delegate function of maximum was used to aggregate the values.

Display manager 654 controls the delegate values which are displayed in explorer 148. Similar to computation manager 652, in the case that the delegate values to be displayed and explored are determined from a raw concept for a single subject record, display manager 654 stores parameters related to the retrieved data having the following data structure:

<Concept_{c},DelegateValues*,TStartₑₓₚₗₒᵣ,TEndₑₓₚₗₒᵣ,Granₑₓₚₗₒᵣ,[RefPos]>1≦c≦C (35)

where C represents the total number of concepts in the KB. DelegateValues* represents a set of delegate values determined for concept c by computation manager 652 at a granularity level specified by Gran_{aggr} using DF_{c}, as shown above in Equation (34). The determined delegate values may be stored in computation manager 652. It is noted that even though delegate values were determined by data provider 152 in response to expressions provided to it by constraint specifier 146, computation manager 652 also determines delegate values. The determination of delegate values by data provider 152 and computation manager 652 serve different purposes and as such are determined separately. Data provider 152 determines delegate values in response to expressions provided to it by constraint specifier 146. Computation manager 652 determines delegate values in order to display retrieved data visually to user 142. TStartₑₓₚₗₒᵣ and TEndₑₓₚₗₒᵣ represent the time period which is to be displayed to user 142 in a window, for displaying the values stored in DelegateValues* for specified subject records. It is noted that depending on the selected time period, none of the values stored in DelegateValues* may be displayed. Granₑₓₚₗₒᵣ represents the granularity level, i.e., time scale, on which the time axis of the 2D visualization of the delegate values is presented to the user. As mentioned above, Gran_{aggr} represents the granularity at which the delegate values displayed are determined, whereas Granₑₓₚₗₒᵣ represents the time scale on which such delegate values are displayed. It is noted that Gran_{aggr}≦Granₑₓₚₗₒᵣ. For example, if Gran_{aggr} is days and Granₑₓₚₗₒᵣ is months, then the delegate values displayed will be displayed at a granularity (i.e., resolution) of days, whereas the scale on which such delegate values are displayed will only display months. In this example, a series of delegate values will be displayed. In such a visualization, for each month displayed on the horizontal axis, a plurality of delegate values may be displayed since each delegate value represents a delegate value for a particular day. Using the above example, if Gran_{aggr} were equal to Granₑₓₚₗₒᵣ, then for each month displayed on the horizontal axis, a single delegate value would be displayed per month, as the delegate values of a concept c would be aggregated into a delegate value at a granularity aggregation (i.e., Gran_{aggr}) of months. In this example, if TStartₑₓₚₗₒᵣ and TEndₑₓₚₗₒᵣ represented a time period of exactly a month, then a single delegate value would be displayed. [RefPos] represents an optional parameter that defines a particular or significant event related to the context of concept c when a relative timeline is used for the horizontal axis.

In the case that the delegate values to be displayed and explored are determined from a raw concept for a plurality (i.e, a population) of subject records, the data structure stored by computation manager 652 has the following structure:

<Concept_{c},InputData*,Gran_{aggr},PDF_{c}>, 1≦c≦C (36)

Equation (36) is similar to Equation (34), except that PDF_{c} represents the delegate function, specific to concept c, which should be used to determine the delegate value or delegate values for a population of subject records specified in InputData* at the granularity level of Gran_{aggr}. The data structure stored by display manager 654 has the following structure:

<Concept_{c},PopulationDelegateValues*,TStartₑₓₚₗₒᵣ,TEndₑₓₚₗₒᵣ,Granₑₓₚₗₒᵣ,[RefPos]>, 1≦c≦C (37)

Equation (37) is similar to Equation (35), except that PopulationDelegateValues* represents a set of delegate values determined for concept c by computation manager 652 for a population of subject records at a granularity level specified by Gran_{aggr} using PDF_{c}, as shown above in Equation (36). As shown below in FIGS. 11A and 11B, delegate values can be displayed in a window of a GUI. Such a window may include a plurality of panels for displaying different sets of determined delegate values. Granₑₓₚₗₒᵣ represents the granularity on which all delegate values in a given panel are displayed on. According to one embodiment of the disclosed technique, Granₑₓₚₗₒᵣ is the same for all panels displayed in the window of the GUI. According to another embodiment of the disclosed technique, Granₑₓₚₗₒᵣ is different for the panels displayed in the window of the GUI. It is noted that for a given panel, if delegate values representing individual subject records as well as a population of subject records are displayed together, then TStartₑₓₚₗₒᵣ, TEndₑₓₚₗₒᵣ and Granₑₓₚₗₒᵣ used in Equations (35) and (37) above are respectively stored as being substantially the same in display manager 654.

Reference is now made to FIG. 11A, which is an illustration showing an example of the visualization of delegate values determined from raw data values, generally referenced 670, constructed and operative in accordance with another embodiment of the disclosed technique. As mentioned above, explorer 148 can be embodied as a GUI in one embodiment. An example of such a 670 GUI for visualizing delegate values determined from raw data values is shown in FIG. 11A. GUI 670 shows the visualization of delegate values determined from raw data concepts for a plurality of subject records in the medical research domain, using a line plot visualization technique. GUI 670 includes a horizontal axis 672, a vertical axis 674, a display panel 673, data points 676 and value statistics section 688. Horizontal axis 672 represents time at a granularity of months, i.e., Granₑₓₚₗₒᵣ in GUI 670 is defined in display manager 654 (FIG. 10) as months. Vertical axis 674 represents the value of the data concept displayed. In GUI 670, the raw data concept displayed is the red blood cell (herein abbreviated RBC) count, with vertical axis 674 representing the units of that concept. In GUI 670, three different types of data can be displayed, as described above in FIG. 2. Display panel 673 represents the area in which a 2D graph of the delegate values of the raw data concept can be displayed. As mentioned above, a window for visualizing delegate values determined from retrieved data values may include a plurality of panels. In display panel 673, data points 676 are plotted, which represent one type of data displayed in GUI 670. Each data point 676 represents a delegate value representing a measure of the RBC count of a subject record at a particular time according to Gran_{aggr}. In other words, the x-coordinate of a data point 676 represents the time corresponding to a delegate value at a granularity of Gran_{aggr}. In FIG. 11A, Gran_{aggr} is at the same granularity as the raw data values which were used to determine the delegate values displayed as data points 676. Therefore, in this example, the x-coordinate also represents the time-stamp of the actual RBC counts and the Y-coordinate of a data point 676 represents the actual value of the RBC count, even though the value displayed as a data point 676 is a delegate value. In display panel 673, the delegate values for the RBC counts for 58 subject records is displayed, with each subject record having a plurality of delegate value points, determined for different times, for the RBC count raw concept. It is noted that Gran_{aggr} for data points 676 is seconds, meaning that each data point 676 displayed in display panel 673 has an x-coordinate measured in seconds. This is not equal to Granₑₓₚₗₒᵣ, which in GUI 670 is equal to months. It is also noted that the 58 subject records displayed may have been specified earlier using constraint specifier 146 (FIG. 2), by specifying a select subject record expression 194 (FIG. 4A). By placing a cursor (not shown) over a particular data point (such as a data point 685), a tooltip box 684 may be displayed, showing various parameters regarding the raw data point, such as the ID number of the subject record to which the raw data point comes from (e.g., ‘patientID=703’ as in the figure), the x-coordinate of the raw data point (e.g., ‘01-11-1996 14:45:00 (Thu)’ as in the figure) and the y-coordinate of the raw data point (e.g., ‘4.5200 units:Unknown’ as in the figure). It is noted that in tooltip box 684 it can be seen that the raw data points which are displayed in display panel 673 are displayed at a granularity of seconds, i.e., the delegate value representing the measurement of the RBC count for the subject record with ID 703, was determined for an aggregation period of 1 second having a time stamp of Jan. 11, 1996 at 14 hours (2 p.m.), 45 minutes and 0 seconds, having a value of 4.5200. In GUI 670, April 1995 represents TStartₑₓₚₗₒᵣ and March 1996 represents TEndₑₓₚₗₒᵣ, as per Equations (35) and (37) above.

As can be seen in GUI 670 between April 1995 and August 1995, representing a plurality of time-stamped delegate values for a plurality of subject records can generate a graph which includes a substantial amount of clutter and for which it may be difficult to discern a pattern or trend. As such, a second type of data is displayed in GUI 670 which relates to time-oriented delegate values regarding the raw data points of the entire population of subject records displayed. In display panel 673, as an example, three other different types delegate values, referred to as population delegate values, are determined for the population of subject records displayed, each different type of population delegate value being determined using a different delegate function, at a granularity defined by Gran_{aggr}, which in this example for all these population delegate values is months. The first type of population delegate value determined is a delegate value, per month, for all the raw data points stored in InputData* for each month, using a delegate function of maximum value. An example of such a population delegate value is a delegate value data point 690. Delegate value data point 690 represents the delegate value for the population of raw data points of the subject records for the month of August 1995. Delegate value data point 690 was determined using the delegate function maximum value. In other words, for each month, the maximum value of the RBC count for the entire population was determined as the delegate value for that month. It is noted that delegate value data point 690 can also be a data point 676. In GUI 670, the maximum value delegate values for each month are connected by a line 678. It is noted that data point 685 represents the delegate value data point for the month of January 1996, determined using the delegate function maximum value. As such, in tooltip box 684, the parameter ‘RBC-max’ is also displayed as data point 685, which is a delegate value displayed at a Gran_{aggr} of seconds, happens to also be the maximum value data point for the granularity level at which the maximum value data points in display panel 673 are determined at (i.e., Gran_{aggr} at a granularity of months).

The second type of population delegate value determined for the entire population is a delegate value, per month, for all the data points displayed each month, using a delegate function of minimum value. An example of such a population delegate value is a delegate value data point 692. Delegate value data point 692 represents the delegate value for the population of raw data points of the subject records stored in InputData* for the month of October 1995. Delegate value data point 692 was determined using the delegate function minimum value at a Gran_{aggr} of months. In other words, for each month, the minimum value of the RBC count for the entire population of raw data stored in a DB was determined as the delegate value for that month. It is noted that delegate value data point 692 is a data point 676. In GUI 670, the minimum value delegate values for each month are connected by a line 680. The third type of population delegate value determined for the entire population is a delegate value, per month, for all the raw data points stored in InputData* for each month, using a delegate function of mean value. An example of such a delegate value is a delegate value data point 686. Delegate value data point 686 represents the delegate value for the population of raw data of the subject records stored for the month of February 1996. Delegate value data point 686 was determined using the delegate function mean value. In other words, for each month, the mean value of the RBC count for the entire population of raw data stored in InputData* was determined as the delegate value for that month. It is noted that delegate value data point 686 does not correspond to a delegate value determined at a Gran_{aggr} of seconds (such as delegate value points 690 and 692) but to a data point at a Gran_{aggr} of months which was determined using the delegate function mean value. In GUI 670, the mean value delegate values for each month are connected by a line 682.

It is noted that for each month, three different types of population delegate values were determined per month for the values of the raw data concept RBC count for a population of subject records. In GUI 670, the delegate values of a particular type were connected by a line. In another embodiment of the disclosed technique, the population delegate values of a particular type are not connected by a line. Also, the granularity at which each delegate function (e.g., maximum value, minimum value and mean value) was applied in GUI 670 was equivalent, i.e., months. It is noted that in another embodiment of the disclosed technique, the granularity at which each delegate function was applied in GUI 670 could be different. For example, the maximum and minimum value delegate functions may be applied at a granularity of months, whereas the mean value delegate function may be applied at a granularity of years. It is also noted that the delegate values displayed in GUI 670 were determined by computation manager 652 (FIG. 10) and displayed accordingly by display manager 654 (FIG. 10). In general, a user substantially begins exploring time-oriented data of a plurality of subject records by first requesting from explorer 148 (FIGS. 2 and 10) that delegate values representing the raw data points of a concept stored in a subject record or in subject records in a database be plotted. Then, using computation manager 652 and display manager 654, the user can explore the delegate values shown by requesting that various other types of delegate values be determined and visualized, i.e., plotted, for the initial delegate value data points, to determine patterns or trends, i.e., new knowledge, from the data values stored in the plurality of subject records. It is known to the worker skilled in the art that GUI buttons and menus and the like (not shown) are provided for in GUI 670 for enabling a user to specify what types of other delegate values, using which type of delegate function, should be determined for the delegate value data points displayed.

In GUI 670, a third type of data is displayed which represents statistical values which relate to all the delegate value data points of the subject records currently displayed. This type of data is displayed numerically and graphically. This data is displayed numerically in value statistics section 688, which displays the maximum value, minimum value, average value and standard deviation of all the data points 676 displayed in panel 673. Value statistics section 688 also displays TStartₑₓₚₗₒᵣ and TEndₑₓₚₗₒᵣ, shown in the figure as S: 30-03-95 (TStarₑₓₚₗₒᵣ) and E:24-03-96 (TEndₑₓₚₗₒᵣ). It is noted that other statistical values can be displayed in value statistics section 688. A portion of the data displayed in value statistics section 688 is displayed graphically in display panel 673. For example, the average (i.e., mean) RBC count of 3.36 is displayed as a dotted line 696, and the average RBC count plus-minus (±) its standard deviation is displayed as dotted lines 694 in display panel 673. It is noted that other statistical values can be displayed graphically in display panel 673. It is also noted that the statistical values displayed numerically and graphically relate to the data points currently displayed in display panel 673, in the specified time period of TStartₑₓₚₗₒᵣ to TEndₑₓₚₗₒᵣ. If either one of TStartₑₓₚₗₒᵣ or TEndₑₓₚₗₒᵣ is modified, then the statistical values displayed in value statistics section 688 and graphically shown in display panel 673 need to be recalculated and updated in GUI 670. Such recalculations can be executed by display manager 654.

Reference is now made back to FIG. 10. In the case that the data retrieved represents an abstract concept for a single subject record, then computation manager 652 stores parameters relating to the data having the following data structure:

<Concept_{c},InputData*,Gran_{aggr},DF_{c}>, 1≦c≦C (38)

Equation (38) is substantially similar to Equation (34). In the case that the data retrieved is for a plurality (i.e, a population) of subject records, then DF_{c} is Equation (38) is replaced by PDF_{c}, as shown above in Equation (36), where PDF_{c} represents the delegate function, specific to concept c, which should be used to determine the delegate value for a population of subject records specified in InputData* at the granularity level of Gran_{aggr}. As shown, and described below in FIG. 11B, data stored for abstract concepts is displayed in explorer 148 on a symbolic ordinal scale as a proportional distribution, since the scale used to store abstracted data is a discrete value scale. As such, display manager 654 stores parameters related to the retrieved data having a data structure which differs from Equations (35) and (37). The data structure stored by display manager 654 can be defined formally as:

<Concept_{c},Distribution*,TStartₑₓₚₗₒᵣ,TEndₑₓₚₗₒᵣ,Granₑₓₚₗₒᵣ,[RefPos]>1≦c≦C (39)

where C represents the total number of concepts in the KB and Granₑₓₚₗₒᵣ represents the granularity level, i.e., time scale, on which the time axis of the 2D visualization of the data is presented to the user. TStartₑₓₚₗₒᵣ and TEndₑₓₚₗₒᵣ represent the time period which is to be displayed to user 142 in a window, for displaying the values stored in Distribution* for specified subject records. It is noted that depending on the selected time period, none of the values stored in Distribution* may be displayed. [RefPos] represents an optional parameter than defines a particular or significant event related to the context of concept c when a relative timeline is used for the horizontal axis. Distribution* represents a data structure having the form:

$$\begin{matrix}{( {value}_{c}^{1} , {proportion}_{c}^{1} )}_{1} & Λ & {( {value}_{c}^{t} , {proportion}_{c}^{t} )}_{1} & Λ & {( {value}_{c}^{T} , {proportion}_{c}^{T} )}_{1} \\ M & O & & & M \\ {( {value}_{c}^{1} , {proportion}_{c}^{1} )}_{j} & & {( {value}_{c}^{t} , {proportion}_{c}^{t} )}_{j} & & {( {value}_{c}^{T} , {proportion}_{c}^{T} )}_{j} \\ M & & & O & M \\ {( {value}_{c}^{1} , {proportion}_{c}^{1} )}_{J} & Λ & {( {value}_{c}^{t} , {proportion}_{c}^{t} )}_{J} & Λ & {( {value}_{c}^{T} , {proportion}_{c}^{T} )}_{J} \\ & 1 \leq t \leq T , 1 \leq j \leq J & & & \end{matrix} \qquad ( 40 )$$

where value_{c}^{t} represents the t^{th} symbolic ordinal value for concept c, and T represents the total number of symbolic ordinal values on the discrete value scale used for storing concept c, which in Equation (40) is an abstract concept. It is noted that T is a finite number. For example, in the medical research domain, if concept c represents an abstract concept such as ‘susceptibility to anemia,’ with values measured for this concept being measured on a discrete value scale having the following values: ‘negligible,’ ‘low,’ ‘moderate’ and ‘high’ then T would be 4. The following would then be the mapping between the discrete value scale and a symbolic ordinal scale: 1=negligible, 2=low, 3=moderate and 4=high. J represents the total number of time periods for which data is to be displayed at the granularity level specified by Gran_{aggr}, in the overall time period defined by TStartₑₓₚₗₒᵣ and TEndₑₓₚₗₒᵣ. For example, in the medical research domain, if Gran_{aggr} is days and [RefPos] is defined as a bone marrow transplant (i.e, a relative timeline is used for the horizontal axis, with the zero position representing a bone marrow transplant procedure), and TStartₑₓₚₗₒᵣ is defined as 3 days (i.e., 3 days after a bone marrow transplant) and TEndₑₓₚₗₒᵣ is defined as 20 days (i.e., 20 days after a bone marrow transplant), then J would represent 18, as 18 different time periods, with each time period equaling a day, are to be displayed in explorer 148. proportion_{c}^{t} represents the proportion of measurements, as a percent, stored for concept c having a value equal to valued for a given time period j. Using a type of bar chart, (value_{c}^{t}, proportion_{c}^{t})ⱼ is displayed in explorer 148 with j representing the time component (i.e., horizontal axis component) of value_{c}^{t}, and value_{c}^{t} and proportion_{c}^{t} representing the value component (i.e., vertical axis component), as described below in FIG. 11B.

It is noted that in Equation (40), value_{c}^{t} represents a delegate value and does not represent a raw data value which may be stored in InputData* as in Equation (38) above, even though value_{c}^{t} may correspond to such a raw data value. Computation manager 652 determines the delegate value or delegate values to be stored in Distribution* (which is substantially in display manager 654) using the DF_{c} of Equation (38) at the granularity specified by Gran_{aggr}. It is noted that in general, Granₑₓₚₗₒᵣ can affect Gran_{aggr}. If Gran_{aggr} equals Granₑₓₚₗₒᵣ, then one time period j will be displayed in explorer 148, representing a single delegate value as determined by computation manager 652. If Granₑₓₚₗₒᵣ is greater than Gran_{aggr}, then each time period j displayed in explorer 148 will display the distribution of a series of delegate values as determined by computation manager 652. This is explained in FIG. 11B. It is also noted that in the case where abstracted data from a plurality of subject records is to be displayed, and PDF_{c} replaces DF_{c} in Equation (38), Equations (39) and (40) remain unchanged. In such a case, proportion_{c}^{t} would represent the percent of the plurality of subject records having a value equal to value_{c}^{t}.

Reference is now made to FIG. 11B, which is an illustration showing an example of the visualization of abstracted data values, generally referenced 720, constructed and operative in accordance with a further embodiment of the disclosed technique. As mentioned above, explorer 148 can be embodied as a GUI in one embodiment. An example of such a 720 GUI for visualizing abstracted data values is shown in FIG. 11B. GUI 720 shows the visualization of abstracted data concepts for a plurality of subject records in the medical research domain, using a modified bar chart visualization technique. GUI 720 includes a horizontal axis 722, an external symbolic ordinal scale vertical axis 724, an internal percentage scale vertical axis 726, a display panel 728 and bar distributions 730A, 730B, 730C and 730D. Horizontal axis 722 represents time at a granularity of months, i.e., Granₑₓₚₗₒᵣ in GUI 720 is defined in display manager 654 (FIG. 10) as months. Two vertical axes are displayed in GUI 720. External symbolic ordinal scale vertical axis 724 represents the discrete value scale for the concept displayed. In GUI 720, the data displayed is for the abstract concept PLATELET_STATE_BMT (i.e., the general amount of platelets in the blood after a bone marrow transplant), for 58 subject records. External symbolic ordinal scale vertical axis 724 therefore shows the possible values for such a concept, which are ‘very_low,’ ‘low,’ ‘moderately_low,’ ‘normal’ and ‘high.’ In this example, T in Equation (40) would be equal to 5, as five discrete values are defined for the abstract concept PLATELET_STATE_BMT. Also, in Equation (40), the parameter value_{c}^{t} represents the possible values for the abstract concept PLATELET_STATE_BMT. For each discrete value on external symbolic ordinal scale vertical axis 724, an internal percentage scale vertical axis 726, ranging from 0% to 100%, is also provided. This scale represents the proportion, i.e., distribution, of subject records which have stored for concept c a given discrete value. Together external symbolic ordinal scale vertical axis 724 and internal percentage scale vertical axis 726 represent a modified bar chart visualization technique, which may substantially enable user 142 (FIG. 2) to discover trends in the distribution of abstracted data of a plurality of subject records over time.

For example, bar distributions 730A, 730B, 730C and 730D represent the distribution of values of the subject record data retrieved for the concept PLATELET_STATE_BMT for the month of February 1995. Each of bar distributions 730A, 730B, 730C and 730D represent a delegate value. Bar distribution 730A shows that approximately 40% of the subject records had a value of ‘normal’ stored for the concept PLATELET_STATE_BMT in the month of February 1995. Bar distribution 730B shows that approximately 12% of the subject records had a value of ‘moderately_low’ stored for the concept PLATELET_STATE_BMT in the month of February 1995. Bar distribution 730C shows that approximately 40% of the subject records had a value of ‘low’ stored for the concept PLATELET_STATE_BMT in the month of February 1995. And bar distribution 730D shows that approximately 8% of the subject records had a value of ‘very_low’ stored for the concept PLATELET_STATE_BMT in the month of February 1995. It is noted that 0% of the subject records had a value of ‘high’ stored for the concept PLATELET_STATE_BMT in the month of February 1995. In this example, ‘very_low,’ ‘low,’ ‘moderately_low’ and ‘high’ represents the possible parameters for value_{c}^{t} in Equation (40), whereas the percentages 8%, 40%, 12%, 40% and 0%, represent, respectively, the proportion_{c}^{t} parameter for a given value. j in this example represents February 1995, with Granₑₓₚₗₒᵣ representing months, TStartₑₓₚₗₒᵣ being December 1994 and TEndₑₓₚₗₒᵣ being December 1995. It is noted that Gran_{aggr} in this example also represents months, which means that each bar distribution in display panel 728 represents the percentage of subject records whose delegate value for a given month is equal to a given discrete value on external symbolic ordinal scale vertical axis 724. Since PLATELET_STATE_BMT is an abstract concept, the delegate value determined for each subject record may be derived from abstracted data stored for each subject record. In addition, the distribution value (i.e., percentage value) for a given month does not represent the percentage of all subject records, but rather the percentage of subject records who have a delegate value determined for a given month. For example, a dotted rectangle 732 shows the distribution of values for the concept PLATELET_STATE_BMT in the month of May 1995. By placing a cursor (not shown) over one of the bar distributions for that month, a tooltip box 734 may be displayed. The tooltip box shows various parameters for the bar distribution of the symbolic ordinal value ‘low’ for the month of May 1995. Shown in tooltip box 734 is the concept ‘PLATELET_STATE_BMT,’ the specific discrete value for that bar distribution, which is ‘low,’ as well as the start time and end time for the time period of the bar distribution, which is from midnight (00:00:00) of Monday, May 1, 1995 until 11:59 p.m. and 59 seconds (23:59:59) of Wednesday, May 31, 1995. Tooltip box 734 also shows the percentage of subject records in May 1995 which had a delegate value of ‘low’ stored for the shown concept, which is 43.5%. In brackets, the percentage is shown as the actual number of subject records, here 7, having such a delegate value as well as the actual number of subject records, here 16, which have a delegate value stored for the shown concept in May 1995. In other words, 43.5% does not represent a percentage of all 58 subject records, but rather a percentage of the subject records (16 in total) which have sufficient data stored for the month of May 1995 to determine a delegate value for the month.

Reference is now made back to FIG. 10. As mentioned above, computation manager 652 and display manager 654 store certain parameters of the data retrieved from data provider 152, including parameters related to the constraints specified in constraint specifier 146 (FIG. 2), which resulted in the respective data being retrieved. Using these parameters, as well as parameters specified by the user, display manager 654 can display the data retrieved, such as in the case where explorer 148 is embodied as a GUI. These parameters also enable various computations for manipulating and exploring the visualized data. Below, operators for manipulating and exploring the visualized data are described. In general, such operators represent modifications of the parameters stored in either computation manager 652, display manager 654 or both, as specified by a user. Each operator can be specified according to its input data, which are the parameters which are to be provided to computation manager 652, display manager 654 or both, at least one specified determination, which modifies the input data provided and its output data, which represents the modified parameters stored in computation manager 652, display manager 654 or both after the at least one specified determination. Explorer 148 enables three different types of data to be explored and manipulated which are displayed using display manager 654, for example as shown above in FIGS. 11A and 11B.

The first type of data which can be explored is delegate values which corresponds to raw data values stored in InputData*, for example data points 676 (FIG. 11A). Recall that raw data values which are displayed as delegate values represent data values for raw concepts which are time-oriented, i.e., measurements of values without any specific context of interpretation but which have a time-stamp. In the medical research domain, raw data values could be the values of a white blood cell count, a cholesterol level test, a urine specific gravity test, a bilirubin count and the like. In the information security domain, raw data values could be the values representing the number of hacker threats detected by a firewall software program each day, the number of registry value changes in a specific time period, the amount of RAM memory used by a computer workstation each hour and the like. Recall that raw data values can represent data values for a single subject record or for a plurality of subject records. The second type of data which can be explored is statistical values determined for a plurality of raw data values. The plurality of raw data values may be for a single subject record or for a plurality of subject records. Examples of such in FIG. 11A include delegate value data points 686, 690 and 692 (all from FIG. 11A) which represent population delegate values. In this respect, the second type of data represents a delegate value determined for a plurality of raw data values, such as a maximum monthly value for a hemoglobin count or a mean yearly value for the amount of RAM usage. The third type of data which can be explored is data values representing abstract concepts, such as bar distributions 730A, 730B, 730C and 730D (all from FIG. 11B). In general, such data values represent data values derived from abstracted data values and interpreted in a specific context using a knowledge base, such as domain knowledge base 156 (FIG. 2). As described below, the at least one specified determination used by a particular operator as well as the output data generated depends on the type of data which is being explored and modified.

Recall that data displayed in explorer 148 is displayed as a 2D graph in a window. A first operator enabled by explorer 148 is a temporal exploration operator. This operator enables a user to use explorer 148 to scroll the data displayed in the 2D graph to visualize different time periods of the data displayed and to zoom in and zoom out of the data displayed at different time scales. In other words, the temporal exploration operator enables a user to modify TStartₑₓₚₗₒᵣ and TEndₑₓₚₗₒᵣ in Equations (35), (37) and (39), such that the time period of the data which is to be displayed to a user in the window is modified. The temporal exploration operator also enables a user to modify Granₑₓₚₗₒᵣ in Equations (35), (37) and (39), depending on the type of data to which the temporal exploration operator is applied, to visualize the data displayed at a higher time resolution (i.e., a magnification) or at a lower time resolution (i.e., a minification) for a given specified time period. As described below, the third operator enabled by explorer 148 enables a user to modify Gran_{aggr} in Equation (38). It is noted that if Granₑₓₚₗₒᵣ is modified, then TStartₑₓₚₗₒᵣ and TEndₑₓₚₗₒᵣ are necessarily modified accordingly. Modifying the data displayed to be visualized at a lower time resolution enables substantially more data values to be visualized, which may aid a user in determination a pattern or an association in the displayed data over a longer period of time. Modifying the data displayed to be visualized at a higher time resolution enables substantially fewer data values to be visualized, but at a greater resolution, which enables a user to explore data values in a specified time period more in-depth. In the case that the temporal exploration operator is applied to data values of the first type (delegate values corresponding to raw data values) or the second type (statistical values determined for a plurality of raw data values), as described above, any delegate values determined for the displayed data are not determined again. In such a case, a user is able, via appropriate controls (not shown) in explorer 148 such as GUI controls, to specify a new time period for which data should be displayed or a new time resolution for a given new time period at which data should be displayed. In general, specifying a new time resolution requires that a new time period be specified as well. In general, after the user has specified the new time period or new time resolution, display manager 654 recalculates certain stored parameters to update the data values displayed according to what the user specified. Formally, the temporal exploration operator as applied to data values of the first type and the second type can be defined as:

TemporalExplorationOperator≡(<Concept_{c},CurrentValues*,TStartₑₓₚₗₒᵣ,TEndₑₓₚₗₒᵣ,Granₑₓₚₗₒᵣ,[RefPos]>, TStart^{New}ₑₓₚₗₒᵣ,TEnd^{New}ₑₓₚₗₒᵣ,Gran^{New}ₑₓₚₗₒᵣ) [symbol] <Concept_{c},NewValues*,TStart^{New}ₑₓₚₗₒᵣ,TEnd^{New}ₑₓₚₗₒᵣ,Gran^{New}ₑₓₚₗₒᵣ,[RefPos]> (41)

where ‘≡’ denotes the definition symbol, in other words, the temporal exploration operator can be defined as. The terms to the left of the arrow ‘ [symbol] ’ represent the input data to display manager 654, whereas the terms to the right of the arrow ‘ [symbol] ’ represent the output data of display manager 654 after the at least one specified determination is determined, as explained below. In Equation (41), CurrentValues* represents the data values currently displayed and depends on the type of data displayed. In the case of the first type of data, CurrentValues* is equal to DelegateValues* in Equation (35), which represents a set of delegate values determined for concept c by computation manager 652 at a granularity level specified by Gran_{aggr} using DF_{c}, as shown above in Equation (34). In the case of the second type of data, CurrentValues* is equal to PopulationDelegateValues* in Equation (37), which represents a set of delegate values determined for concept c by computation manager 652 for a population of subject records at a granularity level specified by Gran_{aggr} using PDF_{c}, as shown above in Equation (36). TStart^{New}ₑₓₚₗₒᵣ and TEnd^{New}ₑₓₚₗₒᵣ represent the new start and new end of the time period of the data to be displayed and Gran^{New}ₑₓₚₗₒᵣ represents the new granularity (i.e., time scale) at which the data is to be displayed. Recall that Granₑₓₚₗₒᵣ represents the time scale which is used in the 2D graph to display data values and not the time scale on which delegate values are determined (which is Gran_{aggr}). Using Equation (41), since the granularity of the data values displayed is modified and the start time and end time of the data values to be displayed is also modified, display manager 654 has to recalculate the values of the data to be displayed. NewValues* represents a new set of DelegateValues* (first type of data) or a new set of PopulationDelegateValues* (second type of data) which is determined by display manager 654 based on TStart^{New}ₑₓₚₗₒᵣ, TEnd^{New}ₑₓₚₗₒᵣ and Gran^{New}ₑₓₚₗₒᵣ which is to be displayed in explorer 148. It is noted that when display manager 654 recalculates the values to be stored and displayed in DelegateValues* and PopulationDelegateValues*, the parameters and values stored in InputData*, as described above in Equations (34) and (36), do not change. The recalculation of the values stored and displayed in DelegateValues* and PopulationDelegateValues* can be considered a specified determination which display manager 654 executes on input data, as per the left hand side of Equation (41) to generate output data, as per the right hand side of Equation (41).

Reference is now made to FIG. 12A, which is an illustration showing an example of the exploration of delegate values determined from raw data values using a temporal exploration operator, generally referenced 750, constructed and operative in accordance with another embodiment of the disclosed technique. In FIG. 12A, delegate values determined from raw data values are displayed on a 2D graph in a window of a GUI, which represents an embodiment of explorer 148 (FIGS. 2 and 10). Exploration of data values using a temporal exploration operator 750 includes a first window 752 and a second window 754. First window 752 shows data values and statistical values determined for those data values. First window 752 includes a display panel 774 in which current data values 758 are shown. Current data values 758 represent the white blood cell counts of 58 subject records for a time period of a year ranging from the end of September 1994, defined above as TStartₑₓₚₗₒᵣ, until the end of September 1995, defined above as TEndₑₓₚₗₒᵣ. Horizontal axis 756 represents the time scale at which data values 758 are displayed at, which was defined above as Granₑₓₚₗₒᵣ, which in first window 752 is at a granularity of months. Each data value 758 is actually a delegate value representing the white blood cell count of each one of the 58 subject records aggregated at a Gran_{aggr} of seconds. Vertical axis 753 represents the units in which the raw concept white blood cell count is measured in, which in window 752 is thousands of cells per milliliter of blood (10³ cells/mL). In display panel 774 statistical values 769, which represent population delegate values for data values 758, are also displayed. Statistical values 769 represent the maximum monthly value for the white blood cell count of all the subject records displayed. A line 760 connects statistical values 769. It is noted that data values 758 are displayed at a time resolution (i.e., granularity) of seconds, defined above as Gran_{aggr}. As can be seen in first window 752, since data values 758 are displayed at a time resolution of seconds on a display with a time scale of months (horizontal axis 756), data values 758 appear very cluttered. According to the disclosed technique, using a temporal exploration operator, a user (not shown) can zoom in, or zoom out, on data values 758 at a specified time resolution over a specified time period, as shown in second window 754.

In second window 754, which includes a display panel 776, a user (not shown) has selected to zoom in on the data values shown in first window 752 for the time period of the 1 Mar. 1995 until the 31 Mar. 1995, at a granularity of days. In this example, the 1 Mar. 1995 represents TStart^{New}ₑₓₚₗₒᵣ, the 31 Mar. 1995 represents TEnd^{New}ₑₓₚₗₒᵣ, and days represents Gran^{New}ₑₓₚₗₒᵣ. The new specified time period to be displayed as well as the new granularity may be selected via a menu (not shown), a button, such as button 762 representing March 1995 or via a keyboard shortcut, as is known in the art. Arrows 778A and 778B show that data values 758 are now shown closer up in second window 754. In second window 754, a horizontal axis 764 now shows a time period ranging the entire month of March 1995, with each day shown. A vertical axis 759 has not changed and represents substantially the same units on the same scale as vertical axis 753. New data values 766 are shown in second window 754. It is noted that even though Granₑₓₚₗₒᵣ has changed from months to days in second window 754, Gran_{aggr} has not changed and new data values 766 are still displayed at a granularity of seconds, although since the time scale is displayed at a time resolution of days, new data values 766 are less cluttered than in first window 752. None of new data values 766 represent data values which were not displayed in first window 752, i.e., all of new data values 766 were already displayed in first window 752 under button 762 representing data values 758 for March 1995. Also, statistical value 772 represents the maximum monthly value for the white blood cell count of all the subject records displayed for the month of March 1995 and is equal to statistical value 770 in first window 752 which also represents the maximum monthly value for the white blood cell count of all the subject records displayed for the month of March 1995. A line 768 connects statistical value 772 with the similar statistical value of adjacent months (not shown). Data values 758 and statistical values 769 were defined above in Equation (41) as CurrentValues*, where new data values 766 and statistical value 772 represent NewValues*. New data values 766 and statistical value 772 represent the new data values stored in display manager 654 (FIG. 10). In this example, new data values 766 and statistical value 772 are actually a subset of data values 758 and statistical values 769. It is noted that in this example, Gran_{aggr} was kept constant in first window 752 and second window 754, although as described below, a user could have specified a different Gran_{aggr} in second window 754 besides specifying a different Granₑₓₚₗₒᵣ using other exploration operators.

Reference is now made to FIG. 12B, which is a schematic illustration of a method for exploring delegate values determined from raw data values using a temporal exploration operator, generally referenced 790, operative in accordance with a further embodiment of the disclosed technique. In procedure 792, data values for a specified time period and at a specified time resolution are retrieved and displayed. The data values represent delegate values determined from raw data values or statistical values determined for a plurality of raw data values stored for at least one subject record. For example, data values may be displayed for a time period ranging from Jun. 1, 1990 to Sep. 15, 1990 at a time resolution of months. With reference to FIG. 10, computation manager 652 and display manager 654 store certain parameters of the data retrieved from data provider 152 (FIG. 2), including parameters related to the constraints specified in constraint specifier 146 (FIG. 2), which resulted in the respective data being retrieved. Using these and other parameters, display manager 654 can display the data retrieved. In procedure 794, a new time resolution at which to display the data values displayed in procedure 792 is defined. Defining a new time resolution substantially represents defining a new granularity for displaying the data values, defined above as Granₑₓₚₗₒᵣ. For example, if the specified time resolution in procedure 792 was months, then the new time resolution may be defined as days. It is noted that procedure 794 is an optional procedure. With reference to FIG. 10, a user is able, via appropriate controls (not shown) in explorer 148 such as GUI controls, to specify a new time resolution for a given new time period at which data should be displayed.

In procedure 796, a new time period is defined at which to display the data values displayed in procedure 792. As shown, procedure 796 can follow directly after procedure 792. For example, if the time period defined in procedure 792 ranged from Jun. 1, 1990 to Sep. 15, 1990, then the new time period defined in procedure 796 may range from Jun. 1, 1992 to Nov. 20, 1992. In both the specified time period and the new time period, the time resolution is defined at a granularity of months. In the case that procedure 794 was executed, a new time resolution is defined as well. With reference to FIG. 10, a user is able, via appropriate controls (not shown) in explorer 148 such as GUI controls, to specify a new time period at which data should be displayed. In general, specifying a new time resolution requires that a new time period be specified as well. In procedure 798, the displayed values are updated according to the new time period defined in procedure 796 or according to the new time resolution defined in procedure 794 and the new time period defined in procedure 796. With reference to FIG. 10, after the user has specified the new time period or new time resolution, display manager 654 recalculates certain stored parameters to update the data values displayed according to what the user specified.

Reference is now made back to FIG. 10. In the case that the temporal exploration operator is applied to data values of the third type (data values representing abstract concepts) as described above, any delegate values determined for the displayed data must be determined again. As mentioned above, in the case of data values for abstract concepts, if Granₑₓₚₗₒᵣ is modified, Gran_{aggr} is modified as well as the distribution of delegate values for a specified granularity must be recalculated. As above, a user is able, via appropriate controls (not shown) in explorer 148 such as GUI controls, to specify a new time period for which data should be displayed or a new time resolution for a given new time period at which data should be displayed. In either case, the data values to be displayed representing the abstract concepts must be recalculated. In general, after the user has specified the new time period or new time resolution, computation manager 652 and display manager 654 recalculate certain stored parameters to update the data values displayed according to what the user specified. Formally, the temporal exploration operator as applied to data values of the third type can be defined as:

TemporalExplorationOperator≡(<Concept_{c},InputData*,Gran_{aggr},DF_{c}>, <Concept_{c},Distribution*,TStartₑₓₚₗₒᵣ,TEndₑₓₚₗₒᵣ,Granₑₓₚₗₒᵣ,[RefPos]>, Gran^{New}_{aggr},TStart^{New}ₑₓₚₗₒᵣ,TEnd^{New}ₑₓₚₗₒᵣ,Gran^{New}ₑₓₚₗₒᵣ) [symbol] <Concept_{c},InputData*,Gran^{New}_{aggr},DF_{c}>, <Concept_{c},NewDistribution*,TStart^{New}ₑₓₚₗₒᵣ,TEnd^{New}ₑₓₚₗₒᵣ,Gran^{New}ₑₓₚₗₒᵣ,[RefPos]> (42)

where ‘≡’ denotes the definition symbol, in other words, the temporal exploration operator can be defined as. As above, the terms to the left of the arrow ‘ [symbol] ’ represent the input data to computation manager 652 and display manager 654, whereas the terms to the right of the arrow ‘ [symbol] ’ represent the output data of computation manager 652 and display manager 654 after the at least one specified determination is determined, as explained below. In Equation (42), Distribution* represents the abstracted data values currently displayed using the data structure shown above in Equation (40). Since Granₑₓₚₗₒᵣ is modified in Equation (42), Gran_{aggr} is also modified. By modifying the time resolution at which the data values are to be aggregated, the distribution of such data values needs to be recalculated. In other words, the data values stored in InputData* need to be aggregated again using the delegate function DF_{c} but at the new specified aggregation granularity, Gran^{New}_{aggr}. Computation manager 652 aggregates the data values stored in InputData* using DF_{c} at the time resolution of Gran^{New}_{aggr}. This recalculation generates a new set of abstracted data values, stored as NewDistribution*, to be displayed to a user. Based on the new aggregated values determined by computation manager 652, display manager 654 determines NewDistribution*, which represents the new abstracted values to be displayed based on TStart^{New}ₑₓₚₗₒᵣ, TEnd^{New}ₑₓₚₗₒᵣ and Gran^{New}ₑₓₚₗₒᵣ. All other terms in Equation (42) are similar to those in Equation (41) and were defined above. NewDistribution* can represent new abstracted values for a single subject record or for a plurality of subject records. The recalculation of the values stored and displayed in Distribution* can be considered a specified determination which computation manager 652 and display manager 654 execute on input data, as per the left hand side of Equation (42) to generate output data, as per the right hand side of Equation (42).

Reference is now made to FIG. 12C, which is an illustration showing an example of the exploration of abstracted data values using a temporal exploration operator, generally referenced 820, constructed and operative in accordance with another embodiment of the disclosed technique. In FIG. 12C, abstracted data values are displayed on a 2D graph in a window of a GUI, which represents an embodiment of explorer 148 (FIGS. 2 and 10). Exploration of abstracted data values using a temporal exploration operator 820 includes a first window 822 and a second window 834. First window 822 shows abstracted data values. Recall that the abstracted data values displayed were initially first specified and retrieved using constraint specifier 146 (FIG. 2). First window 822 includes a display panel 824 in which abstracted data values 826 are shown. Recall that abstracted data values are displayed as a proportional distribution. Abstracted data values 826 represent the abstract concept white blood cell state after a bone marrow transplant of 58 subject records for a time period of a month ranging from May 1, 1995, defined above as TStartₑₓₚₗₒᵣ, until May 31, 1995, defined above as TEndₑₓₚₗₒᵣ. Horizontal axis 828 represents the time scale at which abstracted data values 826 are displayed at, which was defined above as Granₑₓₚₗₒᵣ, which in first window 822 is at a granularity of days. Since Granₑₓₚₗₒᵣ is equal to Gran_{aggr}, each abstracted data value 826 represents an aggregation, i.e., a delegate value, of the concept displayed for all the subject records at a granularity of days as well. In other words, for a given day, an abstracted data value 826 is an aggregation of the abstracted data values stored for that day for all the subject records which have abstracted data values stored for that day. Abstracted data values 826 are substantially defined in Distribution* as defined above in Equations (39) and (40). Vertical axis 830 represents the discrete value scale in which the abstracted concept white blood cell state after a bone marrow transplant is measured in, which is ‘very high,’ ‘high,’ ‘normal,’ ‘moderately_low,’ ‘low’ and ‘very_low.’ Vertical axis 830 also includes a percentage scale from 0% to 100% for each discrete value. According to the disclosed technique, using a temporal exploration operator, a user (not shown) can zoom in, or zoom out, on abstracted data values 826 at a specified time resolution over a specified time period, as shown in second window 834.

In second window 834, which includes a display panel 836, a user (not shown) has selected to zoom out on the abstracted data values shown in first window 822 for the time period of January 1995 until December 1995, at a granularity of months. In this example, January 1995 represents TStart^{New}ₑₓₚₗₒᵣ, Dec. 1995 represents TEnd^{New}ₑₓₚₗₒᵣ, and months represents Gran^{New}ₑₓₚₗₒᵣ as well as Gran^{New}_{aggr}. The new specified time period to be displayed as well as the new granularity may be selected via a menu (not shown), a button, such as button 844 representing May 1995 or via a keyboard shortcut, as is known in the art. Arrows 832A and 832B show that abstracted data values 826 are now shown in a condensed form in second window 834. In second window 834, a horizontal axis 840 now shows a time period ranging the entire year of 1995, with each month shown. A vertical axis 842 has not changed and represents substantially the same units on the same scale as vertical axis 830. New abstracted data values 838 are shown in second window 834 and substantially represent NewDistrbution* as shown above in Equation (42). Note that since Granₑₓₚₗₒᵣ was changed to months in second window 834, abstracted data values 826 in first window 822 had to be recalculated at a Gran_{aggr} of months in order to display new abstracted data values 838 at a Granₑₓₚₗₒᵣ of months. In addition, new abstracted data values 838 for months other than May 1995 had to be determined. Each new abstracted data value 838 is a delegate value representing the concept displayed at a granularity of months, meaning the distribution of each discrete value as a percent for all 58 subject records displayed which have abstracted data values stored in the time period shown.

Reference is now made to FIG. 12D, which is a schematic illustration of a method for exploring abstracted data values using a temporal exploration operator, generally referenced 860, operative in accordance with a further embodiment of the disclosed technique. In procedure 862, data values for a specified time period and at a specified time resolution are retrieved and displayed. The data values represent abstracted data values stored for at least one subject record. The abstracted data values may be initially derived from raw data values. With reference to FIG. 10, computation manager 652 and display manager 654 store certain parameters of the data retrieved from data provider 152 (FIG. 2), including parameters related to the constraints specified in constraint specifier 146 (FIG. 2), which resulted in the respective data being retrieved. Using these parameters, display manager 654 can display the data retrieved. In procedure 864, a new time resolution at which to display the data values displayed in procedure 862 is defined. Defining a new time resolution substantially represents defining a new granularity at both the level of the data displayed, defined above as Granₑₓₚₗₒᵣ, and the level at which data values for abstract concepts are aggregated, defined above as Gran_{aggr}. It is noted that procedure 864 is an optional procedure. With reference to FIG. 10, a user is able, via appropriate controls (not shown) in explorer 148 such as GUI controls, to specify a new time resolution for a given new time period at which data should be displayed.

In procedure 866, a new time period is defined at which to display the data values displayed in procedure 862. As shown, procedure 866 can follow directly after procedure 862. In the case that procedure 864 was executed, a new time resolution is defined as well. With reference to FIG. 10, a user is able, via appropriate controls (not shown) in explorer 148 such as GUI controls, to specify a new time period at which data should be displayed. In general, specifying a new time resolution requires that a new time period be specified as well. In procedure 868, the data values to be displayed are recalculated. In the case that procedure 864 was not executed, and only a new time period was specified in procedure 866, the data values to be displayed are recalculated according to the new time period specified. In general, abstracted data values represent delegate values, therefore if the time period for displaying data values is changed, the delegate values which are displayed are recalculated based on the data values in the new time period. In the case that procedure 864 was executed, the data values to be displayed are recalculated according to the new time period specified as well as the new time resolution specified. Recalculating the data values substantially represents recalculating the delegate values to be displayed at the new time resolution specified, defined above as Gran_{aggr} (FIG. 10). The recalculated delegate values are determined based on abstracted data values. With reference to FIG. 10, if Granₑₓₚₗₒᵣ is modified, Gran_{aggr} is modified as well as the distribution of delegate values for a specified granularity must be recalculated. In either case, the data values to be displayed representing the abstract concepts must be recalculated. Computation manager 652 aggregates the data values stored in InputData* using DF_{c} at the time resolution of Gran^{New}_{aggr}.

This recalculation generates a new set of abstracted data values, stored as NewDistribution*, to be displayed to a user. In procedure 870, the displayed values are updated according to the recalculated data values in procedure 868. With reference to FIG. 10, after the user has specified the new time period or new time resolution, display manager 654 recalculates certain stored parameters to update the data values displayed according to what the user specified. Based on the new aggregated values determined by computation manager 652, display manager 654 determines NewDistribution*, which represents the new abstracted values to be displayed based on TStart^{New}ₑₓₚₗₒᵣ, TEnd^{New}ₑₓₚₗₒᵣ and Gran^{New}ₑₓₚₗₒᵣ.

Reference is now made back to FIG. 10. A second operator enabled by explorer 148 is a change delegate value operator. This operator enables a user to use explorer 148 to view the data displayed in the 2D graph using different delegate functions, or at a different aggregation granularity (defined as Gran_{aggr} above) to aggregate the data stored in InputData*, as defined above in Equations (34), (36) and (38). In other words, the change delegate value operator enables a user to modify Gran_{aggr}, DF_{c} and PDF_{c} in Equations (34), (36) and (38), such that the function used to aggregate data values stored for at least one subject record, or the granularity level of the aggregation, is modified. By modifying how the data values are aggregated, and at what time resolution, the data values displayed are also modified. Changing the delegate function, or the time resolution used to display stored data values may enable a user to determine patterns in the stored data values which are only discernible using a particular delegate function. In this manner, a user may be able to generate new knowledge in a domain. The application of the change delegate value operator to all three types of data values (as described above) is substantially the same. As mentioned above, a user is able, via appropriate controls (not shown) in explorer 148 such as GUI controls, to specify a new delegate function to aggregate the data values which are displayed, or a new Gran_{aggr}. It is noted, as mentioned above, that the choice of delegate functions which a user can choose from to aggregate the data values again may be determined from a domain knowledge base which defines appropriate delegate functions for data values for a given concept, whether the concept is a raw data concept or an abstract data concept.

In general, after the user has specified the new delegate function, or a new aggregation granularity, computation manager 652 and display manager 654 recalculate certain stored parameters to update the data values displayed according to what the user specified. Using this operator, the time period which is displayed is not changed nor is the time resolution of the graph (Granₑₓₚₗₒᵣ) on which the data values are displayed changed. Formally, the change delegate value operator as applied to all data values types can be defined as:

ChangeDelegateValueOperator≡(<Concept_{c},InputData*,Gran_{aggr},DF_{c}>, <Concept_{c},CurrentValues*,TStartₑₓₚₗₒᵣ,TEndₑₓₚₗₒᵣ,Granₑₓₚₗₒᵣ,[RefPos]>, Gran^{New}_{aggr},NewDF_{c}) [symbol] <Concept_{c},InputData*,Gran^{New}_{aggr},NewDF_{c}>, <Concept_{c},NewValues*,TStartₑₓₚₗₒᵣ,TEndₑₓₚₗₒᵣ,Granₑₓₚₗₒᵣ,[RefPos]> (43)

In Equation (43) CurrentValues* and NewValues* can represent data values of either the first type, second type or third type. In the case of the third type, CurrentValues* was defined above in Equation (39) as Distribution* and NewValues* was defined above in Equation (42) as NewDistribution*. Gran^{New}_{aggr} represents the new time resolution at which the data values in InputData* are to be aggregated at and NewDF_{c} represents the new delegate function to be used to aggregate the data values in InputData*. In the case that InputData* includes data values from a plurality of subject records, then DF_{c} and NewDF_{c} are to be replaced in Equation (43) by PDF_{c} and NewPDF_{c}, which represent the delegate function and new delegate function to be used to aggregate data values from a plurality (i.e., a population) of subject records. It is noted that a user can define either a Gran^{New}_{aggr}, a NewDF_{c} or both. All other parameters in Equation (43) are as defined above in previous equations. Using the change delegate value operator, since the delegate function used to aggregate data values, or the granularity at which data values are to be aggregated, or both, are modified, the data values which are displayed are substantially different than the data values originally displayed. As such, the data values displayed, as stored in CurrentValues*, need to be updated such that a new set of data values is displayed, as stored in NewValues* in Equation (43).

Reference is now made to FIG. 13A, which is an illustration showing an example of the exploration of delegate values determined from raw data values using a change delegate value operator, generally referenced 900, constructed and operative in accordance with another embodiment of the disclosed technique. FIG. 13A shows two windows of a GUI used to embody explorer 148 (FIGS. 2 and 10), a first window 902 and a second window 904. First window 902 includes a display panel 906 and second window 904 includes a display panel 908. Display panel 906 includes data points 910, first population delegate value data points 913 and second population delegate value data points 915. Data points 910 are delegate values corresponding to raw data values stored in InputData* and are at the same granularity as the granularity at which the raw data values are stored at. First population delegate value data points 913 and second population delegate value data points 915 represent statistical values for a plurality of subject records determined from data points 910. Data points 910 represent delegate values for the raw data concept red blood cell count for each one of the 58 subject records displayed over a time period ranging from April 1995 until March 1996. In display panel 906, data points 910 are aggregated at a Gran_{aggr} of seconds yet are displayed on a time scale Granₑₓₚₗₒᵣ of months. First population delegate value data points 913 represent delegate values of data points 910 aggregated at a Gran_{aggr} of months using a maximum value delegate function. In other words, each first population delegate value data point 913 represents the maximum value of the delegate value of the red blood cell count per month of all 58 subject records which have data values stored for the concept of a given month. A line 912 connects consecutive first population delegate value data points 913. Second population delegate value data points 915 represent delegate values of data points 910 aggregated at a Gran_{aggr} of months using a minimum value delegate function. In other words, each second population delegate value data point 915 represents the minimum value of the delegate value of the red blood cell count per month of all 58 subject records which have data values stored for the concept of a given month. A line 914 connects consecutive second population delegate value data points 915.

Using a graph manager interface (not shown), in second window 904, a user has selected to change the delegate function used to display data points 910. In first window 902, an identity delegate function is used to display data points 910, whereby data points are aggregated at the same granularity at which they are stored in InputData*. In second window 904, the user has selected to aggregate data points 910 of each subject record using a MEAN (AVERAGE) delegate function at a new aggregation granularity of months. According to Equation (43), Gran^{New}_{aggr} would be months and NewDF_{c} would be MEAN. In other words, the data points 910 for each subject record are to be aggregated into a single delegate value per month as the average value of a subject record's red blood cell count for a given month. In second window 904, new data points 916 represent the average value of the concept shown each month for each subject record. First population delegate value data points 917 are equivalent to first population delegate value data points 913, with line 918 being equivalent to line 912. Second population delegate value data points 919 are equivalent to second population delegate value data points 915, with line 920 being equivalent to line 914. In addition, the user has specified that the average value per year of the concept shown for all subject records be determined and displayed. A line 922 connects the average value (not shown) of 1995 for all subject records to the average value of 1996 for all subject records. It is noted that in FIG. 13A, the horizontal and vertical axes of first window 902 and second window 904 did not change, meaning that TStartₑₓₚₗₒᵣ, TEndₑₓₚₗₒᵣ and Granₑₓₚₗₒᵣ were held constant when the change delegate value operator was applied to the data points shown.

Reference is now made to FIG. 13B, which is an illustration showing an example of the exploration of abstracted data values using a change delegate value operator, generally referenced 940, constructed and operative in accordance with a further embodiment of the disclosed technique. FIG. 13B shows two windows of a GUI used to embody explorer 148 (FIGS. 2 and 10), a first window 942 and a second window 944. First window 942 includes a display panel 947 and second window 944 includes a display panel 958. Display panel 947 includes abstracted data points 946 and 948. Each of abstracted data point 946 and 948 represents the distribution as a percent of the abstract concept white blood cell state after a bone marrow transplant for a population of 4 subject records at a Gran_{aggr} of months and a Granₑₓₚₗₒᵣ of months. Each of abstracted data points 946 and 948 represents a delegate value of abstracted data values (not shown) which were aggregated using a maximal cumulative duration delegate function. For example, using this delegate function, abstracted data point 948 was determined for all 4 subject records (100% of the subject records which have data values in the month of April 1995) to have a discrete value of ‘normal’ during the month of April 1995, as shown in a tooltip box 950.

Using a graph manager interface (not shown), a user selected a different delegate function to be used, to aggregate the abstracted data values of the 4 subject records shown in second window 944. The delegate function selected was the longest duration interval delegate function, which results in a different distribution of abstracted data points 952 and 956 in second window 944. For example, using the longest duration interval delegate function, for the month of April 1995, as shown in second window 944, 50% of the subject records have a discrete value of ‘normal’ and 50% of the subject records have a discrete value of ‘very_low.’ In other words, by aggregating the data values of the subject records shown using a different delegate function, the distribution which is displayed may be modified. It is noted that for some months, such as from July 1995 until November 1995, the use of a different delegate function did not change the distribution of the abstracted data points, whereas in other months, such as April 1995, December 1995 and February 1996, the use of a different delegate function did change the distribution of the abstracted data points. It is noted that in second window 944, Gran_{aggr} was not changed but remained at a time resolution of months, whereas DF_{c} was changed from maximal cumulative duration to longest duration interval. As in FIG. 13A, in FIG. 13B the horizontal and vertical axes of first window 942 and second window 944 did not change, meaning that TStartₑₓₚₗₒᵣ, TEndₑₓₚₗₒᵣ and Granₑₓₚₗₒᵣ were held constant when the change delegate value operator was applied to the abstracted data points shown.

Reference is now made to FIG. 13C, which is a schematic illustration of a method for exploring delegate values determined from raw data values and abstracted data values using a change delegate value operator, generally referenced 970, operative in accordance with another embodiment of the disclosed technique. In procedure 972, data values aggregated at a specified aggregation granularity using a specified delegate function are retrieved and displayed. It is noted that these data values are within a specified time period. The data values represent delegate values determined from raw data values or abstracted data values stored for at least one subject record. For example, data values retrieved may be aggregated at a Gran_{aggr} of days using a delegate function such as MEAN. With reference to FIG. 10, computation manager 652 and display manager 654 store certain parameters of the data retrieved from data provider 152 (FIG. 2), including parameters related to the constraints specified in constraint specifier 146 (FIG. 2), which resulted in the respective data being retrieved. Using these parameters, display manager 654 can display the data retrieved. In procedure 974, a new aggregation granularity at which to aggregate the data values displayed in procedure 972 is specified. Defining a new aggregation granularity substantially represents defining a new granularity at the level at which data values for raw and abstract concepts are aggregated, defined above as Gran_{aggr}. It is noted that after procedure 974, procedure 978 can be executed directly. With reference to FIG. 10, a user is able, via appropriate controls (not shown) in explorer 148 such as GUI controls, to specify a new aggregation granularity at which to aggregate the data values displayed.

In procedure 976, a new delegate function is specified at which to aggregate the data values retrieved in procedure 976. As shown, procedure 976 can follow directly after procedure 972. In the case that procedure 974 was executed, a new aggregation granularity is defined as well. With reference to FIG. 10, a user is able, via appropriate controls (not shown) in explorer 148 such as GUI controls, to specify a new delegate function for aggregating data values. In procedure 978, the data values to be displayed are recalculated using either the new specified aggregation granularity, the new specified delegate function or both. In the case that procedure 974 was not executed, and only a new delegate function was specified in procedure 976, the data values to be displayed are recalculated according to the new delegate function specified. In other words, the aggregation granularity is kept constant, yet a new delegate function is used to aggregate the data values. In the case that procedure 974 was executed and procedure 976 was not executed, the data values to be displayed are recalculated according to the new aggregation granularity specified. In other words, the same delegate function is used, yet it is applied to the data values at a new aggregation granularity. In the case that both procedures 974 and 976 were executed, the data values to be displayed are recalculated according to the new aggregation granularity specified using the new delegate function specified. With reference to FIG. 10, after the user has specified the new delegate function, or a new aggregation granularity, computation manager 652 and display manager 654 recalculate certain stored parameters to update the data values displayed according to what the user specified. Using this operator, the time period which is displayed is not changed nor is the time resolution of the graph (Granₑₓₚₗₒᵣ) on which the data values are displayed changed.

In procedure 980, the displayed values are updated according to the recalculated data values in procedure 978. With reference to FIG. 10, after the user has specified the new aggregation granularity or new delegate function, display manager 654 recalculates certain stored parameters to update the data values displayed according to what the user specified. Based on the new aggregated values determined by computation manager 652, display manager 654 determines NewValues* in Equation (43), which represents the new aggregated data values to be displayed based on Gran^{New}_{aggr}, NewDF_{c} or both.

Reference is now made back to FIG. 10. A third operator enabled by explorer 148 is a set relative time operator. This operator enables a user to use explorer 148 to view the data displayed in the 2D graph according to a relative timeline, defined as RefPos (i.e., reference position) above, if the data displayed is displayed using an absolute timeline. This operator also enables a user to view the data displayed according to a new start time if the data displayed is displayed using a relative timeline. In other words, this operator enables a user to change RefPos defined in the equations above, such as in Equations (35), (37), (39) and (41). Recall that relative timelines are defined by start times that represent particular or significant events in a domain, which may be defined in a domain knowledge base. The start time of a relative timeline represents a reference point from which time is measured for a subject record's data. The measurement of time can be at any time resolution, i.e., granularity, defined in constraint specifier 146 (FIG. 2). For example, in the medical research domain, if the start time is ‘birth of a child,’ then the time stamp for a subject record's data values may be stored as the number of days or months after the start time and not the date and time when the data values were stored based on a calendar. If it noted that given a defined start time, data values stored with a time stamp on an absolute timeline can be converted to data values stored with a time stamp on a relative timeline.

By changing the timeline on which data values are displayed, the data values displayed may change. For example, in the medical research domain, if a subject record has data values stored for the concept HGB value, both before a medical procedure and after a medical procedure, then all the data values for the concept HGB value may be displayed. If a user defines a new start time, i.e., a new RefPos, such as ‘medical procedure,’ then only the data values having a time stamp on or after the medical procedure will be displayed. In addition, if data values from a plurality of subject records is displayed, and if the timeline on which the data values are displayed changes, then the subject records from which data values are retrieved and displayed may also change, as subject records may not have data values that are related to the particular event which sets the start time. For example, in the information security domain, data values for the concept ‘number of registry changes’ may be displayed for a plurality of subject records on an absolute timeline. If a user specifies a new timeline, such as a relative timeline with a start time of ‘start of Nimda worm propagation,’ then data values of the subject records for the concept ‘number of registry changes’ will be displayed but only for subject records which have data values relating to the start time ‘start of Nimda worm propagation.’ In other words, the number of registry changes for the subject records will be displayed but only for subject records which have had the Nimda worm (i.e., have experienced the particular event which marks the start time). Data values from subject records which have not had the Nimda worm will not be displayed.

In general, modifying the timeline (i.e., either absolute or relative) or the start time of a relative timeline (i.e., using a different significant event as the start time) used to display data values will modify what data values are displayed, as well as from which subject records data values are displayed in the case that data value are displayed from a plurality of subject records. Changing the timeline using the set relative time operator may enable a user to determine patterns in the stored data values which are only discernible by displaying the stored data values on a relative timeline having a particular event as its start time, or reference point. In this manner, a user may be able to generate new knowledge in a domain. The application of the set relative time operator to all three types of data values (as described above) is substantially the same. As mentioned above, a user is able, via appropriate controls (not shown) in explorer 148 such as GUI controls, to specify a new RefPos. The possible choices for the new RefPos may be specified in a domain knowledge base, which defines specific significant events for a given concept in a given domain. In general, after the user has specified the new RefPos, computation manager 652 and display manager 654 recalculate certain stored parameters to update the data values displayed according to what the user specified. Using this operator, the time period which is displayed is changed to match the RefPos specified. In addition, the data stored in the subject records which is relative to the RefPos specified may have very different absolute timeline time stamps, therefore computation manager 652 and display manager 654 must align the data stored according to the new relative timeline. Also, in the case of an abstract concept, computation manager 652 may need to recalculate the delegate values of the abstract concept displayed and display manager 654 may need to recalculate the values stored in the data structure Distribution*, as defined above in Equation (39), as only data from subject records which have experienced the significant or particular event defined as the new start time (i.e., RefPos) are to be displayed according to the new relative timeline. Formally, the set relative time operator as applied to all data values types can be defined as:

SetRelativeTimeOperator≡(<Concept_{c},InputData*,Gran_{aggr},DF_{c}>, <Concept_{c},CurrentValues*,TStartₑₓₚₗₒᵣ,TEndₑₓₚₗₒᵣ,Granₑₓₚₗₒᵣ,[RefPos]>,NewRefPos) [symbol] <Concept_{c},NewValues*,TStartₑₓₚₗₒᵣ,TEndₑₓₚₗₒᵣ,Granₑₓₚₗₒᵣ,NewRefPos> (44)

In Equation (44) CurrentValues* and NewValues* can represent data values of either the first type, second type or third type. In the case of the third type, CurrentValues* was defined above in Equation (39) as Distribution* and NewValues* was defined above in Equation (42) as NewDistribution*. NewRefPos represents the new reference position from which data values should be displayed at. It is noted that using this operator, the parameter RefPos is no longer optional in the output of Equation (44). Recall that RefPos can refer to a significant or particular event in the context of concept c. In the case that an absolute timeline was used to display the data values, the horizontal axis of the graph used to display the data values is changed to show a relative timeline. In the case that a relative timeline was used to display the data values and RefPos refers to another significant or particular event, then the horizontal axis may also be changed to display a different relative timeline as related to the other significant or particular event. All other parameters in Equation (44) are as defined above in previous equations. Using the set relative time operator, since the RefPos used to display data values, or from which data values are to be aggregated in the case of an abstract concept, is changed, then the data values which are displayed are substantially different than the data values originally displayed. This is the case, since the data values to be displayed need to be recalculated based on the new start time. As such, the data values displayed, as stored in CurrentValues*, need to be updated such that a new set of data values is displayed, as stored in NewValues* in Equation (44). Computation manager 652 may determine the values to be stored in NewValues*. It is noted that all the other parameters in Equation (44), such as Gran_{aggr}, Granₑₓₚₗₒᵣ, TStartₑₓₚₗₒᵣ and TEndₑₓₚₗₒᵣ are not modified when RefPos is changed using the set relative time operator. As a convention, when a NewRefPos is defined, if Granₑₓₚₗₒᵣ or Gran_{aggr} are defined at a time resolution of months or years, then since a relative timeline is being used to display the data, a month may be defined as 30 days, and a year as 360 days (i.e., 12 months of 30 days each), since the data values displayed will not have a time-stamp which is relative to a specific month on a calendar, as would be the case with an absolute timeline.

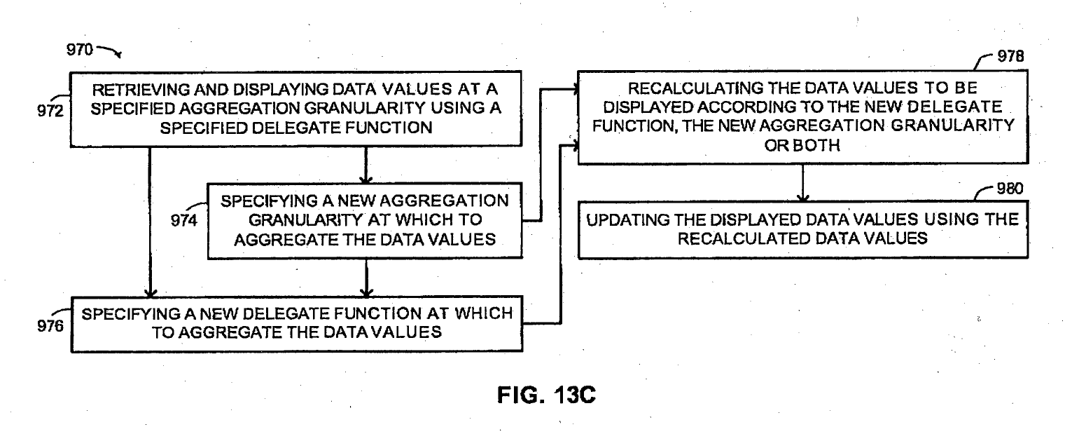

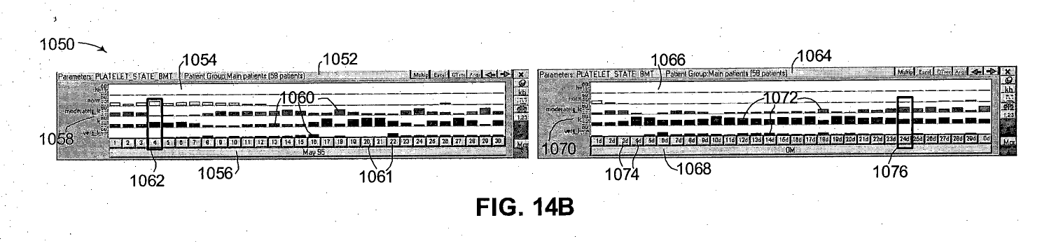

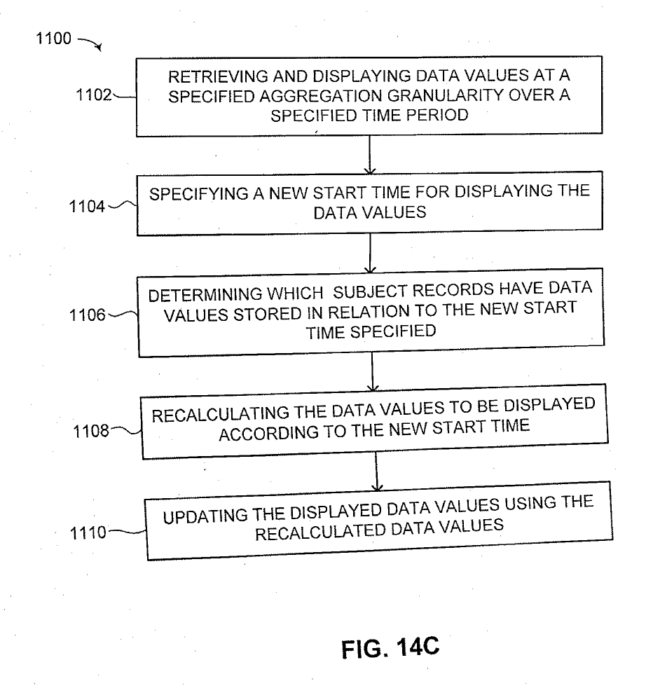

Reference is now made to FIG. 14A, which is an illustration showing an example of the exploration of delegate values determined from raw data values using a set relative time operator, generally referenced 1000, constructed and operative in accordance with a further embodiment of the disclosed technique. FIG. 14A shows two windows of a GUI used to embody explorer 148 (FIGS. 2 and 10), a first window 1010 and a second window 1016. First window 1010 includes a display panel 1012 and second window 1016 includes a display panel 1024. Display panel 1012 includes data points 1006, as well as population delegate value data points 1008. Population delegate value data points 1008 represent statistical values for a plurality of subject records determined from data points 1006. Data points 1006 represent delegate values corresponding to the raw data concept white blood cell count for 58 subject records over a time period ranging from December 1994 until December 1995. A vertical axis 1004 represents the unit used for measuring the raw data concept displayed, which is 10³ cells per microliter of blood. In display panel 1012, data points 1006 are displayed on a time scale of months on an absolute timeline, shown as a horizontal axis 1002. Population delegate value data points 1008 represent delegate values of data points 1006 aggregated at a Gran_{aggr} of months using a maximum value delegate function. In other words, each population delegate value data point 1008 represents the maximum value of the white blood cell count per month of all 58 subject records which have data values stored for the concept of a given month. A line 1014 connects consecutive delegate value data points 1008.

Using a graph manager interface (not shown), in second window 1016, a user has selected to change the start time, i.e., the reference point, used to display data points 1006. In second window 1016, the user has selected to display data points 1006 of each subject record using a start time of allogenic bone marrow transplant, over a time period of a year. In other words, data points 1026 now represent the white blood cell counts of the subject records selected for a year after each subject has had an allogenic bone marrow transplant. In second window 1016, the vertical axis 1022 has remained the same in first window 1010, although the horizontal axis 1018 has changed from an absolute timeline to a relative timeline. It is noted that Granₑₓₚₗₒᵣ has not changed in second window 1016, as the data values are displayed at a time resolution of months, as shown by month tabs 1020. The difference though is that each month shown on horizontal axis 1018 does not represent an absolute month relative to a calendar but relative to a specified period of time (as a convention, 30 days), from the specified start time, which is an allogenic bone marrow transplant. Month tab 1020 ‘1 m’ represents 1 month after an allogenic bone marrow transplant, month tab 1020 ‘2 m’ represents 2 months after an allogenic bone marrow transplant, and so on. In other words, TStartₑₓₚₗₒᵣ and TEndₑₓₚₗₒᵣ have been changed respectively from specific calendar dates to 0 years 0 months after an allogenic bone marrow transplant and 0 years 11 months after an allogenic bone marrow transplant. As a convention, the months in a year are counted from 0 to 11, where month 0 represents the first month after the reference point and month 11 represents the twelfth month (i.e., a year) after the reference point. Data values for subject records displayed in display panel 1012 may not be displayed in display pane 1024 if a subject has not undergone an allogenic bone marrow transplant, i.e., if the subject has not experienced or does not relate to the new start time specified. In other words, data points 1026 may be a different set of data values from data points 1006, taken from a subset of the data values stored for all the subject records specified. As in display panel 1012, population delegate value data points 1028 represent statistical values for a plurality of subject records determined from data points 1026, with consecutive population delegate value data points 1028 being connected by a line 1030.

As mentioned above, using the set relative time operator can also be used to change the start time of when data values are displayed for specified subject records even if data values are already displayed on a relative timeline. For example, raw data points 1026 may represent the white blood cell count after a first allogenic bone marrow transplant. A user may be able to select another significant event as the start time for displaying data values, such as a second allogenic bone marrow transplant (not shown) or after a platelet transfusion (not shown). In either a case, a different relative timeline would be displayed, and different data values would be displayed.

Reference is now made to FIG. 14B, which is an illustration showing an example of the exploration of abstracted data values using a set relative time operator, generally referenced 1050, constructed and operative in accordance with another embodiment of the disclosed technique. FIG. 14B shows two windows of a GUI used to embody explorer 148 (FIGS. 2 and 10), a first window 1052 and a second window 1064. First window 1052 includes a display panel 1054 and second window 1064 includes a display panel 1066. Display panel 1054 includes abstracted data points 1060, shown as a distribution. Abstracted data points 1060 represent a distribution of data values according to percentages for the abstract data concept platelet state after a bone marrow transplant for 58 subject records over a time period ranging from May 1, 1995 until May 30, 1995. A vertical axis 1058 represents the discrete value scale as well as the percent scale used for displaying the distribution of the abstract data concept displayed, which is a scale having five discrete values ranging from ‘high’ to ‘very_low’ as well as a percent scale from 0% to 100% for each discrete value shown. In display panel 1054, abstracted data points 1060 are displayed on a time scale of days on an absolute timeline, shown as a horizontal axis 1056, which include day tabs 1061. A box 1062 highlights the distribution of the abstracted data points for a particular day, May 4, 1995. It is noted that the distribution of the abstracted data points highlighted in box 1062 represents a distribution based on abstracted data points (not shown) which have a time-stamp of May 4, 1995.

Using a graph manager interface (not shown), in second window 1064, a user has selected to change the start time, i.e., the reference point, used to display abstracted data points 1060. In second window 1064, the user has selected to display abstracted data points 1060 of each subject record using a start time of bone marrow transplant, over a time period of a month. In other words, abstracted data points 1072 now represent the platelet state after a bone marrow transplant of the subject records selected for a month (i.e., 30 days) after each subject has had a bone marrow transplant. In second window 1064, the vertical axis 1070 has remained the same in first window 1052, although the horizontal axis 1068 has changed from an absolute timeline to a relative timeline. It is noted that Granₑₓₚₗₒᵣ has not changed in second window 1064, as the data values are displayed at a time resolution of days, as shown by day tabs 1074. The difference though is that each day shown on horizontal axis 1068 does not represent an absolute day relative to a calendar but relative to a specified period of time, from the specified start time, which is a bone marrow transplant. Day tab 1074 ‘3 d’ represents 3 days after a bone marrow transplant, day tab 1074 ‘4 d’ represents 4 days after a bone marrow transplant, and so on. In other words, TStartₑₓₚₗₒᵣ and TEndₑₓₚₗₒᵣ have been changed respectively from specific calendar dates to 0 months 0 days after a bone marrow transplant and 0 months 29 days after a bone marrow transplant. As a convention the days in a month are counted from 0 to 29, where day 0 represents the first day after the reference point and day 29 represents the thirtieth day (i.e., a month) after the reference point. Abstracted data values for subject records displayed in display panel 1054 may not be displayed in display panel 1066 if a subject record does not have abstract data values stored for the concept in the new start time specified, i.e., if a subject record does not have values stored for the first 30 days following a bone marrow transplant from which the abstract data concept platelet state after a bone marrow transplant is derived from. In other words, abstracted data points 1060 may be a different distribution of abstracted data values from the distribution of abstracted data points 1072. A box 1076 highlights the distribution of the abstracted data points for a particular day after a bone marrow transplant, specifically 24 days after a bone marrow transplant. It is noted that the distribution of the abstracted data points highlighted in box 1076 represents a distribution based on abstracted data points (not shown) with a time-stamp relative to the time-stamp when each subject record specified underwent a bone marrow transplant. As mentioned above, using the set relative time operator can also be used to change the start time of when data values are displayed for specified subject records even if data values are already displayed on a relative timeline. For example, abstracted data points 1072 may represent the platelet state after a first bone marrow transplant. A user may be able to select another significant event as the start time for displaying data values, such as a second bone marrow transplant (not shown) or a platelet transfusion (not shown). In either a case, a different relative timeline would be displayed, and different data values and distributions would be displayed.

Reference is now made to FIG. 14C, which is a schematic illustration of a method for exploring delegate values determined from raw data values and abstracted data values using a set relative time operator, generally referenced 1100, operative in accordance with a further embodiment of the disclosed technique. In procedure 1102, data values aggregated at a specified aggregation granularity over a specified time period are retrieved and displayed. The data values represent delegate values determined from raw data values or abstracted data values stored for at least one subject record specified. The specified time period can either be a time period specified on an absolute timeline or on a relative timeline. In the case of a relative timeline, the specified time period can be defined by the start of a particular event which is specific to the data values of the concept being displayed. With reference to FIG. 10, computation manager 652 and display manager 654 store certain parameters of the data retrieved from data provider 152 (FIG. 2), including parameters related to the constraints specified in constraint specifier 146 (FIG. 2), which resulted in the respective data being retrieved. Using these parameters, display manager 654 can display the data retrieved. In procedure 1104, a new start time at which to display the data values displayed in procedure 1102 is specified. Defining a new start time substantially represents defining a new reference point from which data values will be aggregated and displayed, defined above as NewRefPos. In general, the new start time refers to a particular event which has significance to the concept for which the data values in procedure 1102 are displayed. With reference to FIG. 10, a user is able, via appropriate controls (not shown) in explorer 148 such as GUI controls, to specify a new start time from which to aggregate the data values displayed.

In procedure 1106, from the at least one subject record specified, the subject records which have data values stored in relation to the new start time specified are determined. In this procedure, the subject records specified from which data values were retrieved and displayed in procedure 1102 are searched to determine which of the subjects have experienced the particular event which the new start time refers to. With reference to FIG. 10, after the user has specified the new RefPos, computation manager 652 and display manager 654 recalculate certain stored parameters to update the data values displayed according to what the user specified. In procedure 1108, the data values to be displayed are recalculated according to the new start time specified. In this procedure, the data values to be displayed need to be determined according to the new start time specified, as subjects may have experienced the particular event which the new start time refers to at different time periods according to an absolute timeline. In addition, if the data values represent abstracted data values, then the distribution of the abstracted data values needs to be recalculated based on the new start time specified. This may include aligning the abstracted data values according to the new start time specified. With reference to FIG. 10, after the user has specified the new RefPos, computation manager 652 and display manager 654 recalculate certain stored parameters to update the data values displayed according to what the user specified. Using this operator, the time period which is displayed is changed to match the RefPos specified. In addition, the data stored in the subject records which is relative to the RefPos specified may have very different absolute timeline time stamps, therefore computation manager 652 and display manager 654 must align the data stored according to the new relative timeline. Also, in the case of an abstract concept, computation manager 652 may need to recalculate the delegate values to be displayed and display manager 654 may need to recalculate the values stored in the data structure Distribution*, as defined above in Equation (39), as only data from subject records which have experienced the significant or particular event defined as the new start time (i.e., RefPos) are to be displayed according to the new relative timeline. In procedure 1110, the displayed values are updated according to the recalculated data values in procedure 1110. With reference to FIG. 10, after the user has specified the new start time, display manager 654 recalculates certain stored parameters to update the data values displayed according to what the user specified. Based on the new aggregated values determined by computation manager 652, display manager 654 determines NewValues* in Equation (44), which represents the new aggregated data values to be displayed based on NewRefPos.

In general, it is noted that the three operators described above for manipulating and exploring the visualized data enable magnification and minification of the data values displayed, such as the temporal exploration operator, as well as modification of the data values displayed, such as the change delegate value operator and the set relative time operator.

It will be appreciated by persons skilled in the art that the disclosed technique is not limited to what has been particularly shown and described hereinabove. Rather the scope of the disclosed technique is defined only by the claims, which follow.

1. Method for analyzing time-oriented data in a plurality of subject records, comprising the procedures of:
defining a knowledge base in a domain;
linking said knowledge base to a database of a plurality of subject records, each one of said plurality of subject records storing at least one instance of time-oriented data based on at least one concept defined in said knowledge base;
specifying at least one constraint on said plurality of subject records;
retrieving subject records which satisfy said at least one constraint;
graphically displaying said at least one instance of time-oriented data stored in said retrieved subject records; and
exploring at least one association between said at least one instance of time-oriented data stored in said retrieved records.

2. The method according to claim 1, further comprising the procedure of exploring at least one association between one of said at least one concept with another one of said at least one concept using said data stored in said retrieved subject records.

3. The method according to claim 2, wherein said procedure of exploring comprises at least one of retrieving, computing and displaying said at least one association at a specified aggregation granularity over a specified time period.

4. System for analyzing time-oriented data in a plurality of subject records, comprising;
a user interface; and
a data processor, coupled with said user interface;
wherein said user interface comprises:
a constraint specifier, for generating a search query on a database of subject records by specifying at least one constraint, wherein said subject records comprise at least one instance of time-oriented data; and
an explorer, coupled with said constraint specifier,
wherein said data processor comprises:
a data provider, coupled with said explorer, for analyzing said search query to determine the type of said at least one constraint specified;
a subject record database, coupled with said data provider, for storing data of a plurality of subject records;
a domain knowledge base, coupled with said data provider, for storing a plurality of concepts, each said concept comprising at least one definition and at least one property, said at least one definition comprising a context, said at least one definition being defined by said data;
an abstraction mediator, coupled with said data provider, said subject record database and said domain knowledge base, for determining which of said plurality of concepts in said domain knowledge base and which of said data is required for determining at least one abstraction from said subject record database; and
an abstraction generator, coupled with said subject record database, said domain knowledge base and said abstraction mediator, for determining said at least one abstraction from said subject record database based on said context, said at least one abstraction substantially representing a search result for said search query,
wherein said explorer is for visualizing, manipulating and exploring said search result.

5. The system according to claim 4, said abstraction generator further comprising:
a data-driven abstractor, for determining a plurality of abstractions for each one of said subject records based on said plurality of concepts in said domain knowledge base and storing said plurality of abstractions in said subject record database; and
a query-driven abstractor, for determining said at least one abstraction according to said subject record database and said domain knowledge base, when said at least one abstraction is not stored in said subject record database.

6. The system according to claim 4, said explorer further comprising:
a computation manager, for storing at least one parameter related to said visualizing of said search result; and
a display manager, for controlling the display of a delegate value representing said search result.

7. An ontology-based temporal aggregation population specification language, for specifying at least one constraint on a database of subject records, said subject records storing data based on a plurality of concepts, said plurality of concepts defined by a knowledge base, comprising:
a select subject record expression, for specifying a set of subject records to be retrieved from said database which satisfy a set of said at least one constraint;
a select subject record time interval expression, for specifying a time interval to be retrieved from said database which satisfies a set of said at least one constraint; and
a retrieve subject record expression, for specifying data to be retrieved from said set of said subject records which satisfies a set of said at least one constraint.

8. Method for determining a single delegate value for a raw concept comprising the procedures of:
accessing at least one subject record in a database of subject records for which said single delegate value of said raw concept is to be determined;
for a specified time period, retrieving data stored in said at least one subject record for said raw concept; and
applying a specified function to said retrieved data, thereby determining said single delegate value of said raw concept.

9. Method for determining a plurality of delegate values for a raw concept comprising the procedures of:
accessing at least one subject record in a database of subject records for which said plurality of delegate values of said raw concept is to be determined;
for a specified overall time period, retrieving data stored in said at least one subject record for said raw concept;
determining a plurality of granularity aggregations; and
for each one of said plurality of granularity aggregations, applying a specified function to said retrieved data within a respective one of said plurality of granularity aggregations, thereby determining said plurality of delegate values for said raw concept.

10. The method according to claim 9, wherein each one of said plurality of granularity aggregation represents an aggregation time period within said specified overall time period at a specified granularity.

11. Method for determining a single delegate value for an abstract concept comprising the procedures of:
accessing at least one subject record in a database of subject records for which said single delegate value of said abstract concept is to be determined;
for a specified time period, retrieving data stored in said at least one subject record for said abstract concept;
extrapolating said retrieved data within said specified time period;
segmenting said extrapolated retrieved data within said specified time period; and
applying a specified function to said segmented retrieved data, thereby determining said single delegate value for said abstract concept.

12. Method for determining a plurality of delegate values for an abstract concept comprising the procedures of:
accessing at least one subject record in a database of subject records for which said plurality of delegate values of said abstract concept is to be determined;
for a specified overall time period, retrieving data stored in said at least one subject record for said abstract concept;
determining a plurality of granularity aggregations;
extrapolating said retrieved data within said specified overall time period;
segmenting said extrapolated retrieved data according to each one of said plurality of granularity aggregations; and
for each one of said plurality of granularity aggregations, applying a specified function to said segmented retrieved data within a respective one of said plurality of granularity aggregations, thereby determining said plurality of delegate values for said abstract concept.

13. Method for exploring a plurality of delegate values determined from a plurality of raw data values using a temporal exploration operator comprising the procedures of:
retrieving and displaying said plurality of raw data values for a specified time period at a specified time resolution;
defining a new time period at which to display said plurality of raw data values; and
updating said displayed plurality of raw data values according to said new time period.

14. Method for exploring a plurality of abstracted data values using a temporal exploration operator comprising the procedures of:
retrieving and displaying said plurality of abstracted data values for a specified time period at a specified time resolution;
defining a new time period at which to display said plurality of abstracted data values;
recalculating said displayed plurality of abstracted data values according to said new time period; and
updating said displayed plurality of abstracted data values using said recalculated displayed plurality of abstracted data values.

15. Method for exploring a plurality of delegate values determined from a plurality of data values using a change delegate value operator comprising the procedures of:
retrieving and displaying said plurality of data values at a specified aggregation granularity using a specified delegate function;
specifying a new delegate function at which to aggregate said plurality of data values;
recalculating said plurality of data values to be displayed according to said specified new delegate function; and
updating said displayed plurality of data values using said recalculated plurality of data values to be displayed.

16. Method for exploring a plurality of delegate values determined from a plurality of data values from at least one subject record using a set relative time operator comprising the procedures of:
retrieving and displaying said plurality of data values at a specified aggregation granularity over a specified time period;
specifying a new start time for displaying said plurality of data values;
determining which said at least one subject record has at least one data value stored in relation to said new start time;
recalculating said plurality of data values to be displayed according to said new start time specified; and
updating said displayed plurality of data values using said recalculated plurality of data values to be displayed.
